(19) United States
(12) Patent Application Publication
(10) Pub. No.: US 2022/0314837 A1
(43) Pub. Date: Oct. 6, 2022

(54) Temperature controlled battery pack bath tub (BPBT), and a Method of protecting a large battery pack from thermal stresses

(71) Applicant: Sanjay Gupta, Birmingham (GB)

(72) Inventor: Sanjay Gupta, Birmingham (GB)

(21) Appl. No.: 17/595,795

(22) PCT Filed: May 27, 2020
(86) PCT No.: PCT/GB2020/000052

§ 371 Date: Nov. 24, 2021

(30) Foreign Application Priority Data
May 28, 2019 (GB) 1907480.6
May 28, 2019 (GB) 1907486.3
May 28, 2019 (GB) 1907490.5
May 28, 2019 (GB) 1907492.1
May 28, 2019 (GB) 1907497.0
May 28, 2019 (GB) 1907504.3

(51) Int. Cl. B60L 58/26; H01M 10/617; H01M 10/653; H01M 10/6567; H01M 10/6569; H02J 7/00; H01M 10/625; B60L 58/27; H01M 50/204

(52) U.S. Cl. CPC B60L 58/26; H01M 10/617; H01M 10/653; H01M 10/6567; H01M 10/6569; H02J 7/0014; H01M 10/625; B60L 58/27; H01M 50/204; H02J 3/32

(57) ABSTRACT

Temperature controlled Battery Pack; a Method of protecting a large battery pack from thermal stresses; all weather Battery module; an apparatus and method for charging a battery pack, and decoupling the charging voltage from the battery pack voltage; an apparatus and method for discharging the hybrid battery modules, and extending the range of the battery pack; Battery pack controller—safety and reliability of battery pack. A method of providing flood protection to a large battery pack. A method of cooling the battery pack in extreme hot temperatures. A method of heating the battery pack in extreme cold temperatures. A method of repurposing the battery module (BM) Charging and balancing circuit is one of the key components of the battery pack. The invention constitutes an apparatus of Energy discharging split circuit installed within each BM, and an energy management algorithm installed in the battery pack controller. The energy discharging circuit mixes the current output of batteries and capacitors within each BM, as per the instructions from the battery pack controller algorithm. The algorithm takes the SoH and SoC of the batteries in the weakest BMs into account to calculate the mix of current from batteries and capacitors, and selectively instructs each BM. A method for discharging the battery BMs, and extending the range of the battery pack. Battery pack controller is the Master controller of the battery pack.

### TECHNICAL FIELD

Large battery packs used in large electric vehicles e.g. cars, trucks, buses, vans, trains. This invention relates to large battery pack technology.

### BACKGROUND INFORMATION

Vehicles use ICEs to power its drive train. However for electric vehicles, a battery pack with large energy storage capacity is needed to supply large power to electric motors.

Rechargeable batteries e.g. lithium Ion batteries, are the building blocks of a battery pack. These batteries take long time to charge and have very narrow safe operating temperature and charging temperature range, depending upon its chemistry. Batteries generate heat during normal operations (discharging) and charging (depending upon the battery balancing method deployed). Batteries produce even more heat during peak usage (when max current demand is placed on the battery pack), or when the battery is charged using large current as in the case of super/fast chargers. In real world electric cars, trucks, buses, vans, trains, boats or backup power unit for hospitals, data centres and industrial units, have to operate in wide ambient temperature range e.g. from minus 40° C. to over 60° C. Ambient temperatures also put thermal stresses on the batteries during usage and even when the batteries are not being used.

Large battery packs with very high voltage and high current also require better protection from exposure to such voltages and currents in the event of an accident to the rescue staff and other road users; as well as during the repair of the vehicle. Large battery packs should break the high voltage circuit in the event of an accident or manually during repair.

Large commercial vehicles have to operate in rain and sometimes low level flooded areas, especially boats have high chance of exposure to water. Large battery packs including its electronics should be waterproof or water-resistant.

Ideally the maintenance costs of the battery pack should be minimised; it should be easily repairable, so that in the event of an accident or fault, the failed module can be replaced without rejecting the whole battery pack.

Thermal Management:
Air Cooling—Simple battery packs deploy air cooling, which uses gaps between the batteries, to circulate the air to cool the batteries during operations and charging.

Benefits of Air-Cooling:
1. It's cheaper to install, as no pumps are required.

Drawbacks of Air-Cooling—
1. this limits their usage under ambient temperatures outside the normal range,
2. this limits the energy density (energy density for a given cubic metre space) that can be achieved.
3. In the event of small flooding, it can lead to short circuit and permanent damage to the battery pack and associated electronics.
4. Typically the batteries are hard wired. In the event of an accident the fire rescue team has to isolate the battery from rest of the vehicle to safely rescue the occupants.
Cooling Tubes/leaves—Sophisticated battery packs use cooling tubes, which are in direct contact with the battery's sides to cool and heat the batteries. High pressure pumps push cooling/heating liquid through very narrow tubes/leaves interleaved with the batteries, to maximise the energy density and maximise the surface contact area with the batteries. The energy required to cool/heat the battery pack increases as the ambient temp moves away from the safe operating temp of the batteries.

Benefits of the Cooling Tubes:
1. This provides the higher energy density compared to the air-cooled battery packs.
2. The pack can be used in wider ambient range compared to air-cooled battery packs.
3. The pumps consume small enough energy (compared to the stored energy in the battery pack) to push the cooling/heating liquid around the pack, during the normal ambient temperatures and normal usage of the battery pack.

Drawbacks of Cooling Tubes:
1. In extreme (temperature below zero and temperatures above 40° C.) ambient temperatures, high pressure pumps have to push large amount of the cold or hot liquid through narrow tubes/leaves, and consume a significant amount of energy (compared to the stored energy) to cool/heat the battery pack.
2. There is a an uneven cooling or heating of the pack, as batteries close to the inlet are better cooled or heated, vs. the ones close to the outlet.
3. If one or more of the batteries in the battery pack, get into thermal runaway (uncontrolled heating) which can also lead to fire in the battery pack; it's very difficult to cool the individual batteries and extinguish the fire. Secondary technologies e.g. fuses are deployed to stop the thermal runaway. A separate technology is needed to stop the fire.
4. In the event of small flooding, it can lead to short circuit and permanent damage to the battery pack and the associated electronics.
5. Typically the batteries are hard wired within the battery pack as high power switches produce a lot of heat in close proximity of the batteries. In the event of an accident the fire rescue team has to electrically isolate the battery from rest of the vehicle, to safely rescue the occupants.

Flood Protection:

The air cooling and cooling tubes thermal management, is not water resistant or offer protection from high voltage when the vehicle is fully or partly submerged, and it—does not create a water resistant battery pack for all its batteries and the associated electronics. Flooding can result in significant damage to the battery pack, and there is a risk of exposure to high voltages.

How this BPBT Invention Solves the Technical Problems, and how it is Different

This invention solves the current technical problems through many innovative steps:
1. Thermal management—This innovation uses dielectric liquid with a low boiling point as a carrier of heat from individual batteries/capacitors and the associated electronics in the BPBT to the condenser. Batteries are packed inside modules and the modules are stacked horizontally and vertically inside the BPBT. The dielectric liquid which is two phase (liquid-vapour) comes in direct contact with the batteries, the connectors, and the associated electronics. This invention has created vertical ducts in between the batteries. Bubbles are created when subcooled liquid comes in contact with the hot batteries. The bubbles are then channelled into the vertical ducts; these bubbles produce vertical flow of 2 phase dielectric liquid and vapours inside the ducts. These ducts act as heat exchangers. The process of subcooled flow boiling process cools the batteries. This vertical flow also creates low pressure inside the ducts and this creates localised a horizontal movement of liquid, cooling from its tabs.
2. Charging and discharging of batteries in extreme temperatures—this innovation uses capacitors to store energy, which is used to heat the dielectric liquid in the extremely cold temperatures e.g. −40 degree Celsius. From −40 degree Celsius to zero degree Celsius, it's not possible to charge or discharge the lithium ion batteries without damaging its life, capacitors heat up the dielectric liquid to bring the batteries temperature to the safe operating temperature. In extremely hot temperature of 45-60 degree Celsius, especially the tarmac temperature, capacitors supply power to the pump to circulate refrigerant/water through the condenser to cool the BPBT.
3. Water resistance—This innovation make the whole of BPBT a water-tight bath tub, which houses the batteries, the electrical wiring, the electronic circuitry to control the BPBT, and the power electronics to charge the BPBT.
4. Modular design—This innovation allows the extension and reduction of the capacity of the BPBT.

The Key Objectives of the BPBT Inventions in this Disclosure are:
1. can be operated (charging and discharging) in the temperature ranging from minus 40° C. to +65° C.;
2. BPBT has high energy density (Watt Hr/Kg);
3. minimum power consumption of external pumps and the amount of external liquid/refrigerant needed to be cooled/heated and circulated through the BPBT;
4. make the BPBT and all its associated electronics, flood proof;
5. make the BPBT safe i.e. protection from exposure to high voltages in the event of accident or repair;
6. the BPBT is safe in the event of thermal runaway of individual batteries inside the BPBT and also protection from fire;
7. make the pack modular so that the BPBT can be easily repaired by taking out the failed modules;
8. make the batteries last higher number of charge cycles.

### BRIEF ABOUT DRAWINGS

FIG. 1.12—shows the ducts (205) of all the vertical stacked BMs (200) are aligned to form vertical ducts (205) and vertical flow of dielectric liquid

FIGS. 2.1 to 2.12—show the details of the Battery Pack Bath Tub (100)

FIG. 3—Schematic diagram of BPBT (100) external connections. It shows how BPBT connects to various components in an electrical vehicle (10).

### DETAILED DESCRIPTION OF PREFERRED EMBODIMENT OF BPBT, AND HOW IT IS MANUFACTURED

The inventions will be explained through preferred examples of Battery pack bath tub BPBT (100).

BPBT (100)

The aim of this invention is to design an apparatus of a battery pack, which provides:
a. highly controlled and homogenous temperature environment for cooling the batteries in hot and extremely hot ambient temperatures, that extends the life of the batteries and capacitors;
b. highly controlled and homogenous temperature environment for heating the batteries in cold and extremely cold ambient temperatures, that extends the life of the batteries and capacitors;
c. highly controlled and homogenous temperature environment for all the associated electronics of the battery pack;
d. modular serial and parallel electrical circuitry so that any number of modular cases can be fitted electrically in serial and/or parallel, inside the battery pack;
e. modular mechanical fittings so that modular cases can be horizontally and vertically stacked for maximum energy density;
f. safety from fire and gases in the event of thermal runaway of a battery or a number of batteries;
g. safety from flooding for the batteries, capacitors, electrical circuitry and the associated electronics; make the pack modular so that the BPBT can be easily repaired by taking out the failed modules;
h. modular communications with the modules, so that a module with a given ID can be located anywhere in the container (101);
i. highly controlled and homogenous temperature environment for all the associated electronics of the battery pack;
j. make the pack modular so that the BPBT can be easily repaired by taking out the failed modules;
k. minimum power consumption of external pumps and the amount of external liquid/refrigerant needed to be cooled/heated and circulated through the BPBT;
l. make the batteries last higher number of charge cycles.

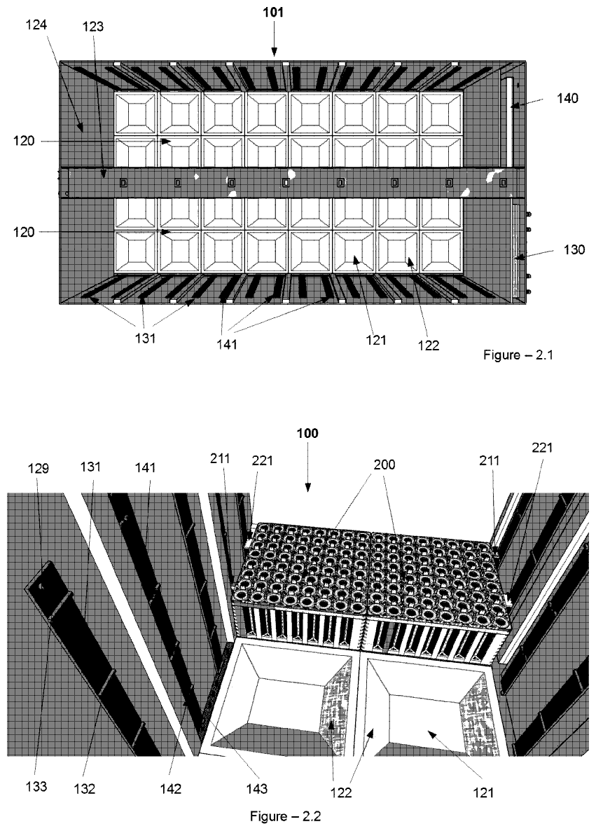

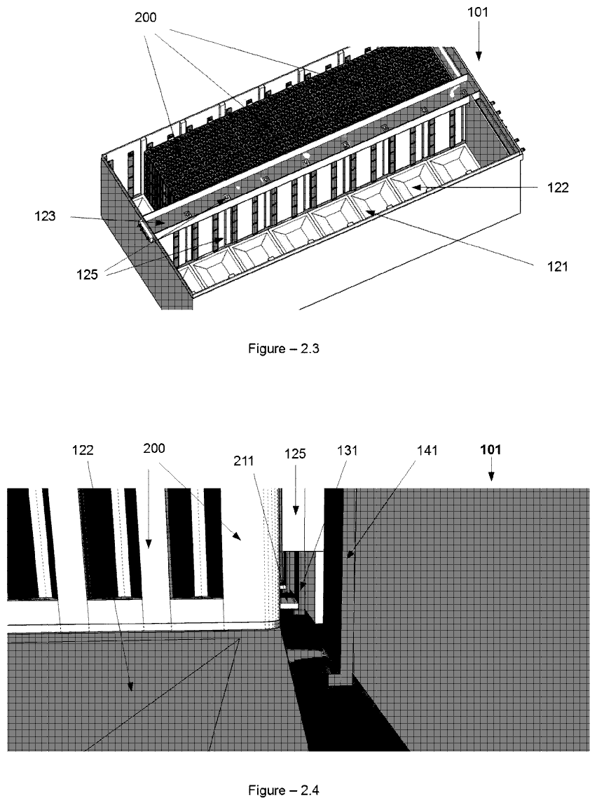

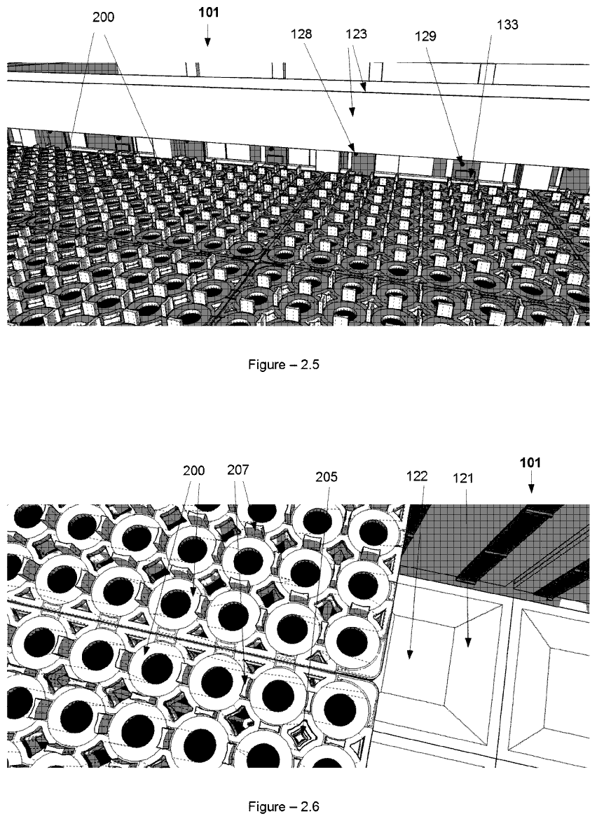

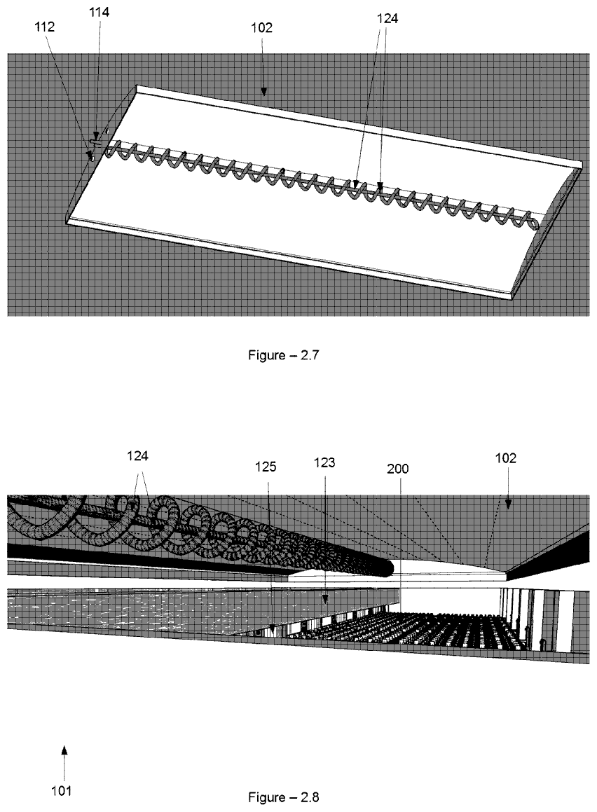

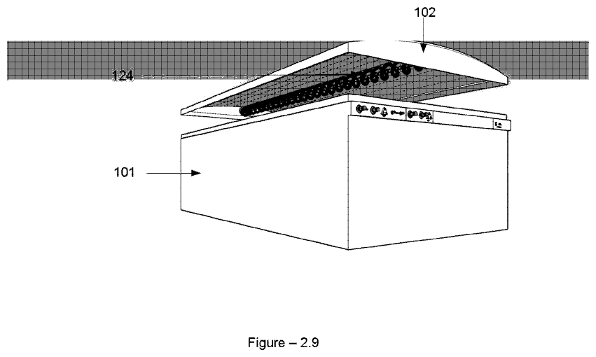

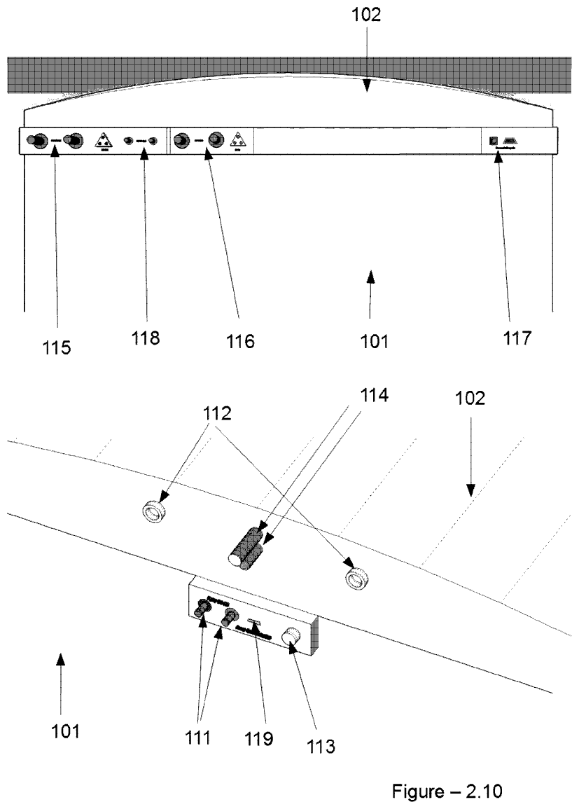

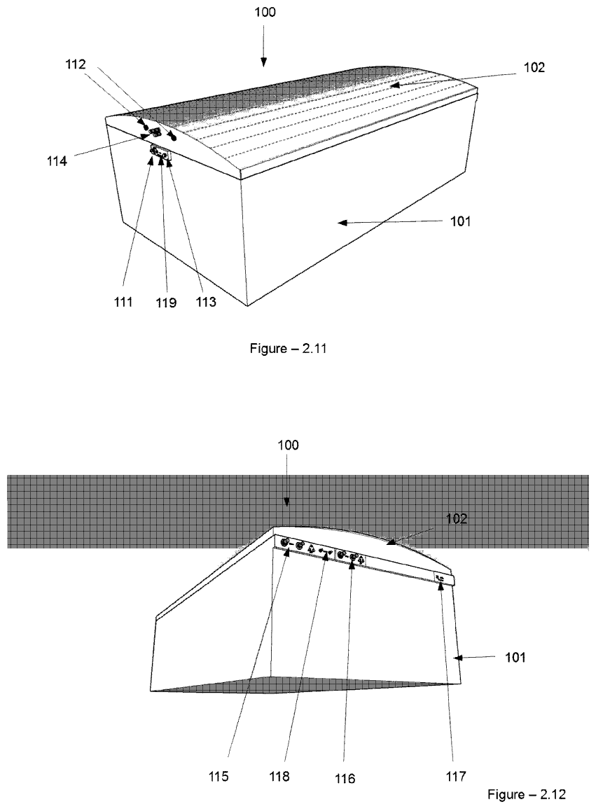

FIG. 2.1 shows the shape of the BPBT (100) is a rectangle; however in another embodiment it can be a polygon or a circle. In another embodiment it could be shaped to fit into a specific space available in the vehicle. In this disclosure all these shapes and types of containers are referred to as a container (101).

FIG. 2.1 and FIG. 2.2 shows, in this embodiment the BPBT is a large bath tub like container (101) filled with 2 phase (liquid and vapour) dielectric liquid, and following are all immersed in the dielectric liquid:
a. Plurality of battery modules BM (200) where each module is packed with plurality of rechargeable batteries and capacitors;
b. Power board (130) to charge large number of rechargeable batteries;
c. Battery pack controller board (140);
d. Relay switches (133).

Last three items in the above list are optional. In one embodiment Power board (130) can be located outside the container or the BPBT, and may not be part of the electronics of the BPBT. In another embodiment parts of the power board can be inside the BPBT and rest can be outside the BPBT. In another embodiment, Battery pack controller (140) can be implemented outside the BPBT and may be called battery management system (BMS). In further embodiment battery pack controller (140) may be part of the BPBT but located outside the container. In one embodiment Relay switches (133) can be located outside the container. In another embodiment one or more relay switches can be located inside the container and rest outside the container or in further embodiment all of the relays switches can be located outside the BPBT.

In this disclosure, the dielectric liquid is a thermally conductive but electrically insulative liquid. E.g. fluorocarbons. In this particular embodiment the dielectric liquid chosen is of low boiling point which is lower than the maximum operating temperature of the batteries (220) and capacitors (220), which when comes in contact with hot batteries/capacitors (220) produces bubbles and the dielectric liquid is also heated by convection. In another embodiment a combination of pressure inside the BPBT (101) and the boiling point of the dielectric liquid can be used, to achieve a higher boiling point of the dielectric liquid inside the BPBT (101). E.g. if the BPBT is used at high altitudes, it would lower the boiling point of the dielectric liquid, the battery pack (101) can then be pressurised to increase the boiling point of the dielectric liquid inside the battery pack (101) or dielectric liquid can be chosen which has higher boiling point than the maximum operating temperature of the batteries (220) and capacitors (220).

Mechanical/Electrical Arrangement of BM (200) Inside the BPBT (100)

BPBT (100) allows a mechanical as well as electrical flexibility in choosing the mechanical size of the BM (200), e.g. square or rectangle or any polygon, and how many batteries and capacitors are connected electrically in series or parallel inside a BM (200). BPBT (100) also gives flexibility in choosing how these BMs (200) are mechanically and electrically arranged inside the BPBT in terms of how many BMs that can be stacked horizontally or vertically inside the BPBT, and how many BMs are electrically connected in series and how many BMs are connected in parallel. Further BPBT (100) gives flexibility in terms how many BMs that can be mechanically and electrically fitted inside the BPBT.

As shown in FIGS. 2.1, 2.2 and 2.3, in this embodiment, BPBT (100) has configuration of 128P64P, (128 series and 64 parallel). It has 128 BMs (200), with 62 batteries and 2 capacitors in each BM. It has mechanical layout with 32 BMs (200) (4 rows of 8 BMs) laid horizontally, and 4 BMs are stacked vertically in each column. In another embodiment, it can be a mechanical layout with any number of horizontally laid and vertically stacked BMs (200), depending upon the energy requirements of the application and the space available in the application e.g. 160S256P configuration can be implemented in 80 modules and each BM with a electrical configuration of 2S256P (2 vertical layers and each layer has 248 batteries connected in parallel and 8 capacitors connected in parallel); has a mechanical layout of 16 BMs×5 BMs (16 BMs are laid horizontally and 5 BMs are stacked vertically in each column); and all the BMs are electrically connected in series inside the BPBT. In a preferred embodiment, the same electrical configuration of 160S256P can also be implemented in 640 modules; and each module has a configuration of 64P (62 batteries connected in parallel and 2 capacitors connected in parallel); has mechanical layout of 64 BMs×10 BMs (64 BMs are laid horizontally, and 10 BMs are stacked vertically in each column); 160 sets of BMs are connected electrically in series and there are 4 BMs connected in parallel in each set.

In another embodiment large batteries/capacitors can be horizontally and/or vertically arranged, using one or more mesh like structures, without using multiple BMs. In such an embodiment the electrical connections to the batteries/capacitors are embedded inside the mesh or laid above or below the mesh. In further embodiment part of the wiring can be based on radio signals, especially the control signals. For this disclosure each such mesh like structure is considered as one BM. If multiple layers of mesh like are structures are stacked, each layer is considered as one BM and vertical layers of mesh are considered as vertically stacked BMs.

In this disclosure, the combination of batteries and capacitors is optional. The BM (200) can be created just with batteries. The BM (200) can also be created just with capacitors.

Electrical serial connection in this disclosure means when positive ends of a group of batteries are electrically connected to the negative ends of another group of batteries. The two groups of batteries are said to be connected electrically in serial fashion.

Electrical parallel connection in this disclosure means when positive ends of a group of batteries are electrically connected to the positive end of another groups of batteries, and the negative end of the first group of batteries are connected to the negative ends of the second group of batteries. The two groups of batteries are said to be connected electrically in parallel fashion.

Electric Connections Inside the BPBT

As shown in FIG. 2.2, in this embodiment of BPBT (100), 128 BMs (200) are electrically serially connected via HV terminals (132) provided on the PCB (131). BMs (200) are charged through charging terminals (142) provided on the PCB (141). The battery pack controller (140) communicates with the BMs (200) through communication terminal (143) provided on the PCB (141).

In this embodiment the battery pack controller is installed inside the BPBT, however in another embodiment it can be installed outside the BPBT (100).

In this embodiment the BPBT (100) has electrical configuration of 128S64P (128 series and 64 parallel). It has 128 BMs (200), and each BM (200). Has with 62 batteries and 2 capacitors. Each battery inside a BM is of nominal voltage of roughly 3.65v and roughly 3.4 aH capacity, this makes the total capacity of the battery pack (ignoring the energy of capacitors)=128*62*3.65*3.4=98 KW, which is capable of powering a SUV, a van or light commercial vehicle.

In this particular embodiment BM has 62 cylindrical lithium-ion (Li-ion) rechargeable batteries (220) and 2 capacitors. In another embodiment it could be any other chemistry; in the shape of cylinder, tower, pouch or prismatic or any other shape. Further the batteries could be of high energy density.

In this disclosure all these rechargeable batteries (220) of different chemistries and shapes are referred to as Batteries (220) in plural and Battery in singular. In this particular embodiment BM has 2 Electric double layer capacitors (EDLC) cylindrical capacitors, also called supercapacitors. In another embodiment these capacitors could be Asymmetric Electrochemical Double Layer Capacitor (AEDLC), Lithium Ion capacitors, or graphene supercapacitors. In this disclosure all capacitors of different electrochemical, chemistries and shapes are referred to as capacitors in plural and capacitor in singular. In another embodiment there could be any number of batteries (220) and any number of capacitors (220) in a module.

In another embodiment, the configuration can be xSxP, the voltage requirement of the embodiment determines the number of electrically serially connected batteries; and current requirement of the embodiment determines the total number of parallel batteries to be connected e.g. configuration of 160S256P; it has 160 BMs, and each BM has 248 batteries and 8 capacitors; using the same batteries will produce (ignoring the energy of capacitors)=160*248*3.65*3.4=492 KW, which can be used to power lorries and boats.

In this embodiment, electrical HV terminals (132), charging terminals (142) and communication terminals (143) are mechanically arranged, inside the BPBT, as per the electrical configuration of 128S64P. In another embodiment, the BPBT with electrical configuration of 160S256P with 160 BMs with each BM of configuration 256P, has 160 HV terminals (132), 160 charging terminals (142) and 160 communication terminals (142). However, in another embodiment, the same electrical configuration of 160S256P can be implemented using 640 BM (200) with each BM of configuration 64P, the BPBT will have 640 HV terminals (132), 640 charging terminals (142) and 640 communication terminals (142).

Depending upon the embodiment, number and location of the PCBs can change, as well as number of HV terminals, charging terminals and communication terminals on the PCBs can change.

How Thermal Stresses are Managed Inside BPBT (100)

FIG. 2.3 shows in this embodiment, a trough (123) with a cross-section of a square, collects the condensate, and vertical drain pipes (125) deliver the subcooled condensate to the sump (122). In another embodiment a trough with a cross-section of funnel or semicircular or half oval or any polygon, can be used to collect the condensate. In this disclosure all such shapes of troughs are referred to as trough. In another embodiment where there are more than one condensing coils explained further down), there can be more than one troughs to collect the condensate. Another innovation here is that a combination of a trough (123) and vertical drain pipes (125) are used to deliver the condensate at the bottom of the BMs. Further innovation is that the trough (123) provides structural strength at the top of the container (101) and drain pipes (125) create a mechanical separation between two rows of BM (200).

FIG. 2.2 and FIG. 2.3 show a square sump (122) which matches in size with the base of module BM (200) such that there is one sump for each column of BMs. In another embodiment the shape of the sump can be of any polygon and each sump may service more than column of BMs. In this disclosure all such shape and size of sumps are referred to as sumps.

FIG. 2.4 shows that the vertical drain pipe (125) delivers the subcooled condensate at the base to fill the sumps (122). FIG. 2.4 also shows that BMs (200) sit on top of sump (122).

The sumps (122) collect the dielectric liquid which can be heated using the PCT heater (121). The heater can be any coil heater or heating tubes through which hot water is circulated. In this disclosure all such heaters are referred to as Heater.

The battery pack controller (140) is electronically connected to the heater to control its functions e.g. switches on the heater when the temp inside the container (101) falls below minimum allowed by the chemistry of the batteries; switches off the heater when the temperature inside the container (101) has reached a preset level.

FIG. 2.5 also shows that when all the BMs (200) are stacked inside the battery pack container (101), these are level and the dielectric liquid fills the container (101). The FIG. 2.5 also shows the relay switches (133) attached to the top of the PCB (131), and are immersed in dielectric liquid. The relays (133) switch off the serial circuit inside the container (101) such that system voltage is less than SELV (Safety extra low voltage) level, and also bypass a BM or group of BMs, as per the control signals from the battery pack controller (140). There are various standards of SELV, the voltage of 60v is considered as SELV in this disclosure. In another embodiment the relay switches (133) can be attached anywhere on the PCB (131). The relays (133) are optional. In another embodiment the relays (133) may not there. In this disclosure relay switch (133) means a switch e.g. FET, MOSFET etc.

In FIG. 2.5 pressure sensor (129) measures the pressure inside the container (101). Battery pack controller (140) is electronically connected to the pressure sensor (129), and records the pressure inside the BPBT (100) at all/regular times.

In this disclosure electronic connection means when two devices communicate with each other through electronic (digital or analogue) signals e.g. electronic connection between battery pack controller (140) and a sensor or electronic connection between battery pack controller (140) and battery charge controller (240).

Battery pack controller (140) is electronically connected to a gas solenoid (113) as shown figure in 2.11. Battery pack controller (140), opens the gas solenoid (113) if the pressure inside the container (101) is higher than preset level, to release the pressure inside the container (101) and closes the solenoid valve after the pressure reaches a preset level.

FIG. 2.11 shows the Immersion proof breather (112), which is a pressure balancing device (balances the pressure inside the container (101) and outside the container (101)), works even when the container (101) is fully submerged (for safety reason, the design allows temporarily fully submerged container (101)). Immersion proof breather are optional, e.g. if the battery pack is used in high altitude areas, pressure inside the container (101) is deliberately maintained at higher levels than external pressure. This is done so that dielectric liquid's boiling point does not fall below a preset level. Immersion proof breathers (112) may also be omitted in areas where these may not work properly e.g. in desert/sandy areas or where these let in extreme ambient temperatures through its membranes.

Optional Liquid level sensors (128), as shown in FIG. 2.5, measure the level of the dielectric liquid inside the container (101). Battery pack controller (140), is electronically connected to the liquid level sensor, monitors the dielectric liquid level inside the container (101) using these sensors, and alerts the user of the battery pack, to top up the dielectric liquid, if the level of the dielectric liquid inside the container (101) is lower than the preset level. In another embodiment these sensors can be placed anywhere inside the container (101). In further embodiment there may not be any liquid sensor.

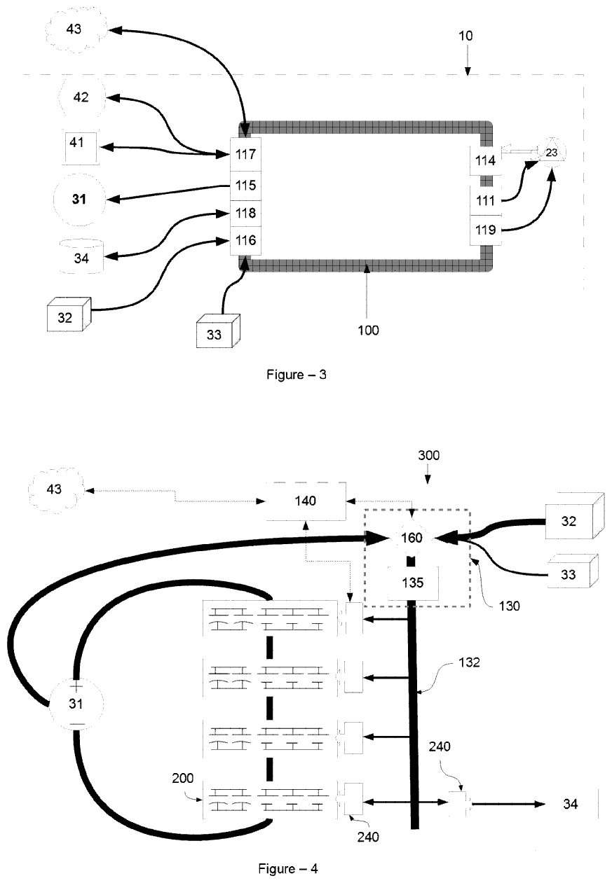

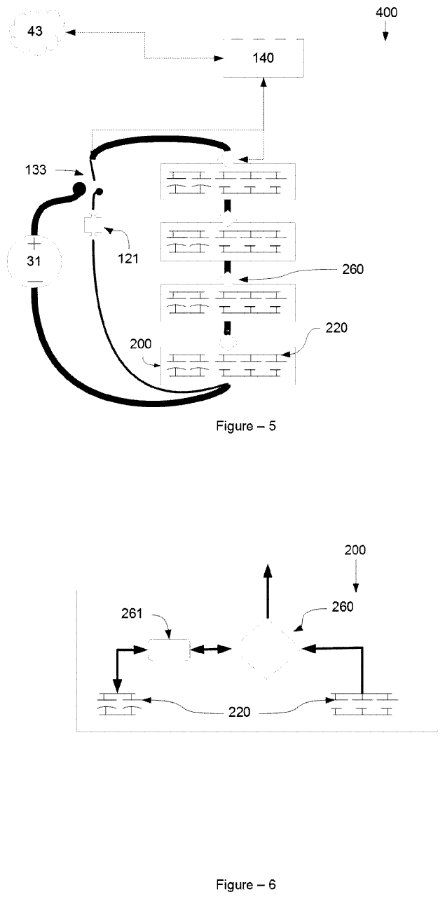

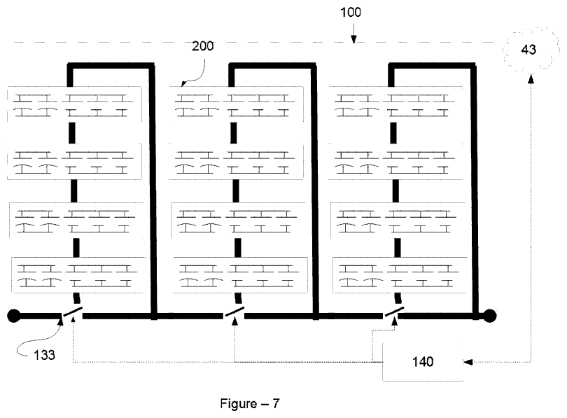

In this embodiment Battery pack controller (140) checks the temperature inside the BMs, and if it is hotter than the optimum operating temperature range of the chemistry of the batteries e.g. 35 degree Celsius, then Battery pack controller switches on the pump (23) as shown in FIG. 3 or increases the flow rate of the liquid/refrigerant through the condenser (124) to cool the vapours faster by increasing the speed of the pump (23). If however the measured temperature is cooler than the optimum operating range of the chemistry of the batteries e.g. less than 10 degree Celsius, then Battery pack controller (140) switch on the heater (121) to heat the dielectric liquid.

How Vertical Stacking of BM (200) Work Inside the Container (101):

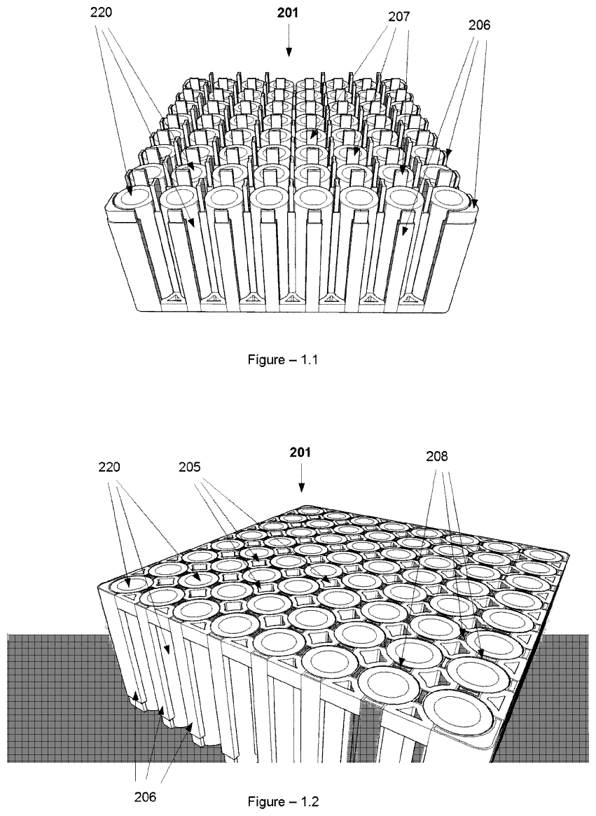

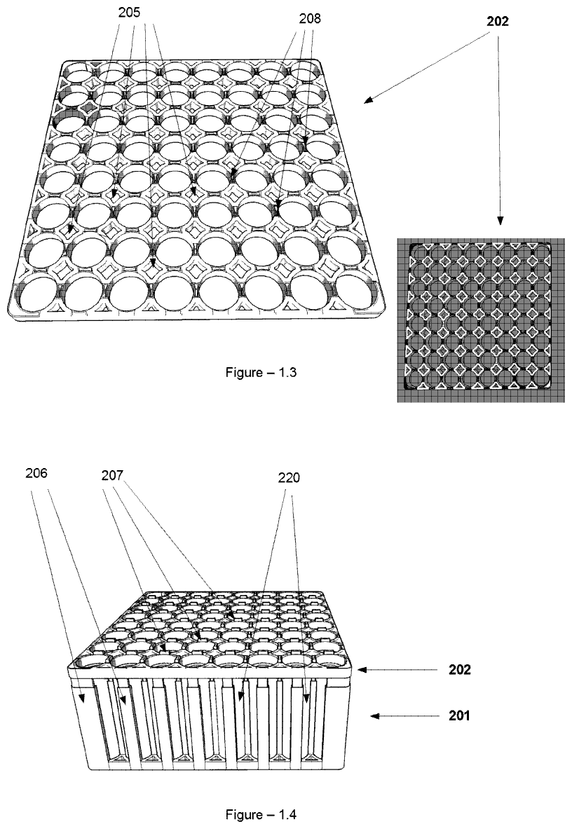

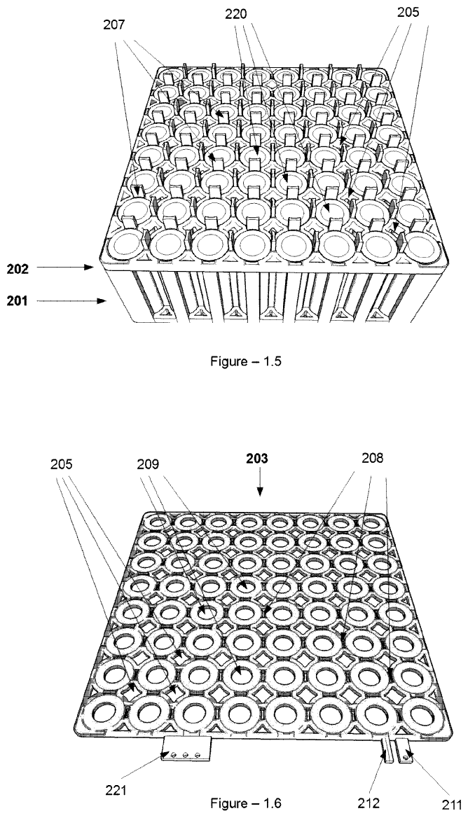

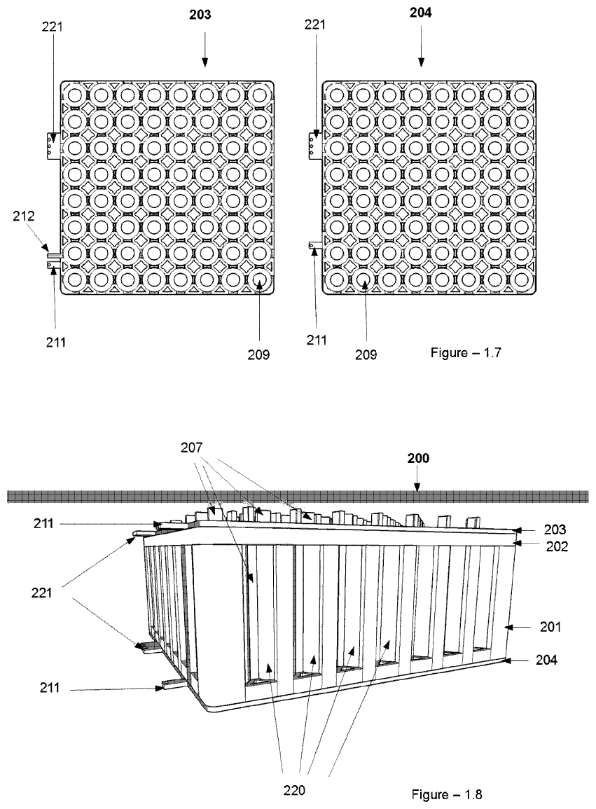

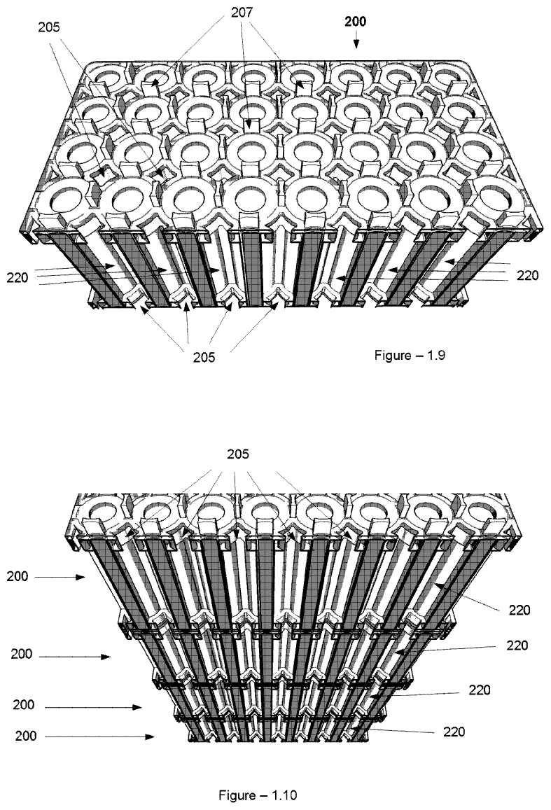

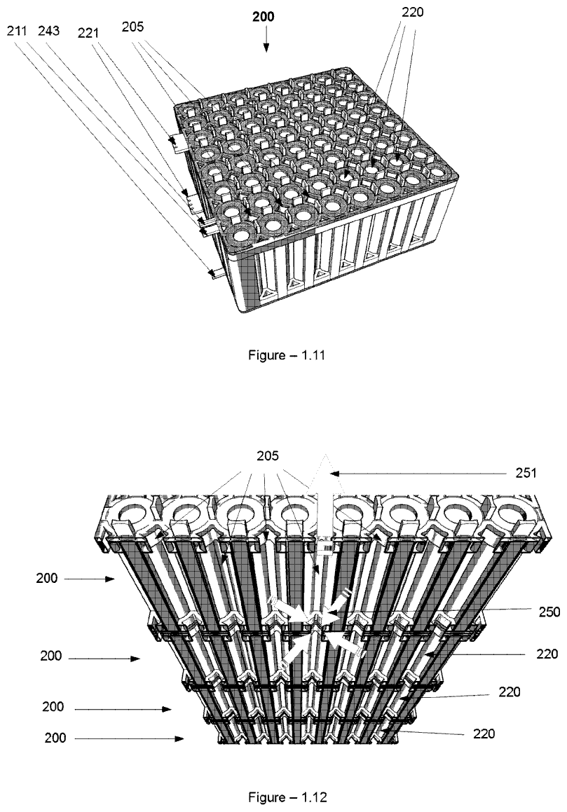

FIG. 1.12 and FIG. 2.6 shows, when the BMs (200) are vertically stacked, the ducts (205) of all the vertical stacked BMs (200) are aligned to form vertical ducts (205). The separators (207) of each BM (200) are used to vertically align the BMs (200).

Inside the ducts (205), the vertical flow starts at the bottommost BM (200) and travels through the 4 vertically stacked BM (200) in this embodiment, until the dielectric liquid and the bubbles reach the surface of the liquid inside the container (101). In another embodiment there could be more or fewer vertically stacked BM (200). The vertical flow continues through the stacked BM (200), inside the ducts (205), until it reaches the surface of the dielectric liquid. As shown in FIG. 1.12, the vertical flow (251) of dielectric liquid also creates a low pressure inside the ducts (205); and low pressure creates a localised horizontal flow (250) of liquid towards the ducts; and the low pressure sucks in hot liquid from the gaps in between the stacked BM (200), which in turn sucks in hot liquid from the tabs of the batteries; harnessing the effects documented in Bernoulli's theorem.

One of the innovation here is the BPBT is mechanically designed which allows horizontal and vertical stacking of BMs. Further innovation is that the vertical heat exchanging ducts (205) which are formed by stacking the BMs allow vertical flow of dielectric liquid through the BMs, and allow the vertical ducts to act as heat exchangers.

Further innovation is that modular electrical circuitry is designed such that any number of BMs can be electrically connected in serial or parallel manner inside the container (101) and further electronic communication terminals available on PCB (141) are also designed for the BMs such that battery pack controller can electronically communicate with a BM, regardless where a BM with specific ID is located inside the container (101).

As shown in FIG. 2.7 and FIG. 2.8, in this embodiment helical coil (124) is used as a condenser to maximise the cooling surface area in a confined space, and parabolic lid (102) is used to channel the vapours towards the cooling coil. In this embodiment there is one helical coil (124) to condensate vapours from 4 rows of BMs (200), in another embodiment there could be two or more helical coils (124) attached to the lid (102) to condensate 8 or more rows. In another embodiment a cooling plate can be used as a lid. In another embodiment curled or straight pipes fitted to the lid can be used as a condenser. In another embodiment microfilm can be attached to the lid with cold liquid inlets and outlets. In another embodiment high grade refrigerant is circulated through the cooling tubes instead of water/glycol. In further embodiment the vapours can be siphoned out of the container (101), condensed using an external cooling loop, and returned to the container (101). In this disclosure any of the above types of condensers are referred to as a condenser. In another embodiment another shape of lid can be used e.g. a flat lid or a lid with a cross-section of semicircle.

Another innovation here is that a combination of helical coil (124) and a parabolic lid (102) is used to maximise the condensation efficiency as well as ease of manufacturing and maintenance of coil (124) and the lid (102). Further innovation is the external shape of a parabolic lid (102) helps to drain away the water if the BPBT (100) is exposed to rain or splash of water, and contributes towards the innovation of making the battery pack flood proof.

Flood proof in this disclosure means that the battery pack's internal electrical circuit, associated electronics and batteries are not impacted by splash of water, though not fully submerged.

FIG. 2.9 shows how the lid (102), slides into the container (101) and sealed with a waterproof sealant to create a watertight BPBT (100). Watertight in this disclosure means it does not let water in when exposed to splash of water but not fully submerged. Waterproof sealant in this disclosure means a sealant that does not wash away when exposed to water. Another innovation here is that all the batteries and the associated electronics is contained inside the watertight BPBT (100). In another embodiment however part of the associated electronics can be located outside the container (101). e.g. Power board can be located outside the container (101).

Another innovation here is that a sealed container consisting of all the batteries, electrical circuits, associated electronics, with a thermal management is used to achieve flood proof of the BPBT (100).

Associated electronics in this disclosure means, the electronics to charge, discharge, and manage the battery within safe thermal limits and manage the overall functions/communications of the battery pack, e.g. Power board with AC/DC converter, Dc-DC converter; battery monitoring board, battery charge controller etc.

FIG. 2.10 shows, in this embodiment, the helical coil (124), has a water/refrigerant inlet and outlet (114). The gas solenoid (113) can be used to top the dielectric liquid.

How the BPBT (100) is Electrically or Electronically Connected to the EV (10) and External Chargers

FIG. 3 is a schematic diagram of particular embodiment of how the BPBT (100) fits into an electric vehicle (EV) (10). In this particular embodiment, as shown in FIG. 2.12 and FIG. 3, the BPBT (100) has a high voltage DC output port (115) with positive and negative terminals which can be electrically connected to electric motor/s (31) positive and negative terminals of electric vehicle (10). In another embodiment there could be two or more DC output ports (115) available on BPBT connected to two or more electric motors (31). As shown in FIG. 2.12 the port (115) also has an AC output port which can be electrically connected to any AC consuming device (not shown) e.g. AC supply to a house or any other AC motor/device. This AC port is optional. In another embodiment e.g. when used as a backup battery for a house/office just the AC output port is there and DC output port is either optional or not supplied. In FIGS. 2.10 and 2.12, the high voltage DC output port (115) shown here as a straight connector, in another embodiment a different connector compatible with a particular manufacturer's cable can be used with harnesses. In FIGS. 2.10 and 2.12 the AC output port (115) shown is a single phase wall socket, in another embodiment it can be a three phase AC connector, compatible with a particular manufacturer's cable with harnesses.

In FIG. 2.12 and FIG. 3, in this particular embodiment the BPBT is shown with a high voltage DC input port (116) with positive and negative terminals connected to a street based DC charger's (32) positive and negative terminals. In another embodiment there could be an additional DC input port which allows charging to a different voltage level e.g. one DC input port allows 200V-400V DC and the second port allows 400V-600V charging. In FIG. 2.12 and FIG. 3, the port (116) also has an AC input port which is electrically connected to any AC charging terminal (33) e.g. home or street based AC charging terminal. This AC port is optional. In another embodiment, however just the AC charging port can be there and the DC charging is either optional or not there. In FIGS. 2.10 and 2.12, the high voltage DC input port (116) shown here as a straight connector, in another embodiment a different connector compatible with a particular manufacturer's cable can be used with harnesses. In FIGS. 2.10 and 2.12 the AC input port (116) shown is a single phase wall socket, in another embodiment it can be a three phase AC connector, compatible with a particular manufacturer's cable with harnesses.

In FIG. 2.12 and FIG. 3, in this particular embodiment the BPBT (100) is shown with low voltage DC output port (118) with positive and negative terminals electrically connected to an electric vehicle's low voltage/auxiliary battery's (34) positive and negative terminals e.g. a lead acid battery.

In another embodiment there could be an additional low voltage DC output port which allows electrical connector to a second battery e.g. first connection connects to a 12V battery and the second connector connects to a 48V battery. The electrical connection shown port (118) and the low battery shown here is a 2 way connection, which means low voltage battery also supplies power to the BPBT (used to power the relays). In another embodiment it could be just one way e.g. the BPBT can charge the battery, however the low voltage battery (34) does not supply charge to the BPBT (100). In further embodiment it could be one battery (34) connection is one way, however the second low voltage battery (34) is two way e.g. 12V battery connection is one way and 48V battery connection is two way.

In FIG. 2.12 and FIG. 3, in this particular embodiment, the BPBT is shown with communication port (117), which is a serial port, electronically connected to vehicle control unit (41) of an electric vehicle. In another embodiment there could be one or more additional ports e.g. an Ethernet port, a CAN port. In further embodiment the additional port can be electronically connected to a another vehicle control unit, e.g. a vehicle may have two or more vehicle/motor control units to control front and rear wheels motors (31) connected to two separate ports at the BPBT.

In FIG. 2.12 and FIG. 3, in this particular embodiment, the communication port (117) is electronically connected to a GUI (graphical user interface) (42) with the vehicle. In another embodiment the port (117) can be connected to a navigation and autonomous driving system. In further embodiment the port (117) can be connected to user's own screen mounted device e.g. off the shelf navigation devices.

In FIG. 3, in this particular embodiment, the BPBT (100) is a single large battery device installed in an electric vehicle. In another embodiment there can be more than one BPBT (100) installed in an electric vehicle electrically connected in a serial or parallel manner e.g. to provide more capacity or voltage to a larger vehicle e.g. there can be two BPBT (100) installed in a train carriage with two wheelsets, one BPBT (100) for each wheelset.

In FIG. 2.12 and FIG. 3, in this particular embodiment, the BPBT (100) is a single large battery device installed in an electric vehicle and the communication port (117) of this BPBT electronically connects to a vehicle control unit which can provide instructions to the BPBT regarding its operations. In another embodiment two or more BPBT are installed in an electric vehicle e.g. in a train carriage. These BPBT (100) can be independently controlled by the vehicle control unit or all the BPBT can be electronically chained, such that an vehicle control unit can manage all the BPBT by electronically connecting to just one of the BPBT and the connected BPBT's battery pack controller (140) acts as the master of other BPBT (100) and the latter's battery pack controllers (140) act as a slave.

In FIG. 2.11 and FIG. 3, in this particular embodiment, the thermal port (114) is thermally connected to an external pump (23), which pumps cold water/refrigerant through the inlet of port (114) and extracts hot water/refrigerant through the outlet of port (114). In FIG. 2.11 and FIG. 3, the low voltage DC port (111) supplies power to the pump and communication port (119) is electronically connected to the pump's control unit. In another embodiment the thermal port (114) is thermally connected to vehicle's heat exchanger which directly pumps in cold water/refrigerant through the inlet of port (114) and extracts hot water/refrigerant through the outlet of port (114); and port (119) is electronically connected to vehicle control unit to instruct how much water/refrigerant supply it needs and when.

In FIG. 2.12 and FIG. 3, in this particular embodiment, the communication port (117) is electronically connected to internet using wifi (43) or Bluetooth (43). In another embodiment the communication port (117) is connected to user's smartphone app to provide information about the status of the battery and receive instructions from the user. In further embodiment the port (117) is connected to the internet based app which remotely monitors the health of the BPBT and provides instructions e.g. to start charging and stop charging. In another embodiment the port (117) is connected to the cloud based operational centre to:
a. provide detailed information on request for remote monitoring e.g. contextual data, sensor data, warning notifications etc;
b. and receive information and instructions which are specific to the battery pack e.g. SoH, Failure of the BMs, prediction of failure, need service etc.

All Weather Battery Module

Description:

Title of Description

All Weather Battery Module

### TECHNICAL FIELD

Battery packs used in large electric vehicles e.g. cars, trucks, buses, vans, trains, boats to supply high voltage power to electric motors. This invention relates to large battery pack technology.

### BACKGROUND INFORMATION

Vehicles use ICEs to power its drive train. For electric vehicles a battery pack is needed to supply large power to electric motors.

Rechargeable batteries e.g. lithium Ion batteries, which are the building blocks of a battery pack, take long time to charge and have very narrow safe operating temperature and charging temperature range, depending upon its chemistry. In real world electric cars, trucks, buses, vans, trains, boats or backup power unit for hospitals, data centres and industrial units, have to operate in extreme ambient temperature range. Ambient temperatures also put thermal stresses on the batteries during usage and even when the batteries are not being used.

A Lithium ion battery can store only small amount of energy and lots of batteries are electrically connected in series and parallel to store large amount of energy e.g. 100-500 KW of energy, which can be used to power large commercial vehicles. Batteries are typically packed into small modules, so that it is easier to assemble a large battery pack and easier to replace a failed module. A number of modules are then installed inside a battery pack.

Batteries can store lots of energy but very slow in delivering this energy—power density of the batteries is very low. Capacitors though store less energy charge and discharge much faster, and have high power density. Hence a hybrid of batteries and capacitors can give a good balance of energy and power.

Capacitors can be safely operated in extreme weather conditions e.g. −40 degree Celsius to 60 degree Celsius. Batteries can safely be operated in much smaller range, depending upon the chemistry.

Thermal Management:
Air Cooling—Simple battery packs/modules deploy air cooling, which uses gaps between the batteries, to circulate the air to cool the batteries during operations and charging.

Benefits of Air-Cooling:
1. It's cheaper to install, as no pumps are required.

Drawbacks of Air-Cooling—
1. this limits their usage under ambient temperatures outside the normal range,
2. this limits the energy density (energy density for a given cubic metre space) that can be achieved.
3. In the event of small flooding, it can lead to short circuit and permanent damage to the battery pack and associated electronics.
4. Typically the batteries are hard wired. In the event of an accident the fire rescue team has to isolate the battery from rest of the vehicle to safely rescue the occupants.
Cooling Tubes/leaves—Sophisticated battery packs/modules use cooling tubes, which are in direct contact with the battery's sides to cool and heat the batteries. High pressure pumps push cooling/heating liquid through very narrow tubes/leaves interleaved with the batteries, to maximise the energy density and maximise the surface contact area with the batteries. The energy required to cool/heat the battery pack increases as the ambient temp moves away from the safe operating temp of the batteries.

Benefits of the Cooling Tubes:
1. This provides the higher energy density compared to the air-cooled battery packs.
2. The pack can be used in wider ambient range compared to air-cooled battery packs.
3. The pumps consume small enough energy (compared to the stored energy in the battery pack) to push the cooling/heating liquid around the pack, during the normal ambient temperatures and normal usage of the battery pack.

Drawbacks of Cooling Tubes:
1. In extreme (temperature below zero and temperatures above 40° C.) ambient temperatures, high pressure pumps have to push large amount of the cold or hot liquid through narrow tubes/leaves, and consume a significant amount of energy (compared to the stored energy) to cool/heat the battery pack.
2. There is a an uneven cooling or heating of the pack, as batteries close to the inlet are better cooled or heated, vs. the ones close to the outlet.
3. If one or more of the batteries in the battery pack, get into thermal runaway (uncontrolled heating) which can also lead to fire in the battery pack; it's very difficult to cool the individual batteries and extinguish the fire. Secondary technologies e.g. fuses are deployed to stop the thermal runaway. A separate technology is needed to stop the fire.
4. In the event of small flooding, it can lead to short circuit and permanent damage to the battery pack and the associated electronics.
5. Typically the batteries are hard wired within the battery pack as high power switches produce a lot of heat in close proximity of the batteries. In the event of an accident the fire rescue team has to electrically isolate the battery from rest of the vehicle, to safely rescue the occupants.

How this Battery Module Invention Solves the Technical Problems, and how it is Different

This Invention Solves the Current Technical Problems Through Many Innovative Steps:
1. Thermal management—This innovation uses dielectric liquid with a low boiling point as a carrier of heat from individual batteries/capacitors and the associated electronics in the BTBT to the condenser. Batteries are packed inside battery modules (BMs) and the BMs are laid horizontally and stacked vertically inside the battery pack. The dielectric liquid which is two phase (liquid-vapour) comes in direct contact with the batteries, the connectors, and the associated electronics. This invention has created vertical ducts in between the batteries. Bubbles are created when subcooled liquid comes in contact with the hot batteries. The bubbles are then channelled into the vertical ducts; these bubbles produce vertical flow of 2 phase dielectric liquid and vapours inside the ducts. These ducts act as heat exchangers. The process of subcooled flow boiling process cools the batteries. This vertical flow also creates low pressure inside the ducts and this creates localised a horizontal movement of liquid, cooling from its tabs.
2. Charging and discharging of batteries in extreme temperatures—this innovation uses capacitors to store energy, which is used to heat the dielectric liquid in the extremely cold temperatures e.g. −40 degree Celsius. From −40 degree Celsius to zero degree Celsius, it's not possible to charge or discharge the lithium ion batteries without damaging its life, capacitors heat up the dielectric liquid to bring the batteries temperature to the safe operating temperature. In extremely hot temperature of 45-60 degree Celsius, especially the tarmac temperature, capacitors supply power to the pump to circulate refrigerant/water through the condenser to cool the battery pack.
3. Modular design—This innovation allows the easy repair and replacement of failed BMs; and allows the extension and reduction of the capacity of the battery pack.

The Key Objectives of the Battery Module Inventions in this Disclosure are:
1. can be operated (charging and discharging) in temperature range from minus 40° C. to over 65° C.;
2. high BM energy density (Watt Hr/Kg);
3. minimum power consumption of external pumps and the amount of external liquid/refrigerant needed to be cooled/heated and circulated through the battery pack;
4. the BM is safe in the event of thermal runaway of individual batteries inside the BM and also protection from fire;
5. make the BM highly reliable; and one the key metric of reliability is the expected life of the BM;
6. failed BMs can be repaired or replaced with new BMs;
7. make the batteries last higher number of charge cycles.

### BRIEF ABOUT DRAWINGS

FIGS. 1.1 to 1.12—show the details of the battery module BM (200)

FIG. 2.2—shows the BMs inside the battery pack (100)

### DETAILED DESCRIPTION OF PREFERRED EMBODIMENT, AND HOW IT IS MANUFACTURED

The inventions will be explained through preferred examples of BM (200).

BM (200):

The aim of battery module BM (200) invention is to design an apparatus of a battery module, which:
a. is modular and fit anywhere in the battery pack;
b. can be easily manufactured and maintained;
c. is highly efficient in cooling the batteries and capacitors, in hot and extremely hot ambient temperatures;
d. is also highly efficient in heating the batteries and capacitors, in cold and extremely cold ambient temperatures;
e. power consumption in cooling/heating the batteries/capacitors is minimal;
f. can be connected in series with other BMs to increase the voltage of the battery pack;
g. can be connected in parallel with other BMs to increase the current capacity of the battery pack;
h. can be taken out of the series circuit if one or more batteries inside the BM are weakened or failed;
i. can be repurposed at end of life in an electric vehicle.

FIG. 1.1 is an illustration of a particular version of a BM. In this particular embodiment BM is shown with a base (201) with 62 cylindrical lithium-ion (Li-ion) rechargeable batteries (220) and 2 capacitors. In another embodiment these rechargeable batteries (220) could be nickel-cadmium (NiCd), nickel metal hydride (NiMH) or Lithium Cobalt-oxide LiCoO₂ or Lithium Manganese-oxide LiMn₂ O₄ or Lithium Nickel-oxide LiNiO₂ or Lithium (NCM) Nickel Cobalt Manganese—Li(NiCoMn)O₂ Lithium (NCA) Nickel Cobalt Aluminium—U(NiCoAl)O₂ or any other chemistry; in the shape of cylinder, tower, pouch or prismatic or any other shape. Further the batteries could be of high energy density. In this disclosure all these rechargeable batteries (220) of different chemistries and shapes are referred to as Batteries (220) in plural and Battery in singular. In this particular embodiment BM has 2 Electric double layer capacitors (EDLC) cylindrical capacitors, also called supercapacitors. In another embodiment these capacitors could be Asymmetric Electrochemical Double Layer Capacitor (AEDLC), Lithium Ion capacitors, or graphene supercapacitors. In this disclosure all capacitors of different electrochemical, chemistries and shapes are referred to as capacitors in plural and capacitor in singular. In another embodiment there could be any number of batteries (220) and any number of capacitors (220) in a BM.

In this disclosure, the combination of batteries and capacitors is optional. The BM (200) can be created just with batteries. The BM (200) can also be created just with capacitors.

The BM (200) is fully immersed in 2 phase dielectric liquid. In this disclosure, the dielectric liquid is a thermally conductive but electrically insulative liquid. E.g. fluorocarbons. In this particular embodiment the dielectric liquid chosen is of low boiling point which is lower than the maximum operating temperature of the batteries (220) or capacitors (220), which when comes in contact with hot batteries/capacitors (220) produces bubbles and the dielectric liquid is also heated by convection. In another embodiment a combination of pressure inside the battery pack (101) and the high boiling point of the dielectric liquid can be used, to achieve a higher boiling point of the dielectric liquid inside the battery pack (101). E.g. if the battery pack is used at high altitudes, it would lower the boiling point of the dielectric liquid, the battery pack (101) can then be pressurised to increase the boiling point of the dielectric liquid inside the battery pack (101).

In FIG. 1.2, in this particular embodiment the BM (200) is shown with cylindrical batteries (220) and capacitors (220), and a separator (207) is arranged between two neighbouring batteries/capacitors (220). In this embodiment, the separator has cross-section of a concave. In another embodiment this separator can have cross section of a rectangle e.g. a separator between two prismatic batteries; or a polygon e.g. a separator between two pouch batteries. One of the Innovations here is that separators (207) not only acts as a buttress to keep the battery/capacitor in its place, but also the combinations of these separators and the sides of the batteries/capacitors are used to create vertical ducts (205). FIG. 1.2 shows the bottom side of the base (201), it shows a polygon shaped opening in the base and this matches with the duct created between 4 batteries/capacitors. In this embodiment, the polygon shaped duct (205) has 8 sides, with 4 sides created by separators and 4 sides created by the sides of the batteries/capacitors.

In FIG. 1.2, in this particular embodiment the base (201) also has circular openings for batteries, so that cylindrical batteries/capacitors (220) can slip fit into the openings.

In this embodiment, battery pack (100) has electrical configuration of 128P64P, the BM (200) has 62 batteries (220) electrically connected in parallel and 2 capacitors (220) electrically connected in parallel. However in another embodiment it can be mix of electrically serially and parallel connected batteries/capacitors (220). In further embodiment it could just be batteries in the BM (200) connected in series or parallel. In another embodiment it could just be capacitors in the BM (200) connected in series or parallel.

In FIG. 1.3, in this particular embodiment, the lid (202) is shown with its outer face and its inner face, which has the mechanical matching openings as the base (201). There is a mechanical mating cut-out for the separator (207) and the cut outs (208), which allow the lid to fit into the base.

In FIGS. 1.4 and 1.5, the lid (202) fits into the base (201). The separators (206) on the edges of the BM mate into the lid. The separators (207) away from the edges, pass through the lid and help align the mechanical openings of the lid with the base.

In FIG. 1.6 in this particular embodiment, the electrically positive connecting plate (203) is shown, which has the cut-outs matching with base (201) and the lid (202) for the ducts (205), and has openings to electrically connect the positive terminals of the batteries/capacitors (220). In this embodiment positive plate (203) is a PCB with ICs (integrated circuits) and electronic circuits for Battery/capacitor charge controller, temperature measuring devices fitted on the inner side (not shown). There is also an I2C or SMBus or PMbus terminal (212). In another embodiment the negative plate (204) could be the PCB with the Battery/capacitor charge controller, temperature measuring devices, and circuitry, with I2C or SMBus or PMbus terminals (212). In another embodiment the electronic circuitry can be split between positive plate (203) and negative plates (204), hence both plates may have electronic circuitry, and one of them can have I2C or SMBus or PMbus terminals.

In FIG. 1.6 in this particular embodiment, the positive plate (203) has positive terminal to supply the power from the batteries/capacitors (220) in the BM. In this embodiment of battery pack of 128S64P configuration, BM (200) has 62 batteries are electrically connected in parallel with 3.4 nominal voltage of each battery and 4.2v of max voltage of each battery, and two capacitors of 500 Farad with 2.7v of max voltage are also connected to the PCB plate. The high voltage of the BM in this embodiment is roughly 4.2V. In another embodiment with a battery pack configuration of 160S256P, BM (200) has 248 batteries of 3.4v nominal and 4.2V can be connected in parallel and 8 capacitors of 500 Farad also connected in parallel. In another embodiment large individual batteries may be used e.g. in case of pouch battery. In this disclosure output power terminals (221) of the BM, as shown if FIGS. 1.6 and 1.8, are referred to as module high voltages (HV) terminals.

As shown in FIGS. 1.6 and 1.7, in this particular embodiment, the positive plate (203) has positive HV terminal (221) to supply power to the battery pack's (100) sidewall mounted HV terminal (132); and also has positive charging terminal (211) to receive power from the battery pack's (100) sidewall mounted charging terminals (142). Battery/capacitor charge controller 240 (not shown) gets power from this charging terminal (211) to charge the batteries. This charging voltage can be any voltage from 12v to 48v. In another embodiment the charging voltage could be higher voltage e.g. 90v. In this disclosure all module charging voltage terminals (211) are referred to as module charging terminals.

In FIG. 1.7 in this particular embodiment, the positive plate (203), and the negative plate (204) are shown. The negative plate (204) also has the mechanical cut-outs matching with base (201), the lid (202), and the ducts (205), and has openings to electrically connect the negative terminals of the batteries. The negative plate (204) has negative module HV terminal (221) and negative module charging terminal (211).

As shown in FIG. 1.8, in this particular embodiment, the base (201) with batteries/capacitors (220), the lid (202), the positive plate (203) and the negative plate (204) are assembled to form a BM (200).

It has the separators (207) extending vertically from the BM, which are designed to mate with another BM (200) which is stacked on top. There are matching openings in the base (201), as shown in FIG. 1.2, which mate with the separators (207) of the BM (200) stacked below.

FIG. 1.8 shows the complete BM (200), in the particular embodiment of battery pack (100), it has 128 such BMs. These BMs are not location specific and can be located anywhere within the battery pack (100). There are standardised 4 electrical terminals, 2 module HV (positive and negative) terminals (221), and 2 module Charging (positive and negative) terminals (211); and 2 electronic communication (I2C or SMBus or PMbus) terminals (212) per BM. This eases the manufacturing and maintenance of the BMs. This modular design of BM (200) is another innovation e.g. in this embodiment each BM has identical electrical configuration of 64P. In another embodiment of BM in a battery pack configuration of 160S256P, there are 80 BMs; each BM with 2S256P (2 sets of 256 parallel connected batteries/capacitors) configuration. In preferred embodiment, the configuration of 160S256P is implemented in 640 BMs; each BM is 64P (62 batteries and 2 capacitors). In another embodiment of the BM the communication terminals (212) can be also be missed altogether and implemented using wireless connections. In another embodiment capacitors can be missed altogether e.g. with improved technology in batteries e.g. graphene batteries.

As shown in FIG. 1.9, ducts (205) go through the negative plate (204), the base (201), the lid (202) and the positive plate (203).

FIG. 1.10 shows when BMs (200) are stacked vertically, the ducts (205) within each BM (200) align and form straight through vertical ducts (205).

FIG. 1.8 and FIG. 1.11 show the fully assembled BM (200). It has two module (positive and negative) charging terminals (211), two module HV terminals (221), and two communication terminals (243). The FIGS. 1.8 and 1.11 also show how the base (201), the lid (202), the positive plate (203) and the negative plate (204) come together to form the BM (200). The figures also show the separators (207), stick out of the BM which mate with another BM (200) stacked on top. The FIGS. 1.8 and 1.11 also show how the batteries (220) and the ducts (205) are symmetrically arranged.

How these Ducts Work as Heat Exchangers to Cool and Heat the Batteries:

When the dielectric liquid in the duct comes in contact with the hot batteries/capacitors (220), portion of the liquid is converted into bubbles resulting in mixture of bubbles and liquid. In this embodiment as shown in FIG. 1.9, the separators (207), guide the bubbles into the duct (205). As shown in FIG. 1.12, these bubbles create a vertical flow (251) of bubbles and dielectric liquid inside the ducts (205), prior to boiling of the dielectric liquid. This results in cooling of the battery/capacitor sides by convection. Bubbles and the liquid reach the surface of the liquid (as the BM is submerged and the surface of the liquid is outside the BM) and some of the bubbles detach from the liquid and are cooled by the condenser. The battery pack delivers the subcooled liquid at the base of the BM. Each battery/capacitor (220) side is cooled by 4 ducts (205). As the width of the duct is large compared to the size of the bubbles the core of the duct stays in liquid state, the vertical flow (251) of liquid continues for long time, under normal usage of the battery and in the normal ambient temperatures. However if the temperature rises in the core of the duct either due to continued heavy use of the batteries/capacitors or in extreme ambient temperatures, more vapours are generated in the duct as liquid boils on the surface of the batteries/capacitors, bubbly flow will increase the vertical lift and reduced pressure inside the duct will suck in more subcooled liquid from the base of the BM. This results in faster circular flow of the liquid until the temperature falls below the boiling point. Battery pack controller (140) controls the flowrate of coolant in the condenser. Thus the ducts (205) act as heat exchangers with sides of the batteries/capacitors (220) are cooled by the subcooled liquid which enters at the bottom of the BM and liquid and bubbles leave at the top of the BM.

In this disclosure temperatures below zero and temperatures above 40° Celsius are referred to extreme temperatures and temperature between zero and 40° Celsius are referred to as normal temperatures.

This is another key innovation here that the subcooled liquid is serviced at the bottom of the ducts (205) and cooling of the batteries/capacitors (220) is achieved using the process known as ‘Subcooled flow boiling’ of dielectric liquid, this allows the BMs to operate further away from Critical heat flux conditions (thermal limit where suddenly heat transfer efficiency decreases and creates a overheating).

(There are two types of boiling phenomenon—pool boiling and flow boiling. In pool boiling the heating surface is submerged in the liquid whereas flow boiling is normally confined to flow channels. Subcooled flow boiling in this disclosure is referred to as boiling when the flow temperature is below the saturation level).

Even if a single duct gets into saturated state and vapour percentage reaches close to 100% e.g. a single battery overheats due to its chemistry etc, the BM which is made of material with very high thermal conductivity and preferably also a microporous material, redistributes the heat away from the duct and the duct will quickly go back to the liquid state. As each battery/capacitor is cooled by 4 ducts (205), a saturation state in a single duct does not severely impact the battery, as the battery/capacitor will continue to be cooled by other 3 ducts (205) and from the tab. These are further innovations here, the heat conducting material of the BM is used to create second line of defence, to act as a heat distributor should a single duct gets into saturated state; and redundancy is created for each battery in terms of exposure to ducts (205) i.e. in this embodiment each battery is part of 4 ducts (205).

The battery/capacitor sides which are exposed to ducts (205) can be optionally coated with microporous material to enhance the heat transfer from the sides e.g. if very high current 4 C or more is drawn from the batteries e.g. in the case of performance electric vehicles.

Even if a single battery goes into thermal runaway and fire during charging or discharging, the subcooled liquid in all four ducts (205) will put out the fire, the ducts will act as chimneys to let the fumes escape the BM, and the battery pack controller (140) will open the solenoid valve (113) to release the fumes and smoke. The separators also act as barriers to shockwave or cascade effect of thermal runaway or explosion.

The battery pack controller (140) checks the temperature of the BMs continuously, and if the temperature within BMs reaches beyond its tolerance range, it switches off the circuit using the relays, to protect the BM (200) and the battery pack. This is another innovation here—the battery pack controller (140) acts as third line of defence and battery pack controller does not need to severely restrict the usage of the battery pack, as isolated event of an individual battery heating is handled by the BM (200).

In this embodiment the battery pack controller is installed inside the battery pack, however in another embodiment it can be installed outside the battery pack (100).

How Vertical Stacking of BM (200) Work Inside the Battery Pack (100):

FIG. 1.12 shows, when the BMs (200) are vertically stacked, the ducts (205) of all the vertical stacked BMs (200) are aligned to form vertical ducts (205). The separators (207) of each BM (200) are used to vertically align the BMs (200).

The vertical flow continues through the stacked BM (200), inside the ducts (205), until it reaches the surface of the dielectric liquid. As shown in FIG. 1.12, the vertical flow (251) of dielectric liquid also creates a low pressure inside the ducts (205); and low pressure creates a localised horizontal flow (250) of liquid towards the ducts; and the low pressure sucks in hot liquid from the gaps in between the stacked BM (200), which in turn sucks in hot liquid from the tabs of the batteries; harnessing the effects documented in Bernoulli's theorem.

Description

Title of Description

An apparatus and method for charging a battery pack, and decoupling the charging voltage from the battery pack voltage

### TECHNICAL FIELD

Battery packs used in large electric vehicles e.g. cars, trucks, buses, vans, trains, boats to supply high voltage power to electric motors. This invention relates to large battery pack technology.

### BACKGROUND INFORMATION

Vehicles use ICEs to power its drive train. For electric vehicles a battery pack is needed to supply large power to electric motors.

Rechargeable batteries e.g. lithium Ion batteries, which are the building blocks of a battery pack, take long time to charge, depending upon its chemistry.

Large commercial vehicles with large battery packs require long charging times to charge the battery pack, and while the vehicle is being charged vehicles are not economically productive. For better utilisation of such vehicles the battery pack must charge in shortest possible time.

Battery charging/balancing—it is a key technology in a large battery pack which can power an electric vehicle. Given the high voltage requirements of a large battery pack of around 300v to over-500V DC; large number of Li-on batteries which have nominal voltage of around 3.6V need to be connected in series and parallel to achieve high voltage and high current.

During charging, the whole of battery pack, with large number of serially connected batteries is charged through a single high voltage DC charger. During this process individual batteries charge to different voltages, resulting in some batteries overcharging while some undercharging. This happens due to individual battery's inherent chemistry and history of usage. This overcharge can result in significant degradation of the batteries. To solve this overcharging and undercharging issue, there are various methods used in the industry to balance (equalise) the charge across the battery pack—these methods are broadly classified as Active and Passive.
a) Active balancing methods transfer the current from highly charged batteries to less charged batteries during the charging process—this method achieves excellent balancing results however it slows the charging process as the charging has to be stopped to avoid damage to the overcharged batteries until the charge is reduced to the max level allowed by the chemistry. Thus Active method is a stop start charging/balancing process.
b) Passive balancing methods simply waste the excess charge of overcharged batteries through resistors and thus easier to implement, however this method create heat in the vicinity of batteries and reduces the charging efficiency.

Drawbacks of the Current Charging/Balancing Process:
a. The charging process has to stop until an overcharge battery is brought back into the tolerance range of the charging. The charging is resumed when the overcharged issue is rectified. For a very large battery with thousands of small batteries this stop start process consumes a lot of charging time.
b. If a battery or group of batteries are failed, it's not possible to simply replace the failed batteries with new batteries as it would result in old batteries with lower capacity and new batteries with high capacity. The active or passive balancing methods would not be able to distinguish the new batteries from the old batteries and likely to end up overcharging old batteries.

How this Charging Apparatus Invention Solves the Technical Problems, and how it is Different

This invention solves the current technical problems through many innovative steps:
1. Decoupling of charging voltage from the output voltage of the battery pack—this invention decouples the input voltage from the battery pack output voltage which is based on battery pack configuration. Hence the battery packs of any configuration can be charged using large chargers and charging voltage is no longer tied to the battery pack voltage.
2. Charging and Balancing the batteries—This innovation measures SoC from a group of batteries and voltage from a group of capacitors connected in parallel and uses a algorithm which calculates the ‘balanced SoC’ and ‘balanced voltage’ for all the said groups. Battery/capacitor charge controllers installed inside battery modules (BMs), charge each of this said group with a specific voltage and current. The individual batteries and individual capacitors which are connected in parallel are then allowed to self balance within their respective groups. This extends the life of the batteries as these are not overcharged and then charge removed. This also saves time to charge the battery pack.

The Key Objectives of the Charging Apparatus Inventions in this Disclosure are:
1. Decoupling of the charging voltage from the output voltage of the battery pack. The battery pack can be charged at any voltage whereas the discharging voltage is determined by the configuration of the battery pack.
2. Extend the life of the battery pack;
3. Fast charging of the battery pack.

### BRIEF ABOUT DRAWINGS

FIG. 4—the schematic circuit diagram of overall system of charging of the batteries/capacitors

FIG. 2.2—shows the charging terminals and the BMs inside a battery pack

### DETAILED DESCRIPTION OF PREFERRED EMBODIMENT, AND HOW IT IS MANUFACTURED

The inventions will be explained through preferred examples of selective charging circuit (300).

The aim of this invention from technical point of view is to design an apparatus of a battery pack charger, to:
a. provide faster charging of the batteries by saving time spent on charging the batteries and then removing the charge from the overcharged batteries to balance the batteries/capacitors;
b. decouple the DC charging voltage from the DC output voltage. The battery pack can be charged at any DC voltage e.g. up to 1200v, while the battery pack DC output voltage is pre-defined;
c. electrical modular designs of the battery pack, so that a battery module (BM) can be replaced or taken out of the electrical circuit, without disrupting the electrical connection of other BMs.

The second aim of this invention, from usability of the battery pack point of view, is to design an apparatus of a battery pack charger, to:
a. extend the range of the battery pack, by maximising battery pack capacity utilisation and storing regenerative current with minimal losses;
b. extend the longevity of the batteries, by not overcharging weak batteries, while fully charging the stronger batteries;

In this disclosure, SoC is the State of Charge (SoC) which is a gauge of charge with in battery usually expressed in percentage e.g. 80% charge. It is expressed as % of manufactured capacity. State of Charge (SoC) of each battery/capacitor can be measured by any method including coulomb counting methods. Depth of Discharge (DoD) is how much charge is left before the battery/capacitor is recharged.

SoH means remaining capacity compared to manufactured capacity e.g. 95% of remaining capacity.

In this disclosure, Battery pack controller (140) determines the failure of a battery or a battery module (BM) (200). Battery pack controller's algorithm takes into battery's history of charging, impedance, SoH, thermal runaway etc and determines the failure of the battery, or if more than one battery is failed inside a BM, battery pack controller (140) deems the BM as a failed BM. In this disclosure the failure of batteries or capacitors or BM refers to Battery pack controller's declared failure.

In this particular embodiment the battery pack has a configuration of 128S64P, with 128 battery modules (BMs) connected in series, and each BM has a configuration of 62 batteries connected in parallel and 2 capacitors in parallel.

In this particular embodiment BM has 62 cylindrical lithium-ion (Li-ion) rechargeable batteries (220) and 2 capacitors. In another embodiment it could be derivative of Li-ion or any other chemistry; in the shape of cylinder, tower, pouch or prismatic or any other shape. Further the batteries could be of high energy density. In this disclosure all these rechargeable batteries (220) of different chemistries and shapes are referred to as Batteries (220) in plural and Battery in singular. In this particular embodiment BM has 2 Electric double layer capacitors (EDLC) cylindrical capacitors, also called supercapacitors. In another embodiment these capacitors could be Asymmetric Electrochemical Double Layer Capacitor (AEDLC), Lithium Ion capacitors, or grapheme supercapacitors. In this disclosure all capacitors of different electrochemical, chemistries and shapes are referred to as capacitors in plural and capacitor in singular. In another embodiment there could be any number of batteries (220) and any number of capacitors (220) in a BM.

In another embodiment a group of batteries and a group of capacitors can be arranged together inside a larger pack, without the mechanical casing of a BM. Each such group of batteries and capacitors is considered as one BM. If one or more such groups are connected in series or parallel, then multiple BMs are considered to be connected in series and parallel.

In this particular embodiment 128 BMs are connected in series. In another embodiment large batteries/capacitors can be horizontally and/or vertically arranged, using one or more mesh like structures, without using multiple BMs. In such an embodiment the electrical connections to the batteries/capacitors are embedded inside the mesh or laid above or below the mesh. In further embodiment part of the wiring can be based on radio signals, especially the control signals. For this disclosure each such mesh like structure is considered as one BM. In this disclosure, if multiple layers of mesh like are structures are stacked, each layer is considered as one BM and vertical layers of mesh are considered as vertically stacked BMs.

In this disclosure, the combination of batteries and capacitors is optional. The BM (200) can be created just with batteries. The BM (200) can also be created just with capacitors. FIG. 4 is an illustration of a particular embodiment of a Charging circuit (300). In this circuit battery pack controller (140), is the master controller of all charging.

The invention of battery pack charger, has two key components:
1. balanced charging circuit—it's an electronic hardware circuit.
2. balanced charging algorithm—it's an algorithm installed inside battery pack controller.

The balanced charging circuit has further four key sub-components:
1. Battery pack controller (140) which is a master controller and made up of hardware and software. This balanced charging algorithm is installed in this controller;
2. AC/DC-DC converter (135) which converts AC/DC to DC;
3. and Energy charging split circuit (160), which acts a slave to the battery pack controller (140);
4. battery/capacitor charge controller (240), which acts a slave to the battery pack controller (140)

Battery pack controller algorithm (140) controls the Energy charging split circuit (160) which controls the input to the AC/DC to DC converter (135). Energy charging split circuit (160) and AC/DC to DC converter (135), together form the power board (130)(not shown). The power board in this embodiment is installed inside the battery pack (100). In another embodiment the power board can be installed outside the battery pack (100).

The AC/DC to DC converter (135) is referred to as converter (135) in this disclosure. In this embodiment, when a regenerative current is sensed regenerative supply is connected to the converter (135). When an external AC or DC charger is manually connected to the vehicle, either DC charger (32) or AC charger (33) is connected to the converter. In another embodiment only AC and/or DC street charger inputs are connected to the converter (135), and regenerative power is ignored which can be considered not worth storing.

In this embodiment the battery pack controller (140) is installed inside the battery pack, however in another embodiment it can be installed outside the battery pack (100).

In this embodiment AC/DC-DC converter (135) is an isolated AC (single phase and three phase) to DC, and DC to DC buck converter. In another embodiment the converter (135) can be bi-directional AC to DC to AC, as well as DC to DC converter, an additional switch may also be connected (not shown) which connects the converter's output to external AC terminal (33) and input to the High output of the battery pack.

As shown in FIG. 4, the AC/DC-DC converter (135) supplies the DC charging bus (132). In this embodiment, the voltage of the charging bus (132) is at intermediate level e.g. 20v or 48v. It's a step-down from the input high voltage DC and input high voltage AC (single and three phase), and higher than the maximum battery voltage of 4.2V or the capacitor voltage of 2.7v. In another embodiment the voltage of the charging bus can be the same as the DC street charger (32) voltage. In another embodiment the voltage of the charging bus voltage can be same as the max voltage of the batteries e.g. 4.2V.

In FIG. 4, the voltage of DC street charger (32) can be anything from 60v to 1500v depending upon the street charger. Battery pack output voltage of DC bus in this embodiment is 128*4.2v=max 537.6V. However in another embodiment of 160S256P configuration the Battery pack output voltage of DC bus is 160*4.2v=672V. Both of these configurations can be charged by a charger having any voltage from 60v to 1500v. One of the innovation here is that any battery configuration can be charged by this innovative battery pack charger using any input voltage.

High voltage in this disclosure is referred to charging and discharging voltage of 60v to 1500v.

As shown in the FIG. 4, in this embodiment each BM (200) has a Battery/capacitor charge controllers (240), which is acting as slaves to the battery pack controller (140). In this embodiment, as shown in FIG. 4, a Battery/capacitor charge controller (240) charges a group of the batteries as well as a group of capacitors, within the BM (200); which are electrically connected in parallel, with a specific charging voltage and specific charging current, as per the instructions sent by battery pack controller (140) over the communication line I²C or SMbus or PMbus. However in another embodiment, the group of batteries connected in parallel are divided into sub-groups and there could be plurality of battery/capacitor charge controllers (240) within each BM, responsible to charge each sub-group. In further embodiment, the group of batteries may have serial as well as parallel connections, and there could be further sub-groups, with each sub-group having its own set of batteries electrically connected in parallel and sub-groups are electrically connected in series. In another embodiment there could be one battery charge controller (240) for each battery and one capacitor charge controller for each capacitor.

In this disclosure electronic connection means when two devices communicate with each other through electronic (digital or analogue) signals e.g. electronic connection between battery pack controller (140) and a sensor or electronic connection between battery pack controller (140) and battery charge controller (240).

In this disclosure all the charging circuit, which includes SoC/voltage measurement devices, current measurement devices, temperature measurement devices etc, responsible for the charging the batteries and capacitors as per the instructions from the battery pack controller is referred to as battery/capacitor charge controller. Battery/capacitor charge controller (240) can be built using Integrated circuits or other electronic components. In this disclosure any electronic circuit doing the function of charging battery/capacitor is referred to as battery/capacitor charge controller (240).

In this embodiment, the Battery/capacitor charge controllers (240) take the input power from the Charging bus (132). As shown in FIG. 4, in this embodiment all Battery/capacitor charge controllers (240) are electrically connected in parallel, to the charging bus (132). In another embodiment there is no charging bus (132) and each battery/capacitor charge controller (240) can be directly connected to the AC/DC converter (135).

In this embodiment, each BM (200) has a group of 62 electrically parallel connected batteries and a group of 2 electrically parallel connected capacitors, and each group of batteries and capacitors are separately charged, by the Battery/capacitor charge controller (240). However in other embodiment in each BM (200) there could be series as well parallel electrically connected batteries e.g. BM configuration of 2S256P, where there are 2 sets of 248 parallel connected batteries and 2 sets of 4 parallel connected capacitors, in such an embodiment of a BM, the Battery/capacitor charge controllers (240) will charge two sets of 248 batteries separately with their own voltage and current, and two sets of 4 capacitors separately.

In this embodiment, battery pack controller (140), gets the measurements of voltage, SoC etc from each battery and each capacitor supplied by the battery charge controller, and calculates the ‘balanced SoC’ and ‘balanced voltage’ for the said group of batteries and the said group of capacitors. In another embodiment battery pack controller (140) can get voltage and SoC from a sample of batteries and a sample of capacitors to calculate the balanced SoC and the balanced voltage.

Balanced SoC is the SoC, calculated by the algorithm, such that all batteries in all the BMs within the Battery pack (100) are charged to the same SoC. Optimum balanced SoC is the maximum balanced SoC for all the BMs taking into account the SoH of the weakest BM in the series. Optimum balanced SoC is less than 100% e.g. if the weakest BM in series has a remaining capacity of 95%, then 95% is the Optimum balanced SoC for the whole battery pack.

Optimum balanced voltage for the capacitors however is based on the maximum current demands as determined by the battery pack controller. PI note: In this embodiment voltage is assumed to be proportional to the SoC levels of the capacitors. If however in another embodiment capacitors may have voltage which is not proportional to the SoC levels, then SoC is used for capacitors as well. Maximum current demands are specific to the application of the battery pack e.g. stop/start bus has high regenerative current storage demand and performance electric vehicle has high peak current demand.

In this disclosure, Balanced SoC and Balanced Voltage are the equalised charging for batteries and capacitors respectively, at any point during the charging process. Optimum balanced SoC and Optimum balanced voltage are the maximum equalised charging for batteries and capacitors respectively.

As shown in the FIG. 4, Battery pack controller (140) is connected to the cloud based operational centre (43). The battery pack controller creates a log of history of usage of each battery/capacitor and each BM. Using the history of usage e.g. history of charging, terminal voltages, senor data etc, in this embodiment, operational centre (43) software calculates its SoH for each battery/capacitor and each BM, these calculation are specific to the battery pack depending upon the ageing of the battery pack. In this disclosure SoH refers to operational centre calculated SoH. Battery pack controller sends sensor and context data to the operational centre for it to calculate the SoH of the batteries.

In another embodiment SoH is calculated by the battery pack controller using its compute capacity.

Battery pack controller then calculates in real time, charging voltage and charging current to be used by each battery/capacitor charge controller (240) based on the existing SoC of the batteries/capacitors and the optimum balanced SoC and optimum balanced Voltage. Battery pack controller then selectively instructs each Battery/capacitor charge controller (240) using its ID, to charge the batteries/capacitors (220) with a specific charging voltage and specific charging current.

Battery pack controller continues the step by step process of calculating the Balanced SoC and Balanced Voltage and charging the batteries and capacitors, until the optimum balanced SoC is reached for the batteries and balanced voltage is reached for the capacitors, or there is no charging current available.

As shown in FIG. 4, in this embodiment, all Battery/capacitor charge controllers (240) have the same input voltage through the charging bus (132), and these charge controllers (240) dynamically change the output to charging voltage and charging current which is specific to the group/sub-group of batteries or capacitors (220), as per the instructions from the battery pack controller (140).

While getting and while getting charged by the battery charge controller, all the batteries (220) as well as capacitors (220) which are electrically connected in parallel within each group or subgroup, are allowed to self balance, within their respective group/subgroups. Self balance means batteries/capacitors connected in parallel pass current from higher charge battery/capacitor to lower charged battery/capacitor until all the batteries or capacitors connected in parallel are balanced charged or have the same voltage.

As shown in FIG. 4, one or more auxiliary batteries e.g. low voltage lead acid batteries or gel batteries, are also charged by DC-DC converter or battery charge controller (240) connect to the charging bus (132) as its input.

In this embodiment of electrical configuration of 128S64P, 128 BMs are electrically connected in series. As shown in FIG. 4, there is a separate charging for each BM (200). All BMs (200) are charged simultaneously through separate battery/capacitor charge controllers (240).

One of the key innovations here is instead of charging all the BMs connected in series through a high voltage single power supply, this innovation selectively charges each group of batteries where all the batteries are electrically connected in parallel, with a separate power supply. Hence the battery pack can be charged by any voltage (depending upon the range of the converter) as it is being converted into the charging bus voltage, and the battery pack output voltage can be designed to match the motor controller voltage. This decouples the DC charging voltage/current from the DC output voltage/current. The DC street chargers that need to put in say 350 KWhr power into vehicles have to maximise on the voltage to say 1000v and minimise on the current to say 350 amps, as higher current means thicker charging cables. For the same power, electric motors (31) being powered by the battery pack, conversely want higher current and lower voltage, as torque is proportional to the current. Hence this innovation allows that the battery pack of 100 KW can be charged by a 3 KW charger, 30 KW charger, 100 KW and even 350 KW charger. This innovative battery pack charger is agnostic to the battery pack output voltage.

Another innovation is, instead of overcharging some BMs and undercharging some BMs as would have been case if we charge all the BMs connected in series, through a single high voltage power supply; this innovation selectively charges each group of batteries/capacitors directly to the ‘Balanced SoC’ and ‘Balanced voltage’ without having to through the stop start balancing process. This speeds up the charging process, as this innovation does not need to stop charging until an overcharged BM has lost its charge. The overcharging is less common with this invention as all the BMs are charged to a specific voltage using a specific current. However if an overcharge occurs in a given group of batteries, this innovation will simply stop charging the said group of batteries/BM, and continue with the others, until the said group of batteries/BM has self balanced or the said BM/s has the same level of charging as other BMs. The battery pack controller software will continue to take SoC readings of the said BM/s, and will only restart when the overcharge is rectified.

Another innovation is that the battery pack controller's algorithm calculates the balanced SoC and Balanced voltage, and charges all the groups of batteries connected in series to the maximum of Optimum balanced SoC. The algorithm uses learning from the previous charging, e.g. what was the calculated balanced SoC and how much SoC was achieved using a specific charge voltage and charge current. The charge current/charge voltage relationship with the SoC changes as the batteries age, as weaker batteries charge quickly and also take in less charge than stronger batteries to reach the same SoC levels. Thus unevenly aged batteries can be balanced and it maximises capacity utilisation.

Another innovation is the algorithm takes the SoH of the batteries into account to calculate Optimum balanced SoC. This allows for uneven ageing of the batteries/capacitors, and at the same time it maximises the capacity utilisation of all groups of batteries connected in series.

The algorithm gets informed by the operation centre about the SoH of the batteries and it keeps a log of each battery's health (SoH) levels which goes down as the batteries age. Thus when a failed BM (200) is replaced in the battery pack, this log is updated with the SoH of the batteries of the new BM, and the battery pack controller (140) knows that the new BM has higher capacity and it will reset the Optimum balanced SoC to the next weakest BM. This innovation saves having to discard the entire battery pack if a single BM needs changing.

Further innovation here is that batteries connected in parallel within a group or subgroup, inside a BM, are self balanced to speed up the charging process. In this embodiment the charging process is actually balanced charging only 128 BMs, and while the 128 BMs are being balanced charged, the 62 batteries within each BM are self balancing in tandem. There are 128*62=7936 batteries in all the BMs; the battery controller's algorithm is only actively balancing 128 sets of batteries. This also speeds up the charging process.

Further innovation is that each BM stores all its share of regenerative energy in capacitors, as the regenerative energy normally has large current and only available for few seconds, which may not be enough time to store in the Batteries. The capacitors inside each BM maximise its storage of regenerative energy and charge up to optimum balanced voltage. The optimum balanced voltage for capacitors is calculated by the battery pack controller.

Further innovation is that the Energy charging split circuit (160) switches the inputs to DC-DC the converter between, high voltage DC supply, AC supply and regenerative energy. As only one of the inputs is used at any one time, this makes the most effective use of the DC-DC converter part of the converter.

In this embodiment, batteries within the battery pack are from the same manufacturer; have the same chemistry; have the same capacity, have the same voltage, and these batteries are balanced charged at the time of the manufacture of the battery pack, and preferably the capacitors within the battery pack are from the same manufacturer; have the same chemistry; have the same capacity, have the same voltage, and these capacitors are balanced charged at the time of the manufacture of the battery pack. In another embodiment, batteries can be from different manufacturers, and capacitors can also be from different manufacturers. In another embodiment, Batteries and capacitors can have different capacity which are connected in parallel, while keeping the BMs connected in series having equal current capacity.

An Apparatus and Method for Discharging the Hybrid Battery Modules, and Extending the Range of the Battery Pack

Description:

Title of Description

An apparatus and method for discharging the hybrid battery modules, and extending the range of the battery pack

### TECHNICAL FIELD

Battery packs used in large electric vehicles e.g. cars, trucks, buses, vans, trains, boats to supply high voltage power to electric motors. This invention relates to large battery pack technology.

### BACKGROUND INFORMATION

Large battery packs are needed to supply large power to electric motors. A number of battery modules (BMs) are assembled to create a large Battery pack.

Large commercial vehicles need large torque during acceleration or going up a hill. Hence these vehicles draw high current during acceleration or going up a hill. Peak current reduce the battery life and reduce the range of the batteries for the same charge.

All BMs within a battery pack do not age equally and end up with different capacity overtime. This uneven ageing of BMs means that during peak current supply, the overall energy/power output is limited by the weakest BMs. Hence weakest BMs come under most stress during peak demand, and this limits the range of the vehicle and shortens the path to thermal runaway and number of cycles a battery pack can last.

How this Invention Solves the Technical Problems, and how it is Different

This invention solves the current technical problems through many innovative steps:
1. During discharge, the battery pack will run out of the available energy when the BM with the weakest batteries connected in series, reach the minimum SoC levels as determined by the battery pack controller (140). This weakest BM may be less than 1% of the installed capacity of a large battery pack. This algorithm selectively instructs the capacitors in the weakest BMs to supply the current. This may lead to deep discharge of capacitors but it has no real impact on the cycle life of capacitors. This extends the range of the battery pack without stressing or deep discharge of the weak batteries.
2. Capacitors support the batteries during peak demand—One of the key reason of battery's reduced life and lower range compared to installed capacity, apart from exposure to extreme temperatures is erratic high current demand e.g. during acceleration, going uphill, aggressive driving etc. This innovation uses capacitors which have high power density, and can help reduce the peak discharge demand on batteries and especially the weakest batteries. The algorithm provides the selective mix of battery energy based on the SoH and SoC of the batteries and SoC of capacitors within each BM. The capacitors which can fast discharge, can capture almost all the regenerative energy and service the peak current demand, whereas the batteries can discharge slowly supply the average demand of current. This increases the expected life of the BMs by not stressing the batteries during peak load and increases the range of the battery pack as batteries deplete faster through peak currents.

The Key Objectives of the Inventions in this Disclosure are:
longer range of the battery pack;
make the batteries last higher number of charge cycles.

### BRIEF ABOUT DRAWINGS

FIG. 5—shows the schematic circuit diagram of the overall system of discharging of BMs.

FIG. 6—shows the schematic diagram of a circuit within a BM.

### DETAILED DESCRIPTION OF PREFERRED EMBODIMENT, AND HOW IT IS MANUFACTURED

The inventions will be explained through preferred examples of selective discharging circuit (400) for batteries and capacitors in each battery module (BM) (200) and an algorithm installed in the battery pack controller.

The first aim of this invention from technical point of view is to design an apparatus of a battery pack discharger, to:
a. Support weakest batteries when these are discharged to the minimum SoC level, and thus avoiding the deep discharge (higher discharge than recommended) on weakest batteries;
b. decouple the peak discharging current of the battery pack from the maximum discharging current of the batteries connected in series

The second aim of this invention, from usability of the battery pack point of view, is to design an apparatus of a battery pack discharger, to:
a. extend the range of the battery pack by using capacitors to supplement the weakest batteries inside a BM, and thus weakest/weaker BMs are no longer the limiting factor of capacity utilisation;
b. extend the range of the batteries by capturing all the regenerative energy in the capacitors;
c. extend the cycle life of the batteries by using capacitors to supply the peak current, as peak current degrade the batteries faster.
d. extend the range of the batteries as batteries deplete faster through peak current loads.

In this disclosure, SoC is the State of Charge (SoC) which is a gauge of charge with in battery usually expressed in percentage e.g. 80% charge. It is expressed as % of manufactured capacity. State of Charge (SoC) of each battery/capacitor can be measured by any method including coulomb counting methods. Depth of Discharge (DoD) is how much charge is left before the battery/capacitor is recharged.

SoH means remaining capacity compared to manufactured capacity e.g. 95% of remaining capacity.

In this embodiment the battery pack has a configuration of 128564P, with 128 battery BMs (BMs) connected in series, and each BM has a configuration of 62 batteries connected in parallel and 2 capacitors in parallel.

In this particular embodiment BM has 62 cylindrical lithium-ion (Li-ion) rechargeable batteries (220) and 2 capacitors. In another embodiment it could be derivative of Li-ion or any other chemistry; in the shape of cylinder, tower, pouch or prismatic or any other shape. Further the batteries could be of high energy density. In this disclosure all these rechargeable batteries (220) of different chemistries and shapes are referred to as Batteries (220) in plural and Battery in singular. In this particular embodiment BM has 2 Electric double layer capacitors (EDLC) cylindrical capacitors, also called supercapacitors. In another embodiment these capacitors could be Asymmetric Electrochemical Double Layer Capacitor (AEDLC), Lithium Ion capacitors, or graphene supercapacitors. In this disclosure all capacitors of different electrochemical, chemistries and shapes are referred to as capacitors in plural and capacitor in singular. In another embodiment there could be any number of batteries (220) and any number of capacitors (220) in a BM.

In another embodiment a group of batteries and a group of capacitors can be arranged together inside a larger pack, without the mechanical casing of a BM. Each such group of batteries and capacitors is considered as one BM. If one or more such groups are connected in series or parallel, then multiple BMs are considered to be connected in series and parallel.

In this particular embodiment 128 BMs are connected in series. In another embodiment batteries/capacitors can be arranged, using one or more mesh like structures, without using multiple BMs. In such an embodiment the electrical connections to the batteries/capacitors may be embedded inside the mesh or laid above or below the mesh. In further embodiment part of the wiring can be based on radio signals, especially the control signals. For this disclosure each such mesh like structure is considered as one BM. In this disclosure, if multiple layers of mesh like are structures are stacked, each layer is considered as one BM and vertical layers of mesh are considered as vertically stacked BMs.

FIG. 5 is a schematic diagram of a particular embodiment of a selective discharging circuit (400). Battery pack controller (140) is the master controller of all discharging.

In this embodiment the battery pack controller is installed inside the battery pack, however in another embodiment it can be installed outside the battery pack (100).

Discharging voltage of battery pack in this embodiment is 128*4.2v=max 537.6V. However in another embodiment of 160S256P configuration the discharging voltage of battery pack is 160*4.2v=672V. High voltage in this disclosure is referred to charging and discharging voltage of 60v to 1500v.

Battery pack controller (140) charge the capacitors in each BM to Optimum balanced voltage. This is the voltage (SoC) at which capacitors are always maintained at by the battery pack controller. However it's possible that the charge may exceed this level due to regenerative current, or may be less than this level during the peak demand of the current. Optimum balanced voltage for the capacitors is based on the maximum current demands as determined by the energy management algorithm. Maximum current demands are specific to the application of the battery pack e.g. stop/start bus has low peak demands and performance electric vehicle has high peak current demands. Thus each application needs a variation of the algorithm to maintain a SoC level of the capacitors which optimally meets the peak current demands of the application.

In this embodiment voltage is assumed to be proportional to the SoC levels of the capacitors. If however in another embodiment capacitors may have voltage which is not proportional to the SoC levels, then SoC is used for capacitors as well batteries.

In this embodiment, as shown in FIG. 5, batteries and capacitors (220) within each BM are connected to Energy discharging split circuit (260). This circuit acts as a mixer of batteries and capacitors current and is electronically controlled by the battery pack controller (140).

FIG. 6 shows the energy discharging split circuit (260) gets the current from group of capacitors and also from the group of batteries, and mixes the current as per the calculations of energy management algorithm. Battery pack controller is electronically connected to energy discharging split circuit (260) in each BM. As shown in FIG. 6 there is also a DC-DC step-up converter (261) which steps ups the voltage of the capacitors because voltage of the capacitors drop as the charge depletes.

In this disclosure electronic connection means when two devices communicate with each other through electronic (digital or analogue) signals e.g. electronic connection between battery pack controller (140) and a sensor or electronic connection between battery pack controller (140) and energy discharging split circuit (260).

The energy management algorithm of battery pack controller (140), calculates the optimal mix of battery current and capacitor current for each BM, to meet the peak current demand for the battery pack. The battery pack controller (140) meets the peak current demands depending upon the SoC/voltage levels of the capacitors within each BM.

Each battery pack configuration may also need a variation of the algorithm which optimally meets the average current demands of the application e.g. average current demand of a lorry is different from a stop/start bus. This extends the range of the battery pack, as peak current from the batteries reduce its range compared to using the same capacity in average current. This also extends the life of the batteries, as batteries degrade faster during peaks current demands from them.

Each application may also need optimisation of the number of capacitors required in each battery BM. In this embodiment there are 2 capacitors, in another embodiment it could be more or less than 2 capacitors in each BM, depending upon the peak current demand of the application.

In this embodiment all the regenerative current is stored in capacitors. If the application requires a lot of regenerative current to be stored e.g. stop/start bus or local train, it may need more capacitors to be able to store more regenerative energy. This extends the range of the battery as capacitors can capture almost all the regenerative energy in short time, which the batteries cannot do. In another embodiment depending upon the application only part of the regenerative is stored in the capacitors and part in the batteries when capacitors have reached the maximum capacity.

The energy management algorithm of battery pack controller (140), selectively instructs each BM the optimal mix of batteries current and capacitor current when the SoC of the batteries within a BM reach the minimum SoC levels, the battery pack controller uses the logic inside the energy discharging split circuit of a BM, to switch the current output to capacitors only.

During discharge the battery pack will run out of the available energy when the weakest BM connected in series, reach the minimum SoC levels as determined by the battery pack controller (140). The BMs with highest capacity may never be fully discharged. The weakest BM may be less than 1% total installed capacity of the battery pack. Another innovation here is that the battery pack controller calculates the difference between SoH of the weakest and average SoH without the weakest. It selectively instructs energy discharging split circuit in the weakest BM to switch the current output to capacitors only, when the batteries are discharged and reached minimum SoC levels. This extends the range of the battery pack without stressing or deep discharge of the weak batteries. It may mean that the capacitors within that BM may get deep discharge, but capacitors have high cycle life and can withstand a deep discharge. The discharged capacitors will be charged again during the regenerative current or through the batteries when the batteries are not supplying the maximum current to the load/motor (31).

In this embodiment, calculations of SoH, which is specific to the each battery pack, is done by the operational centre (43) and sent to the battery pack controller via wifi. Energy management algorithm calculate the minimum SoC level of batteries within each BM, based on the SoH of the batteries.

As shown in the FIG. 5, Battery pack controller (140) is connected to the cloud based operational centre (43). The battery pack controller creates a log of history of usage of each battery/capacitor and each battery module (BM) (200). Using the history of usage e.g. history of discharging, terminal voltages, senor data etc, operational centre (43) software calculates its SoH for each battery/capacitor and each BM, which are specific to the battery pack. In this disclosure SoH of batteries/capacitors refers to operational centre calculated SoH. In another embodiment SoH is calculated by the battery pack controller using its compute capacity.

The battery pack output is also supplied to heater (121) in extreme weather conditions. As capacitors are fully operable at −40 degree Celsius, the capacitor charge is used to provide current to the heaters that heat the battery pack. Capacitors are fully operable at 60 degree Celsius; the capacitor charge is used to provide current to the pumps that cool the condensers that cool the battery pack. Extreme cold/hot temperature in this disclosure means the temperature outside the optimum operating range of the batteries.

In this innovation the Energy discharging split circuit (260) switches the output of each BM between capacitors only; batteries only; and an optimal combination of batteries and capacitors current. As the BMs are selectively discharged, the capacitors act as a standby energy source inside each BM, should one or two batteries fail or are weakened. This innovation uses selective switching inside each BM, to optimally use the capacitors to extend the range of the battery pack, without a deep discharge of the weak batteries. The innovation also extends the life of the weakest BMs as weakest BMs do not go into stressed situation and kept away from thermal runaway.

Another innovation here is that peak current demand of an application is determined by the optimum balanced voltage, not the peak current capacity of the weakest BMs in series. This helps maintain the range of the vehicle even when the battery pack unevenly ages.

Further, BM stores all its share of regenerative energy in capacitors, as the regenerative energy normally has large current and only available for few seconds, which may not be enough time to store in the Batteries. The capacitors inside each BM maximise its storage of regenerative energy and charge up to optimum balanced voltage. The optimum balanced voltage for capacitors is calculated by the energy management algorithm installed inside the battery pack controller (140). These capacitors can give peak power e.g. during acceleration while batteries can supply average power. This also extends the range of the battery pack as more of the regenerative energy is captured by the capacitors and extends the life of each BM as batteries do not have to go through frequent cycles of regenerative charging; and frequent cycles of discharging through large currents. This further extends the range of the vehicle, as the peak discharge energy of the batteries within the BM is reduced and peak current depletes the batteries faster than average current.

In this embodiment, batteries within the battery pack are from the same manufacturer; have the same chemistry; have the same capacity, have the same voltage, and these batteries are balanced charged at the time of the manufacture of the battery pack, and preferably the capacitors within the battery pack are from the same manufacturer; have the same chemistry; have the same capacity, have the same voltage, and these capacitors are balanced charged at the time of the manufacture of the battery pack. In another embodiment, batteries can be from different manufacturers, and capacitors can also be from different manufacturers. Batteries and capacitors can have different capacity which are connected in parallel, while keeping the BMs connected in series have equal current capacity.

Battery Pack Controller—Safety and Reliability of Battery Pack

Description:

Title of Description

Battery pack controller—safety and reliability of battery pack

### TECHNICAL FIELD

Large battery packs used in large electric vehicles e.g. cars, trucks, buses, vans, trains. This invention relates to large battery pack technology.

### BACKGROUND INFORMATION

For large battery packs which supply large energy and high peak power, safety and reliability of the battery pack are equally important as the thermal management and charging of the batteries. Large battery packs produce very high voltages e.g. 800v to deliver high energy in 100s of KW. This high voltage poses significant risk to the occupants of the vehicle and the emergency services if the vehicle is involved in an accident.

Large battery packs typically involves lots of battery modules (BMs) electrically connected in series and parallel, to deliver large energy. Failure of one of the BMs which creates a electrical series link with other modules can make the entire battery pack unusable. Thus one BM connected in series, which in some cases contributes less than 1% of the total energy of the battery pack, can bring down the entire battery pack. Also the failure or thermal runaway of a BM can create a fire hazard for the battery pack, electric vehicle and its occupants.

How this Invention Solves the Technical Problems, and how it is Different

This invention solves the current technical problems through many innovative steps:
1. High voltage safety—This innovation packs the batteries/capacitors in the BMs and relays/power switches are added in parallel to a group of BMs such that when the relay is switched OFF the group of BMs are taken out of the series circuit and when the relay is switched ON the group of BMs are included in the electrical series circuit. The battery pack controller switches ON or OFF upon trigger from battery pack controller. Battery pack takes away the heat emanating from the power relays and protects the batteries from the heat produced by the power relays.
2. Reliability of the battery pack—All the batteries within the battery pack do not age equally and this results in some batteries and hence some BMs losing capacity sooner than the rest of the BMs. Weak BMs in the series circuit also deteriorate faster. This leads to thermal runaway and risk of fire if the weak BMs are continued to be used in the series circuit. This innovation proactively takes the weakest BMs out of the series circuit and this extends the life the battery pack and improves the capacity utilisation.
3. Thermal runaway and fire—If a BM suddenly goes into thermal runaway this innovation not only puts out the fire and removes with the smoke from the battery pack, but also removes the burnt out BM immediately from the circuit, so that the battery pack can keep functioning albeit at reduced capacity.

The Key Objectives of the Battery Pack Controller Inventions in this Disclosure are:
make the battery pack safe i.e. protection from exposure to high voltages in the event of accident or repair;
make the battery pack highly reliable; in terms of expected life of the battery pack and continuity of service.

### BRIEF ABOUT DRAWINGS

FIG. 7—shows the schematic circuit diagram of overall system of relays switching ON/OFF the circuit of BMs

FIG. 2.1—shows the battery pack controller and the battery pack

FIG. 2.2—shows the relays, the BMs and inside of the battery pack

### DETAILED DESCRIPTION OF PREFERRED EMBODIMENT, AND HOW IT IS MANUFACTURED

The inventions will be explained through preferred examples of Battery pack controller (140).

Battery Pack Controller (140)

The aim of this invention is to design an apparatus of a battery pack controller, which provides:
a. safety from high voltage in the event of an accident or repair or during assembly;
b. extend the life of the battery pack by proactively removing the failed or about to fail BMs from the electrical series circuit;
c. In the event of thermal runaway, put out the fire, deal with the smoke, deal with the burnt out module so that it's not a threat to the functioning of the battery pack.

In this disclosure, Battery module (BM) (200) is designed to hold plurality of rechargeable batteries and capacitors, arranged in one or more groups. BMs are fully submerged in dielectric liquid inside the battery pack.

In this disclosure, the dielectric liquid is a thermally conductive but electrically insulative liquid. E.g. fluorocarbons.

In this embodiment the battery pack has a configuration of 128S64P, with 128 battery modules (BMs) connected in series, and each BM has a configuration of 62 batteries connected in parallel and 2 capacitors in parallel.

In this particular embodiment BM has 62 cylindrical lithium-ion (Li-ion) rechargeable batteries (220) and 2 capacitors. In another embodiment it could be any other chemistry; in the shape of cylinder, tower, pouch or prismatic or any other shape. Further the batteries could be of high energy density.

In this disclosure all these rechargeable batteries (220) of different chemistries and shapes are referred to as Batteries (220) in plural and Battery in singular. In this particular embodiment BM has 2 Electric double layer capacitors (EDLC) cylindrical capacitors, also called supercapacitors. In another embodiment these capacitors could be Asymmetric Electrochemical Double Layer Capacitor (AEDLC), Lithium Ion capacitors, or graphene supercapacitors. In this disclosure all capacitors of different electrochemical, chemistries and shapes are referred to as capacitors in plural and capacitor in singular. In another embodiment there could be any number of batteries (220) and any number of capacitors (220) in a BM.

In this disclosure, the combination of batteries and capacitors is optional. The BM (200) can be created just with batteries. The BM (200) can also be created just with capacitors.

In another embodiment a group of batteries and a group of capacitors can be arranged together inside a battery pack (100), without the mechanical casing of a BM. Each such group of batteries and capacitors is considered as one BM. If one or more such groups are connected in series or parallel, then multiple BMs are considered to be connected in series and parallel.

In another embodiment large batteries/capacitors can be horizontally and/or vertically arranged, using one or more mesh like structures, without using multiple BMs. In such an embodiment the electrical connections to the batteries/capacitors can be embedded inside the mesh or laid above or below the mesh. In further embodiment part of the wiring can be based on radio signals, especially the control signals. For this disclosure each such mesh like structure is considered as one BM. In this disclosure, if multiple layers of mesh like are structures are stacked, each layer is considered as one BM and vertical layers of mesh are considered as vertically stacked BMs.

FIG. 7 is the electrical schematic diagram of BMs connected in series inside the battery pack (100). It shows a relay switch (133) which has two positions, in ON position a set of 4 BMs is included into the high voltage series circuit and in OFF position the group of 4 BMs is taken out of the series circuit. In this embodiment a relay is used for each set of 4 BMs

In this embodiment of 128S64P configuration of the battery pack, 128 BMs are connected in series with each BM (200) having 62 batteries and 2 capacitors. As shown in FIG. 2.1, there are 4 rows of 8 BMs horizontally laid and 4 BMs are vertically stacked resulting in 128 (8×4×4) connected in series. As shown in FIG. 2.2, for each set of 4 BMs there is one relay switch (133), installed at the top of the PCB (131). However in another embodiment e.g. configuration of 160S256P; has 160 BMs connected in series, with 248 batteries and 8 capacitors in each BM; 16 BMs laid horizontally and 10 vertically (16 BM×10 BM mechanical configuration). In such an embodiment 1 relay could be used for 10 vertically stacked BMs. Thus relay switch can take out 10 BMs each with 256P batteries/capacitors, from the series circuit.

FIG. 7 also shows that the relay switches (133) are controlled by battery pack controller (140).

In this embodiment the battery pack controller is installed inside the battery pack, however in another embodiment it can be installed outside the battery pack (100). In another embodiment only part of the battery pack controller can be installed inside the battery and part outside the battery pack. In this disclosure the battery pack controller installed either inside the battery pack or outside the battery pack or part inside and part outside the battery pack, is termed as battery pack controller.

As shown in the FIG. 7, the relays (133) can completely switch off the serial circuit inside the container (101) such that system (max voltage at any point within the battery pack) voltage falls to 4*4.2V=16.8v which complies with SELV (Safety extra low voltage) level.

There are various standards of SELV, the voltage of 60v is considered as SELV in this disclosure. In this disclosure relay switch (133) means a switch e.g. FET, MOSFET etc.

When the battery pack controller reads a trigger from the vehicle control unit (VCU) or any other control unit of an application e.g. vehicle is switched off or vehicle is involved in an accident, trigger of flooding, trigger of fire or trigger from a manual switch, trigger of being transported in carrier/ship/lorry, the battery pack controller puts all the relay switches in OFF position. As shown in FIG. 7, all the BMs are connected through a series of relay switches, through group of 4 BMs, hence when the vehicle is switched off or involved in an accident or any such trigger, all the BMs are taken out of the series circuit using the relays. In this embodiment the voltage inside the battery pack container drops to 4×4.2v=16.8v which complies with SELV. However in another embodiment of configuration 160S256P, when a series of relays are installed, through a group of 10 BMs, the switched off voltage drops to 10*4.2=42v, which also complies with SELV.

This innovation provides a safety to the occupants of the vehicle when it is involved in an accident; it also protects the emergency staff from being exposed to high voltages which can be as high as 800v for a large pack. It also allows the vehicle repair personal to be confident that they will not exposed to high voltages, especially when the vehicle is being repaired on a roadside by an emergency roadside recovery personnel. It also provides an extra layer of security to the vehicle from theft. It also provides safety from high voltage when vehicle is being transported on a vehicle carrier or a lorry or a ship. Switching off the circuit during transportation can be different from switching off the circuit when the vehicle is switched off, as during transportation vehicles need to be moved by the operators and can be switched on only to be pushed into a position without actually needing the HV power—hence the battery pack controller has to distinguish between the triggers from VCU. In this disclosure any such trigger which requires breaking of the circuit to below SELV trigger, with various priorities are considered to be a trigger from VCU or a control unit.

FIG. 2.1 shows, in this embodiment Battery pack controller (140) is fitted inside a battery pack container (101). FIG. 2.2 shows PCB (131) which connects to 4 vertically stacked BM (200) and a relay (133) which is installed at the end of the PCB (131) for a set of 4 BMs. In another embodiment the relay switches (133) can be attached anywhere on the PCB (131).

Battery pack controller's algorithm takes into battery's history of charging, history of SoC levels, impedance, SoH, thermal runaway etc and determines the failure of the batteries, and deems the BM as a failed BM. In this disclosure the failure of batteries or capacitors or BMs refers to Battery pack controller's declared failure. SoH and expected failure of the batteries etc is done by the operational centre, which does the remote monitoring of the vehicle (43). The operational requests the sensor and contextual data from the battery pack controller and frequently uploads the calculated data to the battery pack controller. Operational centre uses simulations to predict the failure and calculate SoH of the batteries/capacitors, which requires significant compute power.

In this embodiment, when a BM is deemed as a failed BM, the battery pack controller (140) automatically takes the group of 4 BMs of which the failed BM is a part, out of the series circuit by selectively setting that relay switch to OFF position. The battery pack controller takes the loss of 4 BMs into account when switching off a set of BMs. The battery pack controller alerts the user of limited battery pack capacity or request the user for confirmation in some cases to take the failed BMs out of the circuit, through its communication link (43). The relay of failed group of BMs permanently stays in OFF condition until the failed BM is replaced. The battery pack controller remembers to keep the failed BM relay in OFF position, while the other relays are switched ON or OFF as per the trigger messages from the VCU.

This innovation extends the life of the battery pack, and makes the battery pack highly reliable for critical applications. As within a battery pack not all the batteries age equally for various reasons. Capacity utilisation of the battery pack can be measured by the capacity of the weakest BM in series. Thus weak BMs can limit the usable capacity of the battery pack. This innovation can proactively take the weakest BM or BMs out of the series circuit, and increase the battery capacity without impacting the usage of the battery pack. This innovation can help electric vehicles become reliable.

Battery pack controllers also controls the fire, gases and pressure inside the container in the event of a fire inside the battery pack.

In FIG. 2.2 pressure sensor (129) measures the pressure inside the container (101). Battery pack controller (140) is electronically connected to the pressure sensor (129), and records the pressure inside the battery pack container (100) at all times.

In this disclosure electronic connection means when two devices communicate with each other through electronic (digital or analogue) signals e.g. electronic connection between battery pack controller (140) and a sensor or electronic connection between battery pack controller (140) and battery charge controller (240).

Battery pack controller (140) is electronically connected to a gas solenoid (not shown). Battery pack controller (140), opens the gas solenoid to release the pressure inside the container (101) if the pressure inside the container (101) is higher than preset level, and also closes the solenoid valve after the pressure reaches a preset level.

Liquid level sensors (not shown) measure the level of the dielectric liquid inside the container (101). Battery pack controller (140), electronically connected to the liquid level sensor, monitors the dielectric liquid level inside the container (101) using these sensors, and alerts the user of the battery pack to top the dielectric liquid if the level of the dielectric liquid inside the container (101) is lower than the preset level.

In the event of fire, as the batteries/capacitors are submerged in dielectric liquid, the fire extinguishing properties of the dielectric liquid puts out the fire. The gas solenoid releases the gases/smoke from the fire from the battery pack, the gas solenoid also releases the pressure build up inside the battery pack due to smoke.

Further innovation is that the battery pack controller, in the event of thermal runaway or fire puts out the fire using the fire extinguishing properties of the dielectric liquid as well as releases the smoke from the battery pack. Further innovation is that the battery pack controller immediately removes the burnt out BM out of the series circuit so that battery pack can continue to be used. This lets the user reach home with limited capacity of the battery pack, until the battery pack can be repaired/replaced.

Battery pack controller is also electronically connected to the vehicle control unit which can provide trigger instructions to the controller regarding its operations e.g. vehicle is switched off or involved in an accident etc.

In another embodiment two or more Battery packs can be installed in an electric vehicle e.g. in a train carriage. These battery packs can be independently controlled by the vehicle control unit or all the battery packs can be electronically chained, such that the vehicle control unit can manage all the battery packs by electronically connecting to battery pack controller of just one of the battery packs which acts as a master controller to other pack's battery pack controllers (140) which act as slave/s.

Battery pack controller (140) also acts as a master controller of the following charging and discharging circuits:
a. Energy charging split circuit—this circuit switches the charging current between, high voltage DC supply, AC supply and regenerative energy;
b. Energy discharging split circuit—This circuit acts like a mixer of batteries and capacitors current and is controlled by the energy management algorithm of battery pack controller (140);

Battery pack controller (140) is made up of hardware and software.

Battery pack controller (140) also has two key algorithms:
a. Balanced charging algorithm—balanced charging algorithm calculates the Balanced SoC for said group of batteries; preferably and calculates Balanced voltage for said group of capacitors;
b. Energy management algorithm—The energy management algorithm of battery pack controller (140), calculates the optimal mix of battery current and capacitor current to meet the peak current demand from a given BM/battery pack.

Battery pack controller (140) also consists of a memory card which records battery pack's manufacturing details and battery pack's history of charging and discharging and temperatures e.g. number of charge cycles; number of times temperature exceeded maximum limit and the respective temperatures; number of times limits on current been reached and the respective currents; no of times battery pack fallen below the minimum required charge and the respective charge etc; this memory card can be used to settle warranty claims.

Example of Intended Use
Power unit for large electric vehicles e.g. trucks, SUVs, vans, trains
Backup power unit for hospitals, data centres and industrial units
Energy storage unit for solar panels

Glossary

Dielectric liquid—is a dielectric material (thermally conductive but electrically insulative) in a liquid state. E.g. fluorocarbons

Multi layer faced/sided PCB—printed circuit board with multi layers

Smartphone—personally held devices like phone or tablets e.g. iPhone or Samsung

Vehicle control system—control system of the vehicle

Multi layer faced/sided PCB—printed circuit board with multi layers

Auxiliary low voltage batteries—low voltage batteries e.g. 12v lead acid batteries used for starting an ICE engine and vehicle electronics.

Smartphone—personally held devices like phone or tablets e.g. iPhone or Samsung

Battery pack ‘bath tub’ (BPBT)

1. A temperature controlled BPBT is an apparatus designed as a container, comprises:
a. a plurality of rechargeable batteries/capacitors of any shape and of any electrical storage capacity, packed inside one or more battery modules (BMs);
b. plurality of said BMs are horizontally and/or vertically stacked inside the container;
c. the said batteries/capacitors and the said BMs are fully submerged in a 2 phase (liquid and vapour) dielectric liquid;
d. the said BPBT is thermally connected to at least one condenser either a condenser built inside the container or a condenser which is outside the container;
e. the said container consists of return of the subcooled condensate directly to the base of the container upon condensation such that it feeds the vertical ducts with subcooled liquid, either from the condenser which is inside the container, or the vapours are siphoned off from the container and condensed by the external condenser and the condensate is delivered at the base of the container;
f. the said BMs are designed and horizontally and/or vertically stacked/laid in such a way that it creates an assembly where all the vertical openings at the top and at the bottom of the BMs or around the BMs, form vertical ducts;
g. the bubbles create a vertical flow of dielectric liquid and bubbles through the said ducts, towards the surface of the liquid;
h. the ducts work as heat exchangers; subcooled dielectric liquid enters the ducts through/around the bottom-most BMs and hot dielectric liquid and bubbles leave the ducts through/around the topmost BMs, the process known as Subcooled flow boiling transfers the heat from the batteries/capacitors to the 2 phase dielectric liquid; and ducts help to transport heat away from the BMs;
i. the said BPBT consists of circular flow of subcooled liquid inside the container, and this subcooled liquid cools the batteries/electronics as it rises through the stacked batteries, and the vapours thus produced after cooling the batteries/electronics are condensed by the condenser and the subcooled condensate is returned directly at the base of the container and the ducts which cool the batteries/electronics are supplied again with this subcooled liquid;
j. the said BPBT is a closed container to stop vapours being lost.

2. The BPBT of claim 1 is also thermally connected to one or more heaters.

3. The BPBT of claim 1, the said vertical flow of dielectric liquid also creates a low pressure inside the said ducts, and said low pressure creates a localised horizontal flow of liquid towards the ducts; the low pressure sucks in hot liquid from the gaps in between the stacked BMs, which in turn sucks the hot liquid from the tabs of the batteries, harnessing the effects documented in Bernoulli's theorem.

4. The BPBT of claim 2, the base of the container constitutes heaters, made of either heating tubes which allow piped in heated liquid or preferably multiple PCT heating plates.

5. The BPBT of claim 2, consists of heating of the batteries/capacitors; when bubbles produced by the said heaters at the base are channelled through the said vertically stacked BMs, the said ducts work as heat exchangers; the heated 2 phase dielectric liquid and bubbles enter the ducts from the bottommost BM and cooler dielectric liquid leaves the ducts from the top most BM, and dielectric liquid heats the batteries/capacitors by convection.

6. The BPBT of claim 2, the said heaters at the base of the container preferably are fitted inside one or more sumps to heat the dielectric liquid.

7. The BPBT of claim 1 preferably consists of said electronics apparatus of power board, immersed in dielectric liquid, which can be made up of AC/DC to DC converter, installed inside the BPBT, has the input and output terminals, including:
a. Input terminals: AC (three phase and single phase), high voltage DC;
b. Output terminals: high voltage DC, low voltage DC (e.g. 12v, 48v);
c. Optional terminals: low voltage DC (e.g. 12v, 48v) input; AC (three phase and single phase) output.

8. The BPBT of claim 1, the said condenser/s fitted inside the container, consists of cooling pipes preferably spiral pipes/helical cooling coil with a coil pitch that is maximised for condensation efficiency, preferably attached to the inside of the lid which channels the vapours towards the said cooling coil.

9. The BPBT of claim 1 preferably supplies power to the external pump which pumps refrigerant/cooling water to the said condenser/s; and preferably electrically/electronically controls pump's functions, which includes starting/stopping the pump, increase/reduce its speed etc.

10. The BPBT of claim 1, preferably consists of one or more troughs to collect the condensate from condenser/s fitted inside the container; the troughs are preferably also designed to stop the said condenser coming in direct contact with the said boiling dielectric liquid.

11. The BPBT of claim 10, the trough or troughs are preferably also used to provide structural strength at the top of the said container.

12. The BPBT of claim 10, also preferably consists of vertical drain pipes connected to the trough/s, which deliver the condensate at the base of the container.

13. The BPBT of claim 1, also consists of an array of sumps at the base of the said container, which preferably collect subcooled dielectric liquid delivered by the condenser/s.

14. The BPBT of claim 1, also consists of a seal, of the openable side, preferably the lid of the said container, that creates a water-tight closing; and further preferably the lid fits into the container using a waterproof sealant.

15. The BPBT of claim 1 consists of external sides that are made of thermally resistant material, which preferably can also provide tensile strength, further preferably made of fibre glass.

16. The BPBT of claim 1 also consists of at least one gas solenoid valve attached to, either the lid or the side walls of the said container; and which preferably also works as a controlled valve for top up of the dielectric liquid inside the said container.

17. The BPBT of claim 1 also preferably consists of, either one or more immersion proof breathers, or pressure balancing devices, attached to either the side walls or preferably to the lid of the said container, to balance the pressure between the inside and the outside of the container; however if the BPBT is used in high altitudes immersion proof breather may be omitted to allow build up of the pressure inside the container.

18. The BPBT of claim 1 also consists of at least one pressure sensor attached either to the lid or side walls of the said container, to measure the pressure inside the container; and preferably also consists of liquid level sensors to measure the level of the dielectric liquid inside the container and to monitor the dielectric liquid level inside the container using these sensors.

19. The BPBT of claim 1 also preferably consists of an apparatus which is an electrical circuit of relays switches fully immersed in the dielectric liquid; the relays switches are preferably powered by auxiliary low voltage DC battery of the electric vehicle.

20. The BPBT of claim 52 preferably also consists of said heaters powered by capacitors, to heat the dielectric liquid in extreme cold temperatures.

21. The BPBT of claim 1 preferably also consists of power output terminal to supply power to an external pump where power is supplied by capacitors, to circulate the cooled water/refrigerant through the condenser/s in extreme hot temperatures.

22. The BPBT of claim 1 consists of all the batteries/capacitors and the associated electronics are flood proof up to the water level of external electrical contacts which are close to the lid, and preferably the BPBT is only temporarily fully submerged.

23. The BPBT of claim 1 consists of dielectric liquid which also acts as a fire extinguisher and puts off a fire in the event of a thermal runaway; and preferably the gases from venting of the batteries or fire if any, are released by the gas solenoid.

24. The BPBT of claim 1 consists of flexibility in choosing how the said BMs are electrically arranged inside the BPBT in terms of how many BMs are electrically connected in series or parallel inside the BPBT; and said BMs are preferably electrically connected via HV terminals provided on a PCB.

25. The BPBT of claim 1 consists of flexibility in choosing how the said BMs are mechanically horizontally laid and/or vertically stacked; it can have all the BMs horizontally stacked, or all the BMs vertically stacked or a mix of horizontally laid and vertically stacked mechanical layout.
Battery pack ‘bath tub’ (BPBT)

26. A temperature controlled BPBT is an apparatus designed as a container, comprises:
a. a plurality of rechargeable batteries/capacitors of any shape and any of electrical storage capacity, packed inside one or more battery modules (BMs);
b. plurality of said BMs are horizontally and/or vertically stacked inside the container;
c. the said batteries/capacitors and the said BMs are fully submerged in a 2 phase (liquid and vapour) dielectric liquid;
d. the said BPBT is thermally connected to at least one condenser;
e. the said BPBT consists of return of the condensate directly to the base of the container upon condensation such that it feeds the vertical ducts with subcooled liquid; preferably by installing a trough inside the container to collect the condensate that delivers at the base; or to siphon off the vapours from the container and deliver the condensate at the base after condensation;
f. the said BMs are designed and horizontally and/or vertically stacked/laid in such a way that it creates an assembly where all the vertical openings at the top and at the bottom of the BMs or around the BMs, form vertical ducts, using sides of the batteries/capacitors as walls of the ducts;
g. the bubbles create a vertical flow of dielectric liquid and bubbles through the said ducts, towards the surface of the liquid;
h. the ducts work as heat exchangers; subcooled dielectric liquid enters the ducts through/around the bottom-most BMs and hot dielectric liquid and bubbles leave the ducts through/around the topmost BMs, the process known as Subcooled flow boiling transfers the heat from the sides of the batteries/capacitors forming the ducts to the 2 phase dielectric liquid; and ducts help to transport heat away from the BMs;
i. the said BPBT is a closed container with a lid to stop vapours being lost.

27. The BPBT of claim 26 is also thermally connected to one or more heaters;

28. The BPBT of claim 26, the said vertical flow of dielectric liquid also creates a low pressure inside the said ducts, and said low pressure creates a localised horizontal flow of liquid towards the ducts; the low pressure sucks in hot liquid from the gaps in between the stacked BMs, which in turn sucks the hot liquid from the tabs of the batteries, harnessing the effects documented in Bernoulli's theorem.

29. The BPBT of claim 27 the base of the container constitutes heaters made of heating tubes, which allow piped in heated liquid or preferably multiple PCT heating plates and further preferably PCT heaters powered by the capacitors in the battery pack.

30. The BPBT of claim 27 consists of heating of the batteries/capacitors, when bubbles produced by the said heating sources at the base are channelled through the said vertically stacked BMs, the said ducts work as a heat exchanger; the heated 2 phase dielectric liquid and bubbles enter the ducts from the bottommost BM and cooler dielectric liquid leaves the ducts from the top most BM, and dielectric liquid heats the batteries/capacitors by convection.

31. The BPBT of claim 27 the heater at the base of the container preferably constitutes one or more sumps to heat the dielectric liquid.

32. The BPBT of claim 26 preferably consists of an apparatus of power board, immersed in dielectric liquid, which can be made up of AC/DC to DC converter and Energy charging split circuit, installed inside or outside the BPBT, has the following input and output terminals:
a. Input terminals: AC (three phase and single phase), high voltage DC;
b. Output terminals: high voltage DC, low voltage DC (e.g. 12v, 48v);
c. Optional terminals: low voltage DC (e.g. 12v, 48v) input; AC (three phase and single phase) output.

33. The BPBT of claim 26, the said condenser consists of cooling pipes preferably spiral pipes/helical cooling coil with a coil pitch that is maximised for condensation contact area, preferably attached to the inside of the parabolic shaped lid, alternatively an external condenser which siphons off the vapours and returns the condensate to the said container.

34. The BPBT of claim 26 preferably supplies power to the external pump which pumps refrigerant or cooling water to the said condenser, and preferably electrically/electronically controls its functions e.g. starting/stopping the pump, increase/reduce its speed etc.

35. The BPBT of claim 26, preferably consists of one or more troughs to collect the condensate; which are preferably also designed to stop the condenser coming in direct contact with the said boiling dielectric liquid.

36. The BPBT of claim 34, the trough or troughs are preferably also used to provide structural strength at the top of the said container.

37. The BPBT of claim 26, also consists of vertical drain pipes which deliver the condensate at the base of the container.

38. The BPBT of claim 26, also consists of an array of sumps at the base of the said container, which collect subcooled dielectric liquid delivered by the drain pipes.

39. The BPBT of claim 26, the seal of the openable side, preferably the lid of the said container creates a water-tight closing, and further preferably the lid slides into the container using a waterproof sealant.

40. The BPBT of claim 26 consists of external sides that are preferably made of thermally resistant material which can also provide tensile strength e.g. fibre glass.

41. The BPBT of claim 26 also consists of at least one gas solenoid valve attached to the lid or side walls of the said container, and preferably also works as a controlled valve for top up of the dielectric liquid inside the said container.

42. The BPBT of claim 26 also preferably consists of one or more immersion proof breathers or a pressure balancing devices attached to the side walls or preferably to the lid of the said container, to balance the pressure inside and outside the container; however if the BPBT is used in high altitudes immersion proof breather may be omitted to allow build up of the pressure inside the container.

43. The BPBT of claim 26 also consists of at least one pressure sensor attached to the lid or side walls of the said container, to measure the pressure inside the container.

44. The BPBT of claim 26 also preferably consists of an apparatus which is an electrical circuit of relays switches fully immersed in the dielectric liquid; the relays switches are preferably powered by auxiliary low voltage DC battery of the electric vehicle.

45. The BPBT of claim 27 preferably also consists of heaters powered by capacitors, in extreme cold temperatures.

46. The BPBT of claim 26 preferably also consists of power to external pump supplied by capacitors, to cool the condenser/s in extreme hot temperatures.

47. The BPBT of claim 26 with all the batteries/capacitors and the associated electronics is flood proof up to the level of external electrical contacts which are close to the lid, however cannot be fully submerged.

48. The BPBT of claim 26 consists of dielectric liquid which is also a fire extinguisher and puts of a fire in the event of thermal runaway, and the gases if any are released by the gas solenoid.

49. The BPBT of claim 26 consists of flexibility in choosing how the said BMs are electrically arranged inside the BPBT in terms of how many BMs are electrically connected in series or parallel inside the BPBT.

50. The BPBT of claim 26 consists of flexibility in choosing how the said BMs are mechanically horizontally laid and/or vertically stacked; it can have all the BMs horizontally stacked, or all the BMs vertically stacked or the mix of horizontally laid and vertically stacked mechanical layout.
A Method of protecting a battery pack from thermal stresses

51. A method of protecting a battery pack from thermal stresses, comprising:
a. packing a plurality of rechargeable batteries inside plurality of modules, and packing the plurality of said modules inside a closed container;
b. stacking the said modules horizontally and/or vertically inside the said container;
c. fully immersing the plurality of said rechargeable batteries and the said modules, in a 2 phase (liquid and vapour) dielectric liquid, inside the said container;
d. thermally connecting the container to at least one condenser, either a condenser which is fitted inside the said container, or a condenser which is fitted outside the container;
e. collecting the subcooled condensate and delivering the subcooled condensate at the base of the container, either inside the container, or by siphoning off the vapours and condensing the vapours in a heat exchanger and returning the subcooled condensate at the base of the container;
f. creating vertical ducts through the modules, by aligning the openings in the top and bottom plates of the said modules;
g. the bubbles creating a vertical two-phase flow of said dielectric liquid and bubbles inside the said ducts;
h. the said ducts working as a heat exchangers; subcooled dielectric liquid entering the ducts at the bottom of the stacked modules and hot liquid leaving the ducts at the top of the stacked modules, the process known as ‘subcooled flow boiling’ transferring the heat from the batteries to the dielectric liquid, helping to create an efficient heat transport process to transport heat from the vertically stacked said modules;
i. creating a circular flow of subcooled liquid inside the container, and this subcooled liquid cooling the batteries/electronics as it rises through the stacked batteries, and the vapours thus produced after cooling the batteries/electronics being condensed by the condenser, the subcooled condensate returning directly to the base of the container; and continuing the circular flow of the subcooled liquid.

52. The method of claim 51 also involves thermally connecting the said container to a heater, it can be an electric heater fitted inside the said container; or a set of heating pipes fitted inside the container which are heated by piped in hot water/refrigerant.

53. The method of claim 51 also involves the said vertical flow of dielectric liquid creating a low pressure inside the said ducts, and the low pressure creating a localised horizontal flow of liquid towards the ducts; and the low pressure sucking in hot liquid from the gaps in between the stacked modules, which in turn sucking in hot liquid from the tabs of the batteries; harnessing the effects documented in Bernoulli's theorem.

54. The method of claim 51 also involves actively cooling the condenser using a pump to push cold water or water+ethanol through the condenser.

55. The method of claim 51 cooling step also involves bubbles producing a vertical flow of said dielectric liquid through the said ducts, which pushes the hot/boiling dielectric liquid towards the surface of the liquid within the container.

56. The method of claim 51 cooling step also involves cooling of the electronics which is installed inside the container; preferably including:
a. Power board to charge large number of rechargeable batteries;
b. Battery pack controller board;
c. Relay switches.

57. The method of claim 51 the cooling step also involves either during extremely high ambient temperatures or during the heavy use of the batteries:
a. allowing the already hot dielectric liquid to evaporate on the surface of the said batteries;
b. capturing the further heat produced by the batteries using the latent heat of the dielectric liquid;
c. increasing the flow of cooling liquid through the condenser;
d. continuing to remove the heat from the condenser as fast as possible until the temperature of the dielectric liquid falls below the boiling point;
e. and avoiding the build up of vapours in the said container, which slows the vertical flow of the vapours and the dielectric liquid through the said ducts.

58. The method of claim 52 the heating step also involves heating the cold batteries, by transferring the heat from the said heater, to the said dielectric liquid, and then transferring the heat from the said dielectric liquid to the batteries, with cold batteries also acting as a condenser.

59. The method of claim 52 the heating step also involves switching on the heaters by the battery pack controller.

60. The method of claim 52 the heating step also involves battery pack controller deciding the need to switch on the heater based on the temperature readings of batteries below the minimum operating temperature of the batteries.

61. The method of claim 52 the heating step also involves phase change of said dielectric liquid to bubbles when cold liquid in the sumps of the container coming in contact with the hot heater, as well as heating the dielectric liquid by convection.

62. The method of claim 52 the heating step also involves the bubbles creating a vertical flow of heated dielectric liquid through the ducts.

63. The method of claim 52 the heating step also involves the said ducts acting as heat exchangers with heated liquid entering the bottommost module and cooler liquid leaving the topmost module, and dielectric liquid transferring the heat to the said batteries.

64. The method of claim 52 the heating step also involves during extremely low ambient temperatures:
a. the said heater is preferably heated by the charge stored in the capacitors;
b. the hot heater heating the cold dielectric liquid, preferably not frozen, in the sump by convection and producing bubbles;
c. continuing heating the dielectric liquid, until the temperature of the dielectric liquid in the container coming close to the minimum operating temperature of the batteries;
d. and avoiding heating the dielectric liquid too fast which converts the dielectric liquid in the sump, into such an amount of vapour which when travels through the said ducts, may reduce contact of the heated dielectric liquid to the cold batteries.

65. The method of claim 51 also involves immersion proof breather balancing the pressure inside the container and the external pressure; however where the BPBT is used in high altitudes applications omitting the immersion proof breather as vapours are used to increasing the pressure inside the container and hence increasing the boiling point of the dielectric liquid.

66. The method of claim 51 also involves protecting the container from extreme ambient temperatures using thermal insulation.

67. The method of claim 51 the cooling steps also involve battery pack controller activating the gas solenoid valve when, either the pressure inside the container increases beyond the preset pressure, or for removing any gases and smoke from a fire or thermal runaway.

68. The method of claim 51 the cooling steps also involve using a shape of the lid of the container which channels the vapours to the condenser; preferably using a parabolic lid.

69. The method of claim 51 also involves collecting the condensate inside the container using one or more troughs.

70. The method of claim 51 the cooling steps also involve avoiding the build of pressure inside the container using a gas solenoid.
A method of providing flood protection to a battery pack

71. The method of claim 51 also involves the sealed container providing flood protection to the batteries and the electronics, comprising:
a. extinguishing any incidence of fire inside the said container using the fire extinguishing properties of the dielectric liquid;
b. removing any gas and smoke from a fire, from the said container using gas solenoid;
c. releasing the build up of pressure inside the container using immersion proof breather/s.
A method of cooling the battery pack in extreme hot temperatures

72. The method of claim 51 also involves cooling the battery pack in extreme temperatures, comprising Battery pack controller controlling the battery pack/modules output such that it supplies charge from the capacitors to the external pump/s of the condenser/s when the temperature inside the container increases beyond a preset level.
A method of heating the battery pack in extreme cold temperatures

73. The method of claim 51 also involves heating the battery pack in extreme cold temperatures, comprising Battery pack controller controlling the battery pack/modules output such that it supplies current from capacitors to the heater/s when the temperature inside the container falls below the preset level.

74. The method of claim 51 also involves communicating with vehicle control unit to instruct how much water/refrigerant supply the condenser/s needs and when.

75. The method of claim 51 also involves thermally connecting the thermal ports of the container to an external pump, either a pump which pumps cold water/refrigerant through the inlet port and extracts hot water/refrigerant through the outlet port, or vehicle's heat exchanger's pump which pumps in cold water/refrigerant through the inlet port and extracts hot water/refrigerant through the outlet port.
A Method of protecting a battery pack from thermal stresses

76. A method of protecting a battery pack from thermal stresses, comprising:
a. packing a plurality of rechargeable batteries inside plurality of modules, and packing the plurality of said modules inside a closed container;
b. stacking the said modules horizontally and/or vertically inside the said container;
c. fully immersing the plurality of said rechargeable batteries and the said modules, in a 2 phase (liquid and vapour) dielectric liquid, inside the said container;
d. thermally connecting the container to a condenser, it can be condenser fitted inside the said container e.g. cooling tubes working as a condenser fitted inside the container; or a condenser which siphons the vapours and returns the condensate after condensation at the base of the container;
e. delivering the condensate at the base of the container either by collecting in a trough fitted inside the container or siphoning off the vapours and condensing the vapours in a heat exchanger and returning the condensate at the base of the container;
f. creating vertical ducts through the modules, by aligning the openings in the top and bottom plates of the said modules and by using the sides of the batteries as walls of the ducts;
g. the bubbles creating a vertical two-phase flow of said dielectric liquid and bubbles inside the said ducts;
h. the said ducts working as a heat exchangers; subcooled dielectric liquid entering the ducts at the bottom of the stacked modules and hot liquid leaving the ducts at the top of the stacked modules, the process known as ‘subcooled flow boiling’ transferring the heat from the sides of the batteries forming the ducts to the dielectric liquid, helping to create an efficient heat transport process to transport heat from the vertically stacked said modules;
i. cooling the hot batteries, by transferring the heat from the said batteries to the said dielectric liquid and transferring the heat from the said dielectric liquid to the said condenser, using a phase change of the said dielectric liquid from liquid to vapour to liquid.

77. The method of claim 76 also involves thermally connecting the said container to a heater, it can be a electric heater fitted inside the said container; or a set of heating pipes fitted inside the container which are heated by piped in hot water/refrigerant.

78. The method of claim 76 also involves the said vertical flow of dielectric liquid creating a low pressure inside the said ducts, and low pressure creating a localised horizontal flow of liquid towards the ducts; and the low pressure sucking in hot liquid from the gaps in between the stacked modules, which in turn sucking in hot liquid from the tabs of the batteries; harnessing the effects documented in Bernoulli's theorem.

79. The method of claim 76 also involves actively cooling the condenser using a pump to push cold water/water+ethanol through the condenser.

80. The method of claim 76 cooling step also involves bubbles producing a vertical flow of said dielectric liquid through the said ducts, which pushes the hot/boiling dielectric liquid towards the surface of the liquid within the container.

81. The method of claim 76 cooling step also involves, creating a continuous circular flow of the said dielectric liquid inside the said container; said hot dielectric liquid and the bubbles/vapours rising to the top and the said condenser condensing the said vapours and delivering the subcooled condensate at the base of the said container.

82. The method of claim 76 the cooling step also involves during extremely high ambient temperatures or during the heavy use of the batteries:
a. allowing the already hot dielectric liquid to evaporate on the surface of the said batteries;
b. capturing the further heat produced by the batteries using the latent heat;
c. increasing the flow of cooling liquid through the condenser;
d. continuing to remove the heat from the condenser as fast as possible until the temperature of the dielectric liquid falls below the boiling point;
e. and avoiding the build up of vapours in the said container, which slows the vertical flow of the vapours and the dielectric liquid through the said ducts.

83. The method of claim 77 the heating step also involves heating the cold batteries, by transferring the heat from the said heater, to the said dielectric liquid, and then transferring the heat from the said dielectric liquid to the batteries, using the cold batteries as a condenser.

84. The method of claim 77 the heating step also involves switching on the heaters by the battery pack controller.

85. The method of claim 77 the heating step also involves battery pack controller deciding the need to switch on the heater based on the temperature readings below the minimum operating temperature of the batteries.

86. The method of claim 77 the heating step also involves phase change of said dielectric liquid to bubbles when cold liquid in the sump of container coming in contact with the hot heater, as well as heating the dielectric liquid by convection.

87. The method of claim 77 the heating step also involves the bubbles creating a vertical flow of heated dielectric liquid through the ducts.

88. The method of claim 77 the heating step also involves the said ducts acting as heat exchangers with heated liquid entering the bottommost module and leaving the topmost module, and dielectric liquid transferring the heat to the sides of the said batteries.

89. The method of claim 77 the heating step also involves during extremely low ambient temperatures:
a. the said heater is preferably heated by the charge stored in the capacitors;
b. the hot heater heating the cold dielectric liquid (not frozen) in the sump by convection and producing bubbles;
c. continuing heating the dielectric liquid, until the temperature of the dielectric liquid in the container coming close to the minimum operating temperature of the batteries;
d. and avoiding heating the dielectric liquid too fast which converts the dielectric liquid in the sump, into such an amount of vapour which when travels through the said ducts, may reduce contact of the heated dielectric liquid to the cold batteries.

90. The method of claim 76 also involves immersion proof breather balancing the pressure inside the containers and the external pressure, however where the BPBT is used in high altitudes applications omitting the immersion proof breather as vapours are used to increasing the pressure inside the container and hence increasing the boiling point of the dielectric liquid.

91. The method of claim 76 also involves protecting the container from extreme ambient temperatures using thermal insulation.

92. The method of claim 76 the cooling steps also involve battery pack controller activating the gas solenoid valve when the pressure inside the container increases beyond the preset pressure.

93. The method of claim 76 the cooling steps also involve using a shape of the lid of the container to channel the vapours to the condenser e.g. a parabolic lid.

94. The method of claim 77 the heating steps also involve heating the dielectric liquid collected in one or more sumps.

95. The method of claim 76 the cooling steps also involve avoiding the build of pressure inside the container using a gas solenoid.
A method of providing flood protection to a battery pack

96. A method of providing flood protection to the battery pack, comprises:
a. placing all the rechargeable batteries preferably and capacitors in a water tight container;
b. placing all the interconnections—the electrical high voltage circuit between the said batteries preferably and capacitors, and the control circuit between the said batteries and the said battery pack controller in the said water tight container;
c. immersing the said batteries, and the said electrical and electronic interconnections in 2 phase change (liquid and vapour) dielectric liquid;
d. extinguishing any incidence of fire inside the said containers using the fire extinguishing properties of the dielectric liquid;
e. removing any gas and smoke from a fire, from the said containers using gas solenoid;
f. transferring any heat generated by the thermal runaway of a said batteries preferably and capacitors to a condenser fitted inside the said water tight container using the said dielectric liquid;
g. and transferring the heat from the said batteries to said condenser through the said phase change dielectric liquid;
h. releasing the build up of pressure inside the container using a gas solenoid.
A method of cooling the battery pack in extreme hot temperatures

97. A method of cooling and heating the battery pack in extreme temperatures, comprising:
a. battery modules containing a plurality of rechargeable batteries electrically connected in series or parallel, and a plurality of capacitors electrically connected in series or parallel;
b. immersing the said modules in 2 phase dielectric liquid inside a battery pack container;
c. thermally connecting the container to a condenser, it can be condenser fitted inside the said container e.g. cooling tubes working as a condenser fitted inside the container; or a condenser thermally connected to the container which siphons the vapours and returns the condensate after condensation at the base of the said container;
d. battery pack controller, controls the battery pack/modules output such that it supplies charge from the capacitors, to the pump of the condenser when the temperature increases beyond a preset level.
A method of heating the battery pack in extreme cold temperatures

98. A method of heating the battery pack in extreme cold temperatures, comprising:
a. battery modules containing a plurality of rechargeable batteries electrically connected in series or parallel, and a plurality of capacitors electrically connected in series or parallel;
b. immersing the said modules in 2 phase dielectric liquid inside a battery pack container;
c. thermally connecting the said container to a heater, it can be a electric heater fitted inside the said container; or a set of heating pipes fitted inside the container which are heated by piped in hot water/refrigerant;
d. battery pack controller controlling battery pack/module such that it supplies current from capacitors to the heater when the temperature falls inside below the preset level.
All weather hybrid battery module (BM)

99. Battery module (BM) is an apparatus, an unsealed module to hold plurality of rechargeable batteries/capacitors, comprises:
a. the said batteries/capacitors are electrically arranged in one or more groups where each group of batteries are electrically connected in a parallel or in series with the other group;
b. the said BM is constructed in such a way that the vertical openings at the top and at the bottom plates (either a positive plate at the top and the negative plate at the bottom or a negative plate at the top and the positive plate at the bottom) of a BM are mechanically matched, to form vertical ducts using sides of the batteries as walls of the ducts;
c. the said BM and the said batteries/capacitors are fully submerged in a 2 phase (liquid and vapour) dielectric liquid;
d. the bubbles of 2 phase liquid heated by the sides of the batteries/capacitors are channelled through the said ducts using mechanical buttresses or separators;
e. the bubbles create vertical flow of said dielectric liquid and bubbles inside the said ducts;
f. subcooled dielectric liquid enters the ducts through the bottom plate and hot liquid leaves the ducts through the top plate;
g. the said ducts work as heat exchangers;
h. the process known as ‘Subcooled flow boiling’ transfers the heat from the sides of the batteries/capacitors forming the ducts to the 2 phase dielectric liquid.

100. The BM/s of claim 99 can be horizontally laid and/or vertically stacked.

101. The BM of claim 99, the said vertical flow of dielectric liquid also creates a low pressure inside the said ducts, and said low pressure creates a localised horizontal flow of liquid towards the ducts; and as the vertical flow leaves the BM the low pressure sucks in hot liquid from the tabs of the batteries/capacitors, harnessing the effects documented in Bernoulli's theorem.

102. The BM of claim 99, consists of the said batteries/capacitors which are preferably coated with microporous material/s.

103. The BM of claim 99, each battery is preferably connected to the electrically conducting plates (a positive plate and a negative plate) through a thermal runaway fuse, further preferably connected to a PCB, which can used as a positive plate or a negative plate, through a PCB mounted thermal runaway protection device/resettable fuse.

104. The BM of claim 99, comprises openings in the lid and mechanically matching openings in the base of the said BM; and as long as ducts can be created by mechanically matching lid and base openings, the shape and the size of openings in the lid or the base or both can be changed e.g. the size of the openings can be increased with a reduction in the energy density of the said BM or can be decreased with a limitation on the range of the temperatures the BM can be used for.

105. The BM of claim 99, preferably comprises of surface/side cooling/heating as well as tab cooling/heating of the said batteries/capacitors, when vertically stacked.

106. The BM of claim 99, the said buttresses or separators are made of material which redistributes the heat away from the duct and act as a second line of defence.

107. The BM of claim 99, the said buttresses or separators, preferably extend out from a side of the said BM and these extended buttresses allow the stacking and mating with the other BMs; such that the said ducts of stacked BMs form continuous vertical ducts.

108. The BM of claim 99, consists of said capacitors power the heaters, which heat the dielectric liquid, and the dielectric liquid in turn heat the batteries in extreme cold weather.

109. The BM of claim 99, preferably also consists of heating of the batteries/capacitors, when bubbles produced by a heating source below the said BM/s are channelled through the said ducts, the heated dielectric liquid enters the ducts from the bottom plate and cold dielectric liquid leaves ducts from the top plate, and dielectric liquid heats the sides of the batteries/capacitors by convection, and the ducts work as heat exchangers by transferring the heat from the dielectric liquid to the cold batteries/capacitors.

110. The BM of claim 99, preferably also consists of the said batteries/capacitors which are preferably arranged such a way inside the said BM that the said bubbles created from one battery/capacitor do not coalesce with the bubbles created from the neighbouring batteries/capacitors.

111. The BM of claim 99, preferably consists of one or more temperature sensors, installed anywhere inside the case.

112. The BM is claim 99 is mechanically modular and the electrical circuitry is also modular so that more of said BM/s can be electrically joined together to extend the max voltage or max current capacity of a battery pack.

113. The BM of claim 99 is preferably made with electrically insulative but thermally conductive material e.g. Aluminium Nitride, Silicon Nitride etc

114. The BM of claim 99, preferably consists of battery charge controllers having one or more PCB mounted ICs (integrated circuits) that charge the batteries/capacitors of the said BM.

115. The BM of claim 99 preferably also consists of energy discharging split circuit that switches the source of the BM output current between:
i. batteries current only;
ii. capacitors current only;
iii. an optimal mix of batteries and capacitors current.

116. The BM of claim 99 is mechanically modular and the electrical circuitry is also modular so that it can be replaced with another said BM during repair.

117. The BM of claim 99 preferably also consists of communication terminals; these are preferably I²C or SMBus or PMbus terminals.

118. The BM of claim 99 also consists of positive and negative module HV terminals; and preferably positive and negative module charging terminals.

119. The BM of claim 99 also consists of subcooled dielectric liquid in ducts acts as a fire extinguisher in the event of a fire of one or more batteries or capacitors inside the BM.

120. The BM of claim 99 also consists of ducts act as chimneys to let the gases/fumes escape the BM in the event of fire of one or more batteries or capacitors inside the BM.

121. The BM of claim 99 also consists of separators act as barriers to shockwave or cascade effect of thermal runaway, in the event one or more batteries or capacitors have thermal runaway or explosion, inside the BM.

122. The BM of claim 99 also consists of if one or more ducts get into saturated state, the BM which is made of a material, preferably also a microporous material, which redistributes the heat away from the duct.

123. BM of claim 99 also allows battery modules (BM) can be repurposed by
a. all the BMs inside a larger or smaller battery pack;
b. matching the mechanical fittings of the BMs and the battery pack;
c. electrically connecting in series or parallel the said BMs inside the battery pack for the desired voltage and current requirements;
d. and replacing the failed or weak BMs with new BMs.
All weather hybrid battery module (BM)

124. Battery module (BM) is an apparatus, a module to hold plurality of rechargeable batteries/capacitors, comprises:
a. the said batteries/capacitors are electrically arranged in one or more groups where each group of batteries are electrically connected in a parallel or in series with the other group;
b. the said BM is constructed in such a way that all the vertical openings at the top and at the bottom plates of a BM are mechanically matched, to form vertical ducts using sides of the batteries as walls of the ducts;
c. the said BM and the said batteries/capacitors are fully submerged in a 2 phase (liquid and vapour) dielectric liquid;
d. the bubbles of 2 phase liquid heated by the sides of the batteries/capacitors are channelled through the said ducts using mechanical buttresses or separators;
e. the bubbles create vertical flow of said dielectric liquid and bubbles inside the said ducts;
f. subcooled dielectric liquid enters the duct through the bottom plate and hot liquid leaves the duct through the top plate;
g. the said ducts work as heat exchangers;
h. the process known as ‘Subcooled flow boiling’ transfers the heat from the sides of the batteries/capacitors forming the ducts to the 2 phase dielectric liquid.

125. The BM of claim 124 can be horizontally laid and/or vertically stacked.

126. The BM of claim 124, the said vertical flow of dielectric liquid also creates a low pressure inside the said ducts, and said low pressure creates a localised horizontal flow of liquid towards the ducts; and as the vertical flow leaves the BM the low pressure sucks in hot liquid from the tabs of the batteries/capacitors, harnessing the effects documented in Bernoulli's theorem.

127. The BM of claim 124, consists of the said batteries/capacitors which are preferably coated with microporous material/s.

128. The BM of claim 124, each battery is preferably connected to the electrically conducting lid through a thermal runaway fuse, further preferably connected to the PCB lid through a PCB mounted thermal runaway protection device/resettable fuse.

129. The BM of claim 124, comprises openings in the said lid and mechanically matching openings in the base of the said BM; and as long as ducts can be created by mechanically matching lid and base openings, the shape and the size of openings in the lid or the base or both can be changed e.g. the size of the openings can be increased with a reduction in the energy density of the said BM or can be decreased with a limitation on the range of the temperatures the BM can be used for.

130. The BM of claim 124, preferably comprises of surface cooling/heating as well as tab cooling/heating of the said batteries/capacitors, when vertically stacked.

131. The BM of claim 124, the said buttresses or separators, can be of any shape and thickness.

132. The BM of claim 124, the said buttresses or separators, preferably extend out from a side of the said BM and these extended buttresses allow the stacking and mating with the other BMs; such that the said ducts of stacked BMs form a continuous vertical duct.

133. The BM of claim 124, consists of said capacitors power the heaters which heat the dielectric liquid, and the dielectric liquid in turn heat the batteries in extreme weather.

134. the BM of claim 124, preferably also consists of heating of the batteries/capacitors, when bubbles produced by a heating source below the said BM/s are channelled through the said ducts, the heated dielectric liquid enters the ducts from the bottom plate and cold dielectric liquid leaves ducts from the top plate, and dielectric liquid heats the sides of the batteries/capacitors by convection, thus the ducts work as a heat exchanger by transferring the heat from the dielectric liquid to the cold batteries/capacitors.

135. The BM of claim 124, preferably also consists of the said batteries/capacitors which are preferably arranged such a way inside the said BM that the said bubbles created from one battery/capacitor do not coalesce with the bubbles created from the neighbouring batteries/capacitors.

136. The BM of claim 124, preferably consists of one or more temperature sensors, installed anywhere inside the case.

137. The BM is claim 124 is mechanically modular and the electrical circuitry is also modular so that it can be replaced with another said BM during repair; and more of said BM/s can be joined together to extend the max voltage or max current capacity of a battery pack.

138. The BM of claim 124 is preferably made with electrically insulative but thermally conductive material e.g. Aluminium Nitride, Silicon Nitride etc

139. The BM of claim 124, preferably consists of battery charge controllers having one or more PCB mounted ICs (integrated circuits) that charge the batteries/capacitors of the said BM.

140. The BM of claim 124 preferably also consists of energy discharging split circuit that switches the source of the BM output current between:
i. batteries current only;
ii. capacitors current only;
iii. an optimal mix of batteries and capacitors current;

141. The BM of claim 124 preferably consists of positive and negative module charging terminals.

142. The BM of claim 124 preferably also consists of communication terminals, these are preferably I²C or SMBus or PMbus terminals.

143. The BM of claim 124 preferably also consists of positive and negative module HV terminals.

144. The BM of claim 124 also consists of subcooled dielectric liquid in ducts acts as a fire extinguisher in the event of a fire of one or more batteries or capacitors inside the BM.

145. The BM of claim 124 also consists of ducts act as chimneys to let the gases/fumes escape the BM in the event of fire of one or more batteries or capacitors inside the BM.

146. The BM of claim 124 also consists of separators act as a barrier to shockwave or cascade effect of thermal runaway, in the event one or more batteries or capacitors have thermal runaway or explosion, inside the BM.

147. The BM of claim 124 also consists of if one or more ducts get into saturated state e.g. due to thermal runaway, the BM which is made of material with very high thermal conductivity and preferably also a microporous material, redistributes the heat away from the duct.
A method of repurposing the battery modules

148. A method of repurposing the battery modules (BM) of claim 124, comprising:
e. matching the mechanical fittings of the BMs and the battery pack;
f. placing all the BMs inside a larger or smaller battery pack;
g. electrically connecting in series or parallel the said BMs inside the battery pack for the desired voltage and current requirements;
h. and replacing the failed or weak BMs with new BMs.
An apparatus for charging a battery pack, and decoupling the charging voltage from the battery pack voltage

149. The charging circuit of battery pack, is an apparatus, comprises:
a. a battery pack controller, which acts as a master controller of all charging functions of batteries/capacitors;
b. plurality of BMs are connected electrically in serial or groups of BMs are connected electrically in series where within each said group plurality of BMs are electrically connected in parallel, inside the battery pack;
c. inside each battery module (BM), one or more groups of batteries/capacitors are electrically connected in parallel;
d. there Is at least one battery/capacitor charge controller inside each BM, which charges batteries/capacitors, and acts as a slave to the battery pack controller;
e. battery pack controller's balanced charging algorithm, calculates the Balanced SoC/voltage for said group of batteries/capacitors;
f. battery pack controller then selectively instructs each battery/capacitor charge controller to use a Charge voltage and Charge current, which is specific to each said BM or each said group of batteries/capacitors, until the Balanced SoC for batteries/capacitors is achieved;
g. said group of batteries/capacitors, during and after getting charged by the battery/capacitor charge controller self balance in their respective groups;
h. the battery charge controllers continue the above steps (e, f and g), until either all the BMs have reached the optimum balanced SoC/voltage for batteries/capacitors, or there is no supply of charging current.

150. The Balanced charging algorithm of claim 149 calculates the Balanced SoC and Balanced Voltage to balance charge the entire battery pack, using the following algorithm:
a. gather the history of charge current vs the increase in SoC for each group of batteries/capacitors;
b. gather the existing SoC/voltage of the said groups of batteries/capacitors;
c. allocate the input current to all the groups of batteries/capacitors such that all the available current is given to the group of batteries/capacitors with the least SoC/voltage;
d. continue with the above step C until the said group of batteries/capacitors in all the BMs in the series circuit have equal SoC/voltage levels;
e. any remaining charge is equally divided in all the group of batteries and separately to all the group of capacitors;
f. continue the above four steps (b, c, d and e) until there is no current supply or optimum balanced SoC/voltage is reached for the said group of batteries/capacitors.

151. The battery pack controller of claim 149 stops charging the said group of batteries/capacitors or BMs in the event of an overcharge in these groups of batteries/capacitors or BMs, and continue charging the other groups of batteries/capacitors or BMs, and restart when the said group of batteries or BMs have the same level of charging as other group of batteries or BMs.

152. The battery/capacitor charge controller of claim 149 consists of voltage/SoC measurement devices which send the data to the battery pack controller.

153. The battery pack charging circuit of claim 149 also consists of independent and selective charging of each battery module, and each group of batteries/capacitors connected in parallel with in each BM.

154. The balanced charging algorithm of claim 149 collects measurements of existing SoC/Voltage of batteries/capacitors, prior to the charge cycle and preferably during the charge cycle.

155. The Balanced charging algorithm of claim 149 also calculates the said Charge voltage and Charge current which is specific to each said group of batteries/capacitors, based on:
a. the existing SoC/Voltage of the said groups of batteries/capacitors;
b. balanced SoC/Voltage of the batteries/capacitors;
c. learning from the previous charge cycles the relationship between charge voltage/charge current and achieved SoC/Voltage of batteries/capacitors.

156. The Balanced charging algorithm of claim 149 also calculates the said Optimum Balanced SoC for all the said group of batteries or said BMs, based on:
a. SoH of the weakest of said groups of batteries, when the said groups are electrically connected in series;
b. SoH of the weakest of said BMs, when the said BMs are electrically connected in series.

157. The battery pack charging circuit of claim 149 also consists of all the said groups of batteries/capacitors are equalised charged at balanced SoC/voltage relative to other group of batteries/capacitors, at any time during the charging process.

158. The battery pack controller of claim 149 also acts as a master controller to the following slave circuits:
a. energy charging split circuit;
b. battery charge controller.

159. The battery pack controller of claim 149 also communicates with battery charge controllers using the I²C or SMBus or PMbus.

160. The battery pack charging circuit of claim 149 also consists of an Energy charging split circuit, that switches the input to the DC to DC converter between:
a. high voltage DC street charger;
b. AC charger;
c. and preferably regenerative current.

161. The battery pack controller of claim 149 controls the Energy charging split circuit of claim 160 such that, external high voltage DC or external AC charge the batteries/capacitors, and preferably the regenerative current/energy recovery charge the capacitors.

162. The battery pack charging circuit of claim 149 preferably also consists of auxiliary low voltage batteries electrically connected to the said charging bus through Battery charge controllers or DC-DC converters.

163. The battery pack charging circuit of claim 149 also consists of an AC/DC to DC converter that converts high voltage AC/DC input to interim level DC voltage output; and supplies the Charging bus.

164. The battery pack charging circuit of claim 149 also consists of the inputs of the said Battery/capacitor charge controller/s are electrically connected to said charging bus.

165. The battery pack controller of claim 149 preferably also keeps a log of SoH for each battery/capacitor; and preferably for each BM, and preferably updates the SoH log of a failed BM with the SoH of the new BM, if a failed BM is replaced with a new BM.

166. The battery pack controller of claim 149 is also preferably electronically connected to an operational centre that calculates the SoH of the batteries and BMs, and creates the said balanced charging algorithm offline; the algorithm that extends the BM's life and improves the safety of the battery pack, and periodically performs updates of balanced charging algorithm and SoH etc.

167. The charging circuit of battery pack of claim 149 decouples the charging voltage from the battery pack's output voltage comprises, input voltage and current of the AC/DC to DC converters used to charge the battery pack are matched with the voltage and current of street chargers; and independently number of BMs/groups of batteries that are connected in series and parallel are matched with the voltage and current requirements of different vehicle's electric motors.
A method for charging a battery pack, and decoupling the charging voltage from the battery pack voltage

168. A method of charging of a battery pack, comprising:
a. a battery pack controller, acting as a master controller of all charging functions of batteries/capacitors;
b. inside each BM, electrically connecting a group of batteries/capacitors in parallel;
c. installing Battery/capacitor charge controllers inside each BM,
d. battery/capacitor charge controllers charging batteries/capacitors, inside each BM as per the instructions from the battery pack controller;
e. battery pack controller collecting SoC/Voltage of each battery/capacitor prior to the charging and preferably during the charging;
f. battery pack controller's algorithm calculating the Balanced SoC/Voltage for said groups of batteries/capacitors;
g. the said battery pack controller selectively sending a message to each said group's Battery/capacitor charge controller, using a specific Charge voltage and a specific Charge current, to charge the said group of batteries/capacitors until a Balanced SoC or Balanced Voltage is achieved;
h. after and during the charging, allowing said group of batteries/capacitors, to self balance in their respective groups.
i. the battery charge controllers continuing the above steps (f, g and h), until either the BMs have reached the optimum balanced SoC/Voltage for batteries/capacitors;
or there is no supply of charging current.

169. The method of charging of battery pack of claim 168 also involves, in the event of one or more battery/capacitor within the said groups of batteries/capacitors are overcharged, the Battery/capacitor charge controllers responsible for charging the said group of batteries/capacitors, stopping further charging until the overcharge is self balanced or rectified, however continue charging the rest of the groups of batteries/capacitors.

170. The method of charging of battery pack of claim 168 also involves sending a message/instructing the said battery/capacitor charge controllers using their ID regardless of where it is located within the said battery pack.

171. The method of charging of battery pack of claim 168 also involves said battery pack controller regularly receiving SoC/Voltage from each battery/capacitor, and calculating how much charge it would need to rebalance each and all the said groups in the battery pack prior to beginning the charge process.

172. The method of charging of battery pack of claim 168 also involves in the event of a failure of a battery/capacitor or plurality of batteries/capacitors, replacing the BM having one or more failed batteries/capacitors with a new BM, updating the log of the SoH of the failed BM with the SoH of a new BM, without impacting the balancing of rest of said BMs in the battery pack.

173. The method of charging of battery pack of claim 168 also involves decoupling the charging voltage/current of the battery pack from the battery pack's output voltage/current, and matching the input voltage and current of the AC/DC to DC converters of the battery pack to standard chargers; and independently matching the battery packs output voltage and output current with the voltage and current of the motor controller/electric motors of different vehicles.
An apparatus for charging a battery pack, and decoupling the charging voltage from the battery pack voltage

174. The charging circuit of battery pack, is an apparatus, comprises:
a. a battery pack controller, which acts as a master controller of all charging functions of batteries, preferably and capacitors;
b. inside each battery module (BM), one or more groups of batteries are electrically connected in parallel, preferably and one or more groups of capacitors are also electrically connected in parallel;
c. there is at least one battery/capacitor charge controller inside each BM, which charges batteries, preferably and capacitors, and acts as a slave to the battery pack controller;
d. battery pack controller's balanced charging algorithm calculates the Balanced SoC for said group of batteries; preferably and calculates Balanced voltage for said group of capacitors;
e. battery pack controller selectively instructs each battery/capacitor charge controller to charge the said groups of batteries, and preferably said groups of capacitors, with a specific Charge voltage and Charge current; or preferably charge to Balanced SoC;
f. said group of batteries and preferably said group of capacitors, during and after getting charged by the battery/capacitor charge controller self balance in their respective groups;
g. the battery charge controllers continue the charging process, until either all the BMs have reached the optimum balanced SoC for batteries, preferably and optimum balanced voltage for capacitors, or there is no supply of charging current.

175. The Balanced charging algorithm of claim 174 calculates the said Balanced SoC for batteries, preferably and Balanced voltage for capacitors, based on:
a. the existing SoC of the said groups of batteries, and preferably existing voltage of said group of capacitors;
b. optimum balanced SoC for the said group of batteries;
c. and preferably optimum balanced Voltage for the said group of capacitors.

176. The Balanced charging algorithm claim of 174 calculates the balanced SoC to balance the said groups of batteries, based on the algorithm as explained using an example:
a. if there are 3 groups in series, first group has existing SoC of 30%, second group has SoC of 29%, and the third has SoC of 31%;
b. assuming 1 amp hr of new current to each of the said group of batteries will bring up the SoC of the said group of batteries group by 1%;
c. if the battery charger has 3 amp hr to distribute; it will allocate 1 amp hr to the first group, 2 amp to the second group and zero to the third group; thus all the three groups are balanced charged to 31% SoC, thus 31% will be the Balanced SoC;
d. if the charger had 4 amp hr to distribute, it would have distributed 3 amps hr as explained above and then distributed 0.333 amp hr equally to all the three groups; thus group 1 would have got 1+0.333=1.333 amp hr; group 2 would have got 2+0.333=2.333 amp hr and group 3 would have got 0.333 amp hr; thus all the three groups are balanced charged to 31.33% SoC, thus 31.33% will be the Balanced SoC;
e. if the charger had lamp hr to distribute, it would have given 1 amp to the group which is most out of balance; thus group 1 would have got zero; group 2 would have got lamp hr and group 3 would have got zero; thus the three groups are charged to 30%, 30%, 31%, thus the pack is still unbalanced, as there is not sufficient supply of charge available to balance the battery pack;
f. Battery pack controller continues with the above steps until either all the said groups have reached their optimum balanced SoC, or there is no supply of charging current;
g. If any group of batteries has reached optimum balanced SoC earlier than others, the battery pack controller skips its charging.

177. The Balanced charging algorithm of claim of 174 preferably calculates the balanced Voltage to balance the said groups of capacitors, based on the algorithm as explained using an example:
a. if there are 3 groups in series, first group has existing voltage of 3v, second group has existing voltage of 2v, and the third has existing voltage of 3.5v;
b. assuming 1 amp hr of new current to each of the said group of capacitors will bring up the voltage of the said group of capacitors group by 1v;
c. if the battery charger has 2 amp hr to distribute; it will allocate 0.5 amp hr to the first group, 1.5 amp hr to the second group and zero to the third group; thus all the three groups are balanced charged to 3.5v, thus 3.5v will be the ‘Balanced voltage’;
d. if the charger had 3 amp hr to distribute, it would have distributed 2 amps hr as explained above and then distributed 0.333 amp hr equally to all the three groups; thus group 1 would have got 0.5+0.333=0.833 amp hr; group 2 would have got 1.5+0.333=1.833 amp hr and group 3 would have got 0.333 amp hr; thus all the three groups are balanced charged to 3.888v, thus 3.88v will be the ‘Balanced voltage’;
e. if the charger had lamp to distribute, it would have given 1 amp hr to the group which is most out of balance; thus group 1 would have got zero; group 2 would have got lamp and group 3 would have got zero; thus the three groups are charged to 3v, 3v, 3.5v, thus the pack is still unbalanced, as there is not sufficient supply of charge available to balance the battery pack;
f. Battery pack controller continues with the above steps until either all the groups of capacitors have reached their optimum balanced voltage, or there is no supply of charging current;
g. If any group of capacitors has reached optimum balanced SoC earlier than others, the battery pack controller skips its charging

178. The battery pack charging circuit of claim 174 also consists of decoupling of input AC/DC voltage to the battery pack, from the battery pack's output AC/DC voltage.

179. The balanced charging algorithm of claim 174 collects measurements of existing SoC of batteries, and preferably existing voltage of capacitors, prior to the charge cycle and preferably during the charge cycle.

180. The Balanced charging algorithm of claim 174 also calculates the said Charge voltage and Charge current which is specific to each said group of batteries, preferably and capacitors, based on:
a. the existing SoC of the said groups of batteries, and preferably voltage for said group of capacitors;
b. balanced SoC of the batteries, preferably and balanced voltage for capacitors;
c. learning from the previous charge cycles the relationship between charge voltage/charge current and achieved SoC of batteries preferably and achieved Voltage of capacitors.

181. The Balanced charging algorithm of claim 174 also calculates the said Optimum Balanced SoC for all the said group of batteries or said BMs, based on:
a. SoH of the weakest of said groups of batteries, when the said groups are electrically connected in series;
b. SoH of the weakest of said BMs, when the said BMs are electrically connected in series.

182. The battery pack charging circuit of claim 174 also consists of all the said groups of batteries are equalised charged at balanced SoC and preferably all the said groups of capacitors are equalised charged at balanced Voltage, at any time during the charging process.

183. The battery pack controller of claim 174 also acts as a master controller to the following slave circuits:
a. energy charging split circuit;
b. battery charge controller.

184. The battery pack controller of claim 174 also communicates with battery charge controllers using the I²C or SMBus or PMbus.

185. The battery/capacitor charging circuit of claim 174 also consists of an Energy charging split circuit, that switches the input to the DC to DC converter between:
a. high voltage DC street charger;
b. AC charger;
c. and preferably regenerative current e.g. from the electric motors of electric vehicle.

186. The battery pack controller of claim 174 controls the Energy charging split circuit such that, batteries are charged through external high voltage DC charger or external AC charger, and capacitors are charged by the regenerative current/energy recovery.

187. The battery/capacitor charging circuit of claim 174 preferably also consists of auxiliary low voltage batteries (e.g. Lead acid batteries) electrically connected to the said charging bus through Battery charge controllers or DC-DC converters.

188. The battery pack charging circuit of claim 174 also consists of an AC/DC to DC converter that converts high voltage AC/DC input to interim level DC voltage output e.g. 12v or 24v or 48v; and supplies the Charging bus.

189. The battery charging circuit of claim 174 also consists of the inputs of the said Battery/capacitor charge controller/s are electrically connected to said charging bus.

190. The battery pack controller of claim 174 preferably also keeps a log of SoH for each battery and preferably each capacitor; and preferably for each BM, and preferably updates the log if a failed BM is replaced with a new BM.

191. The battery pack controller of claim 174 is also preferably electronically connected to an operational centre that calculates the SoH of the batteries and BMs, and creates a algorithm offline; algorithm that extends the BM's life and improves the safety of the battery pack e.g. updates of balanced charging algorithm etc, and SoH; and the algorithm is updated in battery pack controller periodically.

192. The battery pack charging circuit of claim 174 also constitutes a replacement of a failed BM with a new BM to extend the life of the battery pack without effecting the balanced charging of other BMs.
A method for charging a battery pack, and decoupling the charging voltage from the battery pack voltage

193. A method of charging of a battery pack, comprising:
a. a battery pack controller, acting as a master controller of all charging functions of batteries, preferably and capacitors;
b. inside each BM, electrically connecting a group of batteries in parallel, preferably and electrically connecting a group of capacitors in parallel;
c. installing Battery/capacitor charge controllers inside each BM,
d. battery/capacitor charge controllers charging batteries, preferably and capacitors, inside each BM as per the instructions from the battery pack controller;
e. battery pack controller collecting SoC of each battery and preferably voltage of each capacitor prior to the charging and during the charging;
f. battery pack controller's algorithm calculating the Balanced SoC for said groups of batteries;
g. battery pack controller's algorithm preferably also calculating the Balanced Voltage for said groups of capacitors
h. the said battery pack controller selectively sending a message to each said group's Battery/capacitor charge controller to charge the said group of batteries, and preferably said groups of capacitors, using a specific Charge voltage and a specific Charge current, or preferably charge to a specific Balanced Soc;
i. after and during the charging, allowing said group of batteries and preferably said group of capacitors, to self balance in their respective groups.
j. the battery charge controllers continuing the step by step process of calculating balanced SoC for batteries and preferably balanced Voltage for capacitors, and charging the BMs, until either the BMs have reached the optimum balanced SoC for batteries, preferably and optimum balanced voltage for capacitors; or there is no supply of charging current.

194. The method of charging of battery pack of claim 193 also involves, in the event of one or more battery/capacitor within the said groups of batteries/capacitors are overcharged, the Battery/capacitor charge controllers responsible for charging the said group of batteries/capacitors, stopping further charging until the overcharge is self balanced or rectified, however continue charging the rest of the batteries or capacitors.

195. The method of charging of battery pack of claim 193 also involves sending a message/instructing the said battery/capacitor charge controllers using their ID regardless of where it is located within the said battery pack.

196. The method of charging of battery pack of claim 193 also involves said battery pack controller regularly receiving SoC from each battery, and preferably voltage from each capacitor, and calculating how much charge it would need to rebalance each and all the said groups in the battery pack prior to beginning the charge process.

197. The method of charging of battery pack of claim 193 also involves in the event of a failure of a battery/capacitor or plurality of batteries/capacitors, replacing the BM having one or more failed batteries/capacitors with a new BM, updating the log of the SoH of the failed BM with the SoH of a new BM, without impacting the balancing of rest of said BMs in the battery pack.

198. The method of charging of battery pack of claim 193 also involves battery pack controller's algorithm controlling the battery charging split circuit such that capacitors are charged by the regenerative current, and batteries are charged by the external street based AC/DC chargers.
An apparatus for discharging the battery modules, and extending the range of the battery pack

199. An electrical circuit that discharges hybrid BMs of a battery pack, is an apparatus, comprises:
a. hybrid BMs containing a plurality of batteries electrically connected in parallel, and a plurality of capacitors electrically connected in parallel;
b. an energy discharging split circuit fitted inside each BM, that switches the source of the BM output current between:
i. batteries current only;
ii. capacitors current only;
iii. an optimal mix of batteries and capacitors current;
c. one or more of said BMs electrically connected in series and/or parallel inside a battery pack;
d. an energy management algorithm, installed in battery pack controller which selectively calculates, the optimal mix of batteries and capacitors current for each of said BM, to match the current demand of the battery pack, using the following algorithm:
i. peak current is supplied by the capacitors and average current is supplied by batteries within each BM;
ii. when a BM or group of BMs in series circuit have their batteries discharged to the minimum SoC levels, their capacitors current meet all the current demand;
iii. Continue the above two steps until batteries in one or more BMs in the series circuit are discharged to minimum SoC levels and their respective capacitors are also discharged to minimum SoC/voltage levels in these BMs, or there is no demand of current.
e. the said battery pack controller selectively instructs the energy discharging split circuit in each BM, to supply the mix of current as per the algorithm.

200. The electrical circuit of claim 199 also consists of the said Battery pack controller which acts as a master controller to all the said Energy discharging split circuits in all the BMs.

201. The electrical discharging split circuit of claim 199 is fitted inside all the said BMs inside the battery pack.

202. The electrical discharging split circuit of claim 199 also consists of DC-DC converters which step up the voltage of the capacitors as the capacitors are discharged.

203. The battery pack controller of claim 199 communicates with Energy discharging split circuit preferably using the I²C or SMBus or PMbus.

204. The electrical discharging split circuit of claim 199 also consists of deep-discharge of capacitors to prevent deep-discharge of batteries in a BM.

205. The energy management algorithm of claim 199 meets the peak current demands of a BM, based on the SoC/voltage levels of the capacitors.

206. The energy management algorithm of claim 199 calculates the Optimum balanced SoC/voltage for capacitors in each BM and it maintains the capacitors at this level of charge.

207. The electrical discharging split circuit of claim 199 preferably consists of optimising the size/number of the capacitors in each BM based on the peak demand and duration of the peak current demand of the application.

208. The energy management algorithm of claim 199 controls the Energy discharging split circuit such that, when batteries output current is less than the maximum allowed for the batteries and the SoC/voltage of the capacitors within each BM is less than the Optimum balanced SoC level, the capacitors are charged by the batteries within the BMs.

209. The battery pack controller of claim 199 preferably also charges the capacitors using the regenerative current until its voltage reaches the max voltage ratings of the capacitor.

210. The energy management algorithm of claim 199 preferably controls the Energy discharging split circuit such that, it increases or reduces the current output of each BMs as per the communication from vehicle/motor controller of the electric vehicle.

211. The electrical discharging split circuit of claim 199 also consists of decoupling of the peak current capacity of the batteries in the BMs, from the peak current demand of various applications.

212. The battery pack controller of claim 199 also preferably controls the relay switch such that it switches the output current of the BMs between:
a. High voltage DC bus
b. Heaters

213. The energy management algorithm of claim 199 also preferably controls Energy discharging split circuit such that capacitors provide the current to the heaters in the battery pack, during extreme cold ambient temperatures.

214. The energy management algorithm of claim 199 also preferably controls Energy discharging split circuit such that capacitors provide the current to the external pump to cool the condensers which are thermally connected to the battery pack, during extreme hot ambient temperatures.

215. The Battery pack controller of claim 199 preferably also stores following user preferences for Energy discharging split circuit:
a. acceleration;
b. energy economy;
c. balance of acceleration and energy economy.

216. The Battery pack controller of claim 199 also preferably electronically connected to the operational centre that creates an algorithm offline; algorithm that extends BMs lives and improves the efficiency of the battery pack; the algorithm is updated in the battery pack controller periodically.

217. The battery pack controller of claim 199 also preferably acts as a master of two or more battery packs, when two or more battery packs are connected to supply large power, master battery pack controller controls the discharging functions of all the slave battery packs.

218. The energy management algorithm of claim 199 also preferably consists of for each application a variation of the algorithm to maintain an Optimum SoC level of the capacitors which optimally meets the peak current demands of the application.

219. The energy management algorithm of claim 199 also preferably consists of for each battery pack configuration a variation of the algorithm which optimally meets the average current demands of the application.
A Method for discharging the battery modules, and extending the range of the battery pack

220. A method of discharging of a hybrid battery pack, comprising:
a. a battery pack controller, acting as a master controller of all discharging functions of batteries and capacitors;
b. inside each BM, electrically connecting a group of batteries in parallel, and electrically connecting a group of capacitors in parallel;
c. installing an energy discharging split circuit inside each BM that switches the source of the BM output current between:
i. batteries current only;
ii. capacitors current only;
iii. an optimal combination of batteries and capacitors current;
d. an energy management algorithm, installed in the said battery pack controller selectively calculating for each said BM, the optimal combination of batteries and capacitors current to match the current demand from the BM;
e. the said battery pack controller selectively instructing the energy discharging split circuit of each BM, the optimal combination of capacitors and batteries current from the said BM.
f. the energy management algorithm, selectively calculating the optimal mix of batteries and capacitors current for each said BM, using the following algorithm:
i. Capacitors supplying the peak current and batteries supplying the average current within each BMs;
ii. when a BM or group of BMs in series circuit have their batteries discharged to the minimum SoC levels, capacitors supplying all the current demand;
iii. Continuing the above two steps until batteries in one or more BMs in the series circuit are discharged to minimum SoC levels and their respective capacitors are also discharged to minimum SoC/voltage levels in these BMs, or there is no demand of current.

221. The method of selective discharging of claim 220 preferably also involves battery pack controller software continuously/regularly calculating the current demand from the power load/motor, and deciding the source of the current:
a. battery alone;
b. or battery and capacitors;
c. or capacitor alone.

222. The energy management algorithm of claim 220 preferably controlling Energy discharging split circuit so that capacitors provide the current to the external pump to cool the condensers which are thermally connected to the battery pack, during extreme hot ambient temperatures.

223. The energy management algorithm of claim 220 also preferably controlling the Energy discharging split circuit so that capacitors provide the current to the heaters in the battery pack, during extreme cold ambient temperatures.
An apparatus for discharging the battery modules, and extending the range of the battery pack

224. An electrical circuit that discharges hybrid BMs of a battery pack, is an apparatus, comprises:
a. hybrid BMs containing a plurality of batteries electrically connected in series or parallel, and a plurality of capacitors electrically connected in series or parallel;
b. an energy discharging split circuit fitted inside each BM, that switches the source of the BM output current between:
i. batteries current only;
ii. capacitors current only;
iii. an optimal mix of batteries and capacitors current;
c. one or more of said BMs electrically connected in series and/or parallel inside a battery pack;
d. an energy management algorithm, installed in battery pack controller which selectively calculates, the optimal mix of batteries and capacitors current for each of said BM, to match the current demand of the battery pack, using the following algorithm:
i. peak current is supplied by the capacitors and average current is supplied by batteries within each BM;
ii. when a BM or group of BMs in series circuit have their batteries discharged to the minimum SoC levels, their capacitors current meet all the current demand;
iii. Continue the above two steps until batteries in one or more BMs in the series circuit are discharged to minimum SoC levels and their respective capacitors are also discharged to minimum voltage levels in these BMs, or there is no demand of current.
e. the said battery pack controller selectively instructs the energy discharging split circuit in each BM, to supply the mix of current as per the algorithm.

225. The electrical discharging circuit of claim 224 also consists of the said Battery pack controller which acts as a master controller to all the said Energy discharging split circuits in all the BMs.

226. The electrical discharging circuit of claim 224 is fitted inside all the said BMs inside the battery pack.

227. The electrical discharging circuit of claim 224 also consists of DC-DC converters which step up the voltage of the capacitors as the capacitors are discharged.

228. The battery pack controller of claim 224 communicates with Energy discharging split circuit preferably using the I²C or SMBus or PMbus.

229. The electrical discharging circuit of claim 224 also consists of deeper discharge of capacitors to protect deeper discharge of batteries in a BM.

230. The energy management algorithm of claim 224 meets the peak current demands of the BM, based on the SoC/voltage levels of the capacitors.

231. The energy management algorithm of claim 224 calculates the Optimum balanced SoC/voltage for capacitors in each BM and it maintains the capacitors at this level of charge.

232. The electrical discharging circuit of claim 224 preferably consists of optimising the size/number of the capacitors in each BM based on the peak demand and duration of the peak current demand of the application.

233. The energy management algorithm of claim 224 controls the Energy discharging split circuit such that, when batteries output current is less than the maximum allowed for the batteries and the SoC/voltage of the capacitors within each BM is less than the Optimum balanced SoC level, the capacitors are charged by the batteries within the BM.

234. The battery pack controller of claim 224 preferably also charges the capacitors using the regenerative current until its voltage reaches the max voltage ratings of the capacitor.

235. The energy management algorithm of claim 224 preferably controls the Energy discharging split circuit such that, it increases or reduces the current output of each BMs as per the communication from vehicle/motor controller of the electric vehicle e.g. CAN or Ethernet message.

236. The electrical discharging circuit of claim 224 also consists of decoupling of the peak current capacity of the batteries in the BMs, from the peak current demand of various applications.

237. The battery pack controller of claim 224 also preferably controls the relay switch such that it switches the output current of the BMs between:
a. High voltage DC bus
b. Heaters

238. The energy management algorithm of claim 224 also preferably controls Energy discharging split circuit such that capacitors provide the current to the heaters in the battery pack, during extreme cold ambient temperatures.

239. The energy management algorithm of claim 224 also preferably controls Energy discharging split circuit such that capacitors provide the current to the external pump to cool the condensers which are thermally connected to the battery pack, during extreme hot ambient temperatures.

240. The Battery pack controller of claim 224 preferably also stores following user preferences for Energy discharging split circuit:
a. acceleration;
b. energy economy;
c. balance of acceleration and energy economy.

241. The Battery pack controller of claim 224 also preferably electronically connected to the operational centre that creates an algorithm offline; algorithm that extends the battery BM life and improves the efficiency of the battery pack e.g. updates of energy management algorithm;
the software is updated in battery pack controller periodically.

242. The battery pack controller of claim 224 also preferably acts as a master of two or more battery packs when two or more battery packs are connected to supply large power, such that master battery pack controller controls the discharging functions of all the slave battery packs.

243. The energy management algorithm of claim 224 also preferably consists of each application needs a variation of the algorithm to maintain a Optimum SoC level of the capacitors which optimally meets the peak current demands of the application e.g. peak current demand of a stop/start bus is different from a performance vehicle.

244. The energy management algorithm of claim 224 also preferably consists of each battery pack configuration also needs a variation of the algorithm which optimally meets the average current demands of the application e.g. average current demand of lorry is different from a performance vehicle.
A Method for discharging the battery modules, and extending the range of the battery pack

245. A method of discharging of a hybrid battery pack, comprising:
g. a battery pack controller, acting as a master controller of all discharging functions of batteries, and capacitors;
h. inside each BM, electrically connecting a group of batteries in parallel, and electrically connecting a group of capacitors in parallel;
i. installing an energy discharging split circuit inside each BM that switches the source of the BM output current between:
i. batteries current only;
ii. capacitors current only;
iii. an optimal combination of batteries and capacitors current;
j. an energy management algorithm, installed in the said battery pack controller selectively calculating for each said BM, the optimal combination of batteries and capacitors current to match the current demand from the BM;
k. the said battery pack controller selectively instructing the energy discharging split circuit of each BM, the optimal combination of capacitors and batteries current from the said BM.

246. The energy management algorithm of claim 245, selectively calculating the optimal mix of batteries and capacitors current for each said BM, using the following algorithm:
i. Capacitors supplying the peak current and batteries supplying the average current within each BMs;
ii. when a BM or group of BMs in series circuit have their batteries discharged to the minimum SoC levels, capacitors supplying all the current demand;
iii. Continuing the above two steps until batteries in one or more BMs in the series circuit are discharged to minimum SoC levels and their respective capacitors are also discharged to minimum voltage levels in these BMs, or there is no demand of current.

247. The method of selective discharging of claim 245 preferably also involves battery pack controller software continuously/regularly calculating the current demand from the power load/motor, and deciding the source of the current:
d. battery alone;
e. or battery and capacitors;
f. or capacitor alone.
Battery pack controller

248. The battery pack controller, is an apparatus designed as a master controller of a battery pack, comprises:
a. A plurality of battery modules (BMs) or plurality of groups of BMs are electrically connected in series inside the battery pack, where within each group a plurality of BMs are electrically connected in parallel;
b. an algorithm which makes a decision whether to switch on or switch off the circuit, based on the triggers/messages from the vehicle control unit or any control unit of an application;
c. using the above algorithm's decision, controls the relays/power switches, and automatically breaks the circuit inside the battery pack, and the system voltage inside the battery pack falls below the SELV level;
d. takes the weakest BM or BMs out of the series circuit if it results in increase in the capacity utilisation of the battery pack, and without impacting the usage of the battery pack.

249. The battery pack controller of claim 248 also consists of a second algorithm that continuously/regularly calculates the capacity utilisation of a BM and compares with the installed capacity of the said BM after taking the SoH, impedance, thermal runaway etc of the batteries/capacitors of said BM into account, and makes the logic decision to declare the BM as a ‘Failed’ BM and controls the relays/power switches to automatically take the Failed BM out of the series circuit, while keeping the remaining BMs in the electrical series circuit.

250. The battery pack controller of claim 248 preferably also takes the group of BMs of which the Failed BM of claim 249 is a part, out of the series circuit and takes the loss of said group of BMs into account when switching off the group of BMs.

251. The battery pack controller of claim 248 preferably also requests user of the battery pack for a confirmation or informs the user, when it takes out the said failed BM and other BMs as per claim 250, out of the series circuit.

252. The battery pack controller of claim 248 remembers to keep the relay/s which takes the said failed BMs as per claim 250, out of the electrical series circuit, to be in permanently switched off position until the failed BM or BMs are replaced.

253. The battery pack controller of claim 248 also consists of removal of a weak BM from the electrical series circuit, to avoid the reaching the point of thermal runaway.

254. The battery pack controller of claim 248 also instructs the charger/charging algorithm that said Failed BMs as per claim 250, which are taken out of the circuit are not charged any longer.

255. The battery pack controller of claim 248 preferably also instructs the discharging circuit that the remaining BMs are not stressed due to reduced number of BMs in the battery pack.

256. The relays/power switches of claim 248 are preferably powered by an auxiliary battery, and if the auxiliary battery is disconnected all or some of the relays/power switches are switched OFF, and the system voltage falls below the SELV level.

257. The battery pack controller of claim 248 preferably also consists of all BMs are fully submerged in dielectric liquid which also acts as fire extinguisher incase of a fire or thermal runaway.

258. The battery pack controller of claim 248 is also electronically connected to the temperature sensors inside the said battery pack preferably to check if there is any thermal runaway.

259. The battery pack controller of claim 248 is preferably also electronically connected to the pressure sensors inside the said battery pack to record the pressure inside the battery pack container and preferably to measure pressure build up due to gases from thermal runaway.

260. The battery pack controller of claim 248 preferably also controls the gas solenoid valve or any pressure control device to automatically open the valve/device preferably to release the gases incase of thermal runaway and/or release the build up of pressure inside the container.

261. The battery pack controller of claim 248 is preferably also electronically connected to the liquid level sensors inside the said battery pack container and warns the users if the level of the dielectric liquid drops below a preset level, and preferably to check if the batteries are no longer submerged in dielectric liquid as it can lead to batteries overheating.

262. The battery pack controller of claim 248 preferably also controls the gas solenoid valve/s to open the solenoid valve for topping up of the dielectric liquid inside the container to protect the safe operations of the battery pack.

263. The battery pack controller of claim 248 can be installed inside the battery pack or outside the battery pack, is made up of purpose built/configured hardware and software:
a. the hardware preferably consists of a motherboard with microprocessor, hard drive and memory chips, microcontrollers, and the electronic communication circuitry;
b. the software preferably provides the decisions logic and stores the data, the software preferably includes CAN or Ethernet communications; storage of the reference data of safe limits of the said batteries and said dielectric liquid; storage of the history of charging and discharging, stores the user preferences.

264. The battery pack controller of claim 248 preferably also consists of a memory card which records battery pack's history of usage; the records preferably include number of charge cycles, number of times temperature exceeded maximum limit and the respective temperatures, number of times limits on current been reached and the respective currents, no of times battery pack fallen below the minimum required charge and the respective charge; and this memory card can preferably be used to settle warranty claims.

265. The battery pack controller of claim 248, is preferably also electronically connected to the vehicle control unit and/or motor controller of the electric vehicle using CAN or Ethernet network, to:
a. provide information which preferably includes health of the batteries/BMs, status of charge left in the battery pack, warning notifications in the event of thermal runaway;
b. take instructions which preferably include vehicle is in an accident situation trigger, isolate the power supply.

266. The battery pack controller of claim 248 acts as a master of two or more battery packs when two or more battery packs are connected electrically in serial or parallel, to supply large voltage or large current, and there is a electronic link between the master battery pack controllers and the slave battery pack controllers.

267. The battery pack controller of claim 248 is preferably also electronically connected to external smartphone based app, to:
a. provide information for remote monitoring, which preferably includes information on the health of the battery, status of charge left in the battery pack, number of cycles of charging, warning notifications in the event of failed BMs, thermal runaway;
b. and take instructions, which preferably include battery pack needs service/BMs replacement, isolate the power supply.

268. The battery pack controller of claim 248 is preferably also electronically connected to external operational centre through Wi-Fi or mobile network, to:
a. provide detailed information on request for remote monitoring which preferably includes contextual data, sensor data, warning notifications;
b. and receive information and instructions which are specific to the battery pack which preferably includes SoH of the batteries/capacitors, Failure of the batteries/capacitors, prediction of Failure, need service.
A method of providing safety and reliability to a battery pack

269. A method of providing safety and reliability to a battery pack, comprising:
a. an algorithm determining whether to switch on or switch off the circuit based on the triggers/messages, from vehicle control unit or any control unit of an application;
b. based on the above algorithm controlling the relays/power switches, automatically breaking the circuit inside the battery pack and the system voltage inside the battery pack falling below the SELV level;
c. taking the weakest BM or BMs out of the series circuit if it results in increase in the capacity utilisation of the battery pack, and without impacting the usage of the battery pack.

270. The battery pack controller of claim 269 also involves the said power switches defaulting to an OFF position (circuit is broken), unless switched ON (circuit is complete) by the said battery pack controller.

271. The battery pack controller of claim 269 also involves disconnecting the auxiliary battery's connection to the battery pack, before any repair is carried out to the battery pack or high voltage drive train.

272. The battery pack controller of claim 269 preferably also electronically connecting to external operational centre preferably through Wi-Fi, mobile network, for:
a. providing detailed information on request for remote monitoring, preferably including contextual data, sensor data, warning notifications;
b. and receiving remote calculated information and instructions which are specific to the battery pack, preferably including SoH of the batteries/capacitors, Failure of the batteries/capacitors, prediction of Failure, need service
Battery pack controller

273. The battery pack controller, is an apparatus designed as a master controller of a battery pack, comprises:
a. an algorithm that reads the triggers/messages from vehicle control unit or any control unit of an application and makes logic decisions e.g. vehicle is switched off/on, vehicle is in a crash situation etc
b. controls the relays/power switches, to automatically break the circuit inside the battery pack such that system voltage inside the battery pack is less than SELV level e.g. when vehicle is switched off, or when vehicle in a crash situation etc;
c. an algorithm that continuously/regularly calculates the capacity utilisation of a BM and compares with the installed capacity of the said BM after taking the SoH, impedance, thermal runaway etc of the batteries/capacitors of said BM into account, and makes the logic decision to declare a BM as a failed BM;
d. controls the relays/power switches to automatically take the failed BM or group containing the failed BMs out of the electrical circuit inside the battery pack, such that the remaining BMs can continue to function.

274. The battery pack controller of claim 273 preferably also takes the BM out of the series circuit if the capacity utilisation of the battery pack increases by taking the BM and the group of BMs of which that BM is a part, out of the series circuit.

275. The battery pack controller of claim 273 preferably also requests user of the battery pack for a confirmation or informs the user, when it takes out one or more failed BMs out of the series circuit.

276. The battery pack controller of claim 273 remembers to keep the relay which takes the failed BMs out of the electrical series circuit, to be in permanently switched off position until the failed BM or BMs are replaced.

277. The battery pack controller of claim 273 also consists of proactive removal of a weak BM from the electrical series circuit, to avoid the reaching the point of thermal runaway.

278. The battery pack controller of claim 273 also instructs the charging algorithm such that failed BMs which are taken out of the circuit are not charged any longer.

279. The battery pack controller of claim 273 preferably also instructs the discharging circuit such that remaining BMs are not stressed due to reduced number of BMs in the battery pack.

280. The relays/power switches of claim 273 are preferably powered by auxiliary battery, such that if the auxiliary battery is disconnected all or some of the relays/power switches are switched OFF, and the system voltage falls below the SELV level.

281. The battery pack controller of claim 273 preferably also consists of all BMs are fully submerged in dielectric liquid which also acts as fire extinguisher incase of a fire or thermal runaway.

282. The battery pack controller of claim 273 is also electronically connected to the temperature sensors inside the said battery pack e.g. to check if there is any thermal runaway;

283. The battery pack controller of claim 273 is preferably also electronically connected to the pressure sensors inside the said battery pack to record the pressure inside the battery pack container e.g. to measure pressure build up due to gases from thermal runaway.

284. The battery pack controller of claim 273 preferably also controls the gas solenoid valve or any pressure control device to automatically open the valve/device e.g. to release the gases incase of thermal runaway and release the build up of pressure inside the container.

285. The battery pack controller of claim 273 is preferably also electronically connected to the liquid level sensors inside the said battery pack container and warns the users if the level of the dielectric liquid drops below a preset level e.g. to check if the batteries are no longer submerged in dielectric liquid as it can lead to batteries overheating.

286. The battery pack controller of claim 273 preferably also controls the gas solenoid valve/s to open the solenoid valve for topping up of the dielectric liquid inside the container e.g. to protect the safe operations of the battery pack.

287. The battery pack controller of claim 273 can be installed inside the battery pack or outside the battery pack, is made up of purpose built/configured hardware and software:
a. the hardware preferably consists of a motherboard with microprocessor, hard drive and memory chips, microcontrollers, and the electronic communication circuitry;
b. the software preferably which provides the decisions logic and stores the date e.g. CAN or Ethernet communications; stores the reference data of safe limits of the said batteries and said dielectric liquid; stores the history of charging and discharging, stores the user preferences etc.

288. The battery pack controller of claim 273 preferably also consists of a memory card which records battery pack's history of usage e.g. number of charge cycles; number of times temperature exceeded maximum limit and the respective temperatures; number of times limits on current been reached and the respective currents; no of times battery pack fallen below the minimum required charge and the respective charge etc; this memory card can preferably be used to settle warranty claims.

289. The battery pack controller of claim 273, is preferably also electronically connected to the vehicle control unit and/or motor controller of the electric vehicle using CAN or Ethernet network, to:
a. preferably provide information e.g. health of the batteries/BMs, status of charge left in the battery pack, warning notifications in the event of thermal runaway etc;
b. preferably take instructions e.g. vehicle is in an accident situation trigger, isolate the power supply etc.

290. The battery pack controller of claim 273 of one battery pack acts as a master of two or more battery packs when two or more battery packs are connected to supply large power, such that the master battery pack controller controls the relays/power switches of all the slave battery packs.

291. The battery pack controller of claim 273 is preferably also electronically connected to external smartphone based app to provide information and take instructions, to:
a. provide information for remote monitoring e.g. health of the battery, status of charge left in the battery pack, number of cycles of charging, warning notifications in the event of failed BMs, thermal runaway etc;
b. and take instructions e.g. to the battery pack needs service/BMs replacement, isolate the power supply etc.

292. The battery pack controller of claim 273 is preferably also electronically connected to external operational centre e.g. through Wi-Fi, to:
a. provide detailed information on request for remote monitoring e.g. contextual data, sensor data, warning notifications etc;
b. and receive information and instructions which are specific to the battery pack e.g. SoH of the batteries/capacitors, Failure of the batteries/capacitors, prediction of failure, need service etc.
A method of providing safety and reliability to a battery pack

293. A method of providing safety and reliability to a battery pack, comprising:
a. an algorithm reading the triggers/messages from vehicle control unit or any control unit of an application and making logic decisions e.g. vehicle is switched off/on, vehicle is in a crash situation etc
b. controlling the relays/power switches, to automatically break the circuit inside the battery pack such that system voltage inside the battery pack is less than SELV level e.g. when vehicle is switched off, or when vehicle in a crash situation etc;
c. an algorithm continuously/regularly calculating the capacity utilisation of a BM and comparing with the installed capacity of the said BM after taking the SoH, impedance, thermal runaway etc of the batteries/capacitors of said BM into account, and making the logic decision to declare a BM as a failed BM;
d. controlling the relays/power switches to automatically take the failed BM or group containing the failed BMs out of the electrical circuit inside the battery pack, such that the remaining BMs can continue to function.

294. The battery pack controller of claim 293 also involves the said power switches defaulting to an OFF position (circuit is broken), unless switch ON (circuit is complete) by the said battery pack controller.

295. The battery pack controller of claim 293 also involves disconnecting the auxiliary battery's connection to the battery pack before any repair is carried out to the battery pack or high voltage drive train.

296. The battery pack controller of claim 293 preferably switching off all the relays upon receiving a trigger from the user or vehicle control unit.
A method of remote monitoring the battery pack

297. A method of remote monitoring of battery pack of claim 273, by a remote operational centre, comprising:
a. Battery pack controller providing detailed information on request e.g. contextual data, sensor data, warning notifications etc;
b. Operational centre using simulation methods for calculating the SoH of batteries/capacitors, predicting failure of BMs, calculating logic to extend the life of BMs;
c. Battery pack controller receiving information, and instructions which are specific to the each battery pack e.g. SoH of batteries/capacitors, Failure of the BMs, prediction of failure, need service etc.
